(19) United States
(12) Patent Application Publication
(10) Pub. No.: US 2026/0322830 A1
(43) Pub. Date: Oct. 15, 2026

(54) ANOMALY DETECTION FOR GENERATIVE ARTIFICIAL INTELLIGENCE SYSTEMS

(71) Applicant: Darktrace Holdings Limited, Cambridge (GB)

(72) Inventors: Adam Stevens, Cambridge (GB); Stephen Pickman, Great Barton (GB); Philip Sellars, Trumpington (GB); Simon Fellows, Chester (GB); Timothy Bazalgette, Knebworth (GB)

(21) Appl. No.: 19/575,572

(22) Filed: Mar. 23, 2026

Related U.S. Application Data
(60) Provisional application No. 63/775,808, filed on Mar. 21, 2025.

(51) Int. Cl. H04L 9/40; G06N 3/045

(52) U.S. Cl. CPC H04L 63/1416; G06N 3/045; H04L 63/0428; H04L 63/1441

(57) ABSTRACT

Systems, methods, and apparatus are disclosed for an artificial intelligence based cyber security system configured to protect networks against malicious, unauthorized, or anomalous generative artificial intelligence interactions. The system utilizes a cyber security appliance deploying specialized machine learning models to establish a normal pattern of life for user and agentic interactions with large language models. The appliance intercepts and extracts prompt and response payloads, evaluating them using named entity recognition and semantic classifiers to identify personal identifiable information leakage, prompt injections, and data exfiltration. Upon detecting an interaction that deviates from historical baselines or violates ingested security policies, an autonomous response engine dynamically executes targeted mitigation actions. These actions include masking sensitive data with generic placeholders or completely severing the unauthorized network connection. Furthermore, the architecture integrates a cyber attack simulation engine to continuously test and refine the defensive models against emerging generative artificial intelligence threats.

### CLAIM FOR PRIORITY

This application claims the benefit under 35 USC § 119 of provisional Application Ser. No. 63/775,808 filed on Mar. 21, 2025, which is hereby expressly incorporated by reference in its entirety for all purposes.

### NOTICE OF COPYRIGHT

A portion of this disclosure contains material that is subject to copyright protection. The copyright owner has no objection to the facsimile reproduction by anyone of the material subject to copyright protection as it appears in the United States Patent & Trademark Office's patent file or records, but otherwise reserves all copyright rights whatsoever.

### FIELD

Embodiments of the design provided herein generally relate to cyber security and the monitoring of generative artificial intelligence systems.

### BACKGROUND

Cybersecurity attacks and data management have become a pervasive problem for enterprises as many computing devices and other resources have been subjected to attack and compromised. Recently, generative artificial intelligence language models have become widely used in corporate settings. These artificial intelligence models are often deployed as direct chatbots to provide employees with services such as question answering, coding assistance, or document navigation.

Beyond direct human-to-machine interactions, these artificial intelligence technologies are increasingly being utilized to support more complex functionality, such as agentic systems. In these environments, artificial intelligence agents may autonomously or semi-autonomously utilize various digital tools, interact with other artificial intelligence agents, and access enterprise files or application programming interfaces (APIs) to complete tasks.

Because these technologies are both novel and being rapidly adopted, organizations typically lack visibility and monitoring of these systems. This lack of visibility opens a new potential risk for internal or external misuse. Examples of such risks include the unintentional leakage of personally identifiable information (PII), unauthorized data exfiltration, the execution of malicious prompts, and overarching compliance breaches.

Traditional network security tools often struggle to monitor the contextual nuances of natural language prompts or the complex, multi-step interactions of agentic workflows. As a result, it can be difficult for enterprise administrators to identify anomalous usage, enforce network policies regarding artificial intelligence systems, or adequately intercept problematic communications before sensitive information is compromised or malicious activities are executed within the network.

### SUMMARY

Methods, systems, and apparatus are disclosed for an Artificial Intelligence-based cyber security system. The Artificial Intelligence based (AI-based) cyber security system may include many features including the following twenty concepts.

In an embodiment, a cyber security appliance includes a processing component, and a non-transitory computer readable medium including one or more software modules accessible by the processing component. The one or more software modules include a generative AI interaction module configured to receive extracted information from interactions between a user and an artificial intelligence (AI) based agent, an analytic logic module including one or more AI classifiers and machine-learning models configured to perform a similarity search against a historical storage database, determine an anomaly score, and identify, via the one or more AI classifiers, sensitive information, a Pattern of Life (POL) decision logic module configured to maintain state information associated with the monitored interactions and determine when an interaction exceeds an operational limit based on the anomaly score, and an autonomous response module configured to execute an autonomous responsive action in response to a notification from the POL decision logic module.

In an embodiment, the sensitive information is indicative of at least one of a network policy violation, a personal identifiable information (PII) leakage, or an unauthorized data exfiltration.

In an embodiment, the extracted information is received from an endpoint agent on an endpoint computing device.

In an embodiment, the similarity search is performed using a vector based machine learning embedding.

In an embodiment, the anomaly score is determined using an unsupervised anomaly-based autoencoder ensemble.

In an embodiment, the unsupervised anomaly-based autoencoder ensemble determines the anomaly score by calculating a reconstruction loss for the interaction.

In an embodiment, the responsive action is to disable or modify the interaction.

In an embodiment, the modification of the interaction includes masking the identified sensitive information with at least one placeholder prior to the interaction reaching the artificial intelligence (AI) based agent.

In an embodiment, disabling the interaction includes at least one of disabling a monitored connection through a Transmission Control Protocol (TCP) reset message, altering a firewall policy to block the monitored connection, or removing permissions of the user.

In an embodiment, the one or more AI classifiers include a Named Entity Recognition (NER) model trained to identify the sensitive information within the interactions.

In an embodiment, a method of securing artificial intelligence interactions includes receiving, by a cybersecurity appliance, data representing an interaction including a prompt or a response associated with a generative artificial intelligence (AI) tool, processing, by the cybersecurity appliance, the interaction using an autoencoder ensemble trained on a normal pattern of life including historical prompts and responses, determining, by the cybersecurity appliance, a reconstruction loss for the interaction based on the processing by the autoencoder ensemble, identifying, by the cybersecurity appliance, the interaction as anomalous based on the reconstruction loss indicating an unusualness of the interaction for a specific user, and executing, by the cybersecurity appliance, an autonomous responsive action to secure the generative AI tool in response to identifying the interaction as anomalous.

In an embodiment, the autoencoder ensemble includes a plurality of autoencoders, and wherein each autoencoder of the plurality of autoencoders represents a distinct time period of training data.

In an embodiment, the method further includes aging off an oldest autoencoder of the plurality of autoencoders after a predetermined period and training a new autoencoder to maintain a rolling window of the plurality of autoencoders used to evaluate the interaction.

In an embodiment, identifying the interaction as anomalous is evaluated for a specific object, and wherein the specific object includes at least one of an entire business, a specific user, or a specific user group.

In an embodiment, determining the reconstruction loss includes calculating a mean squared error loss representing an amount of alteration between an original representation of the interaction and a reconstructed representation of the interaction.

In an embodiment, the data representing the interaction includes an agentic interaction between the generative AI tool and a second AI-based system rather than a human user.

In an embodiment, the generative AI tool includes a chatbot configured to offer at least one service including question and answering, coding assistance, or document navigation.

In an embodiment, a non-transitory computer readable medium includes software modules to be executed by a processor. The software modules include a generative AI interaction module configured to receive extracted information from interactions between a user and an artificial intelligence (AI) based agent, an analytic logic module including one or more AI classifiers and machine-learning models configured to perform a similarity search against a historical storage database, determine an anomaly score, and identify, via the one or more AI classifiers, sensitive information, a Pattern of Life (POL) decision logic module configured to maintain state information associated with the monitored interactions and determine when an interaction exceeds an operational limit based on the anomaly score, and an autonomous response module configured to execute an autonomous responsive action in response to a notification from the POL decision logic module.

In an embodiment, the analytic logic module is configured to perform the similarity search by comparing a vector embedding of the interaction against a centroid stored in the historical storage database to save memory space.

In an embodiment, the extracted information further includes data representing an access request by the AI based agent to a tool, and wherein the tool includes at least one of a web search, a file lookup, or an application programming interface (API) interaction.

### DRAWINGS

The drawings refer to an embodiment of the design provided herein in which:

The above, and other, aspects, features, and advantages of an embodiment of the present disclosure will be more apparent from the following description as presented in conjunction with the following several figures of the drawings.

FIG. 1 is a block diagram of an artificial intelligence-based cyber security appliance with example components making up a detection engine, in accordance with an embodiment of the disclosure;

FIG. 2 is a block diagram of a cyber security appliance specifically tailored for monitoring and securing generative artificial intelligence interactions, in accordance with an embodiment of the disclosure;

FIG. 3 is a graph of an example chain of unusual behavior including anomalous prompt and network activities, in accordance with an embodiment of the disclosure;

FIG. 4 is a block diagram of a logical architecture of an endpoint agent deployed on an endpoint computing device, in accordance with an embodiment of the disclosure;

FIG. 5 is a block diagram of an artificial intelligence-based cybersecurity system including a cyber security appliance, a scalable cloud platform, and an enterprise network, in accordance with an embodiment of the disclosure;

FIG. 6 is a diagram of a cooperative cybersecurity architecture featuring interactive orchestration across multiple artificial intelligence-based engines, in accordance with an embodiment of the disclosure;

FIG. 7 is a block diagram of a cyber attack simulation engine and an enterprise architecture utilized for security testing, in accordance with an embodiment of the disclosure;

FIG. 8A is a diagram of a cyber attack simulation engine constructing an example graph of nodes to simulate cyberattack paths, in accordance with an embodiment of the disclosure;

FIG. 8B is a diagram of a cyber attack simulation engine and a restoration engine assigning probabilistic scores for a portion of a graph of nodes, in accordance with an embodiment of the disclosure;

FIG. 9 is a block diagram of a cyber threat defense system protecting a comprehensive enterprise architecture, in accordance with an embodiment of the disclosure;

FIG. 10 is a block diagram of a computing device that can be utilized within the cybersecurity system, in accordance with an embodiment of the disclosure;

FIG. 11 is a flowchart of a process for securing generative artificial intelligence interactions using categorizers and named entity recognition, in accordance with an embodiment of the disclosure;

FIG. 12 is a flowchart of a process for detecting anomalous interactions using unsupervised machine learning and a rolling ensemble of autoencoder models, in accordance with an embodiment of the disclosure;

FIG. 13 is a flowchart of a process for evaluating semantic intent using vector embeddings and clustering, in accordance with an embodiment of the disclosure;

FIG. 14 is a flowchart of a process for monitoring and securing agentic artificial intelligence workflows against unauthorized data exfiltration, in accordance with an embodiment of the disclosure;

FIG. 15 is a flowchart of a process for evaluating and responding to a potential cyber threat based on calculated threat level and confidence scores, in accordance with an embodiment of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

While the design is subject to various modifications, equivalents, and alternative forms, specific embodiments thereof have been shown by way of example in the drawings and will now be described in detail. It should be understood that the design is not limited to the particular embodiments disclosed, but-on the contrary-the intention is to cover all modifications, equivalents, and alternative forms using the specific embodiments.

### DESCRIPTION

Generative language models are now widely used in corporate settings, functioning both as direct chatbots and to support more complex functionality such as agentic systems. Companies frequently provide their employees with access to these generative chatbots to offer services like question and answering, coding assistance, or document navigation. Since these technologies are both novel and being rapidly adopted, organizations typically lack visibility and monitoring of these systems. Consequently, this rapid adoption opens a new potential risk for internal or external misuse of the technology. Common examples of these emerging risks include data exfiltration, the leakage of identifiable information, or various compliance breaches.

To address these critical vulnerabilities, a generative AI prompt monitoring product can be deployed to detect anomalies. This monitoring system routinely reviews inputs and outputs sent to large language models over generative AI tools and tries to see what comes out. By rigorously checking the output, the system can determine if there is anything anomalous in the generated response. Ideally, any solution providing these services would provide a range of protective functions to secure the enterprise environment. These primary functions include the identification of malicious prompts, problematic responses, and unapproved usage including PII leakage and data exfiltration.

To effectively monitor these interactions, the system could use a range of potential sources of data. An example of this concept is based around APIs such as those of Microsoft Copilot and ChatGPT Enterprise, capturing the exact data flowing to and from these services. However, the system could also 1) rely on event logs from platforms like AWS Bedrock, and 2) capture from browser extensions, data from endpoint agents, or information routed through AI gateways. These latter options are particularly valuable because they also allow for the possibility of intercepting and blocking or adapting problematic prompts inline. Furthermore, the system can retrieve, for example, chat logs with the artificial intelligence (AI) based agent, for example Microsoft Copilot, ChatGPT, etc., to perform continuous anomaly detection on the prompts that people are sending to generative AI tools and their API integrations.

As an initial step in designing this generative assistance monitoring tool, the system seeks to detect when an input prompt or a model response falls outside the usual domain for a user or customer. One method for detecting such anomalies is based around similarity searches against a vector storage database. This first machine learning approach to discover the unusualness of prompts tests one against another via vector use, as opposed to relying on an autoencoder. The machine learning approach builds up a vector database of prompts that that user has previously submitted to the generative AI tool. When a new prompt comes in, the cyber security system clusters it, identifies similarity to see what other clusters it closely aligns with, and reviews tagged information about the users who sent those prompts to see where it fits in the database.

Alternatively, a second machine learning approach can train an autoencoder ensemble with stored prompts and responses to mathematically identify whether a prompt falls under usual or normal for that user. The training data can use background information and a training corpus of normal interactions with generative AI tooling that has a call and response, monitoring the environment for multiple weeks. Once trained, the reconstruction loss for anomaly detection for generative AI tools can be used by the machine learning can be used as a measure of the unusualness of new prompts. Detecting such an anomaly would act as a weak indicator for further investigation to take place. This provides a secondary, robust method for detecting such anomalies using a trained autoencoder ensemble rather than just a similarity score against stored vector embeddings.

While a range of products exist to tackle these concerns using approaches ranging from rule-based detection to supervised AI models, this system utilizes a more adaptable architecture. The proposed approach combines low-level models, such as generic prompt anomaly modeling, prompt categorization, and PII detection, with a flexible model engine. This advanced structure allows for the fulfillment of all the protective functions without restricting detection only to known patterns of threats and behavior. Additionally, the system provides essential data on the uptake of AI systems and tracks the change in usage over time. The tool can thoroughly investigate the use of generative AI tools for anomalous uses to provide comprehensive oversight.

An example deployment strategy involves utilizing the monitoring of user Generative AI prompts and LLM responses for anomalies with a PII-Identifier Proxy Server. In this configuration, the proxy server and/or firewall can inspect the web requests sent to the generative AI service and make decisions so that what data is transmitted to the Generative AI remains in control by that user's network policies. The system will host an AI classifier and embed prompt data, review inputs and outputs, and act as a proxy or firewall in front of the LLM. This allows the system to develop a modeling layer to look for sensitive information, finding a way to remove that data from prompts before it leaves the network. Offering this as a self-hosted service ensures that users can maintain control over their data while interacting with external models. Again, API interactions with enterprise AI services for the AI based agent could also inspect the web requests sent to the Generative AI service and make decisions so that what data is transmitted to the Generative AI remains in control by that user's network policies.

Finally, the AI classifiers will look at the prompt data, inspect any data being transmitted, and try to identify anomalies in real time. The AI classifier cooperates with the model of normal behavior to determine whether it is unusual/anomalous, or it is not unusual/anomalous to have this interaction with the generative AI tool based upon historic behavior. The AI classifier can identify an anomalous interaction between the user and a generative AI tool, as well as an anomalous interaction that is trying to actively do something malicious. The AI classifier also cooperates with the autonomous response engine to be able to block the anomalous interactions that it sees. Based on these detections, the system can dynamically modify the request, modify the response displayed to the end user, or block the website entirely to mitigate threats like jailbreaking and prompt injections.

### Additional Details

The following text below discusses how some of the other components in the cyber security system operate; and thus, how these components respond to the commands, requests, and communications from the system.

In the following description, numerous specific details are set forth to provide a thorough understanding of the present design. It will be apparent, however, to one skilled in the art that the present design may be practiced without these specific details. In other instances, well-known structures and devices are shown in block diagram form in order to avoid obscuring the present design. Any of the embodiments described herein can be combined, and any such combination may still be contemplated to be within the spirit and scope of the present design. The term coupled is defined as meaning connected either directly to the component or indirectly to the component through another component.

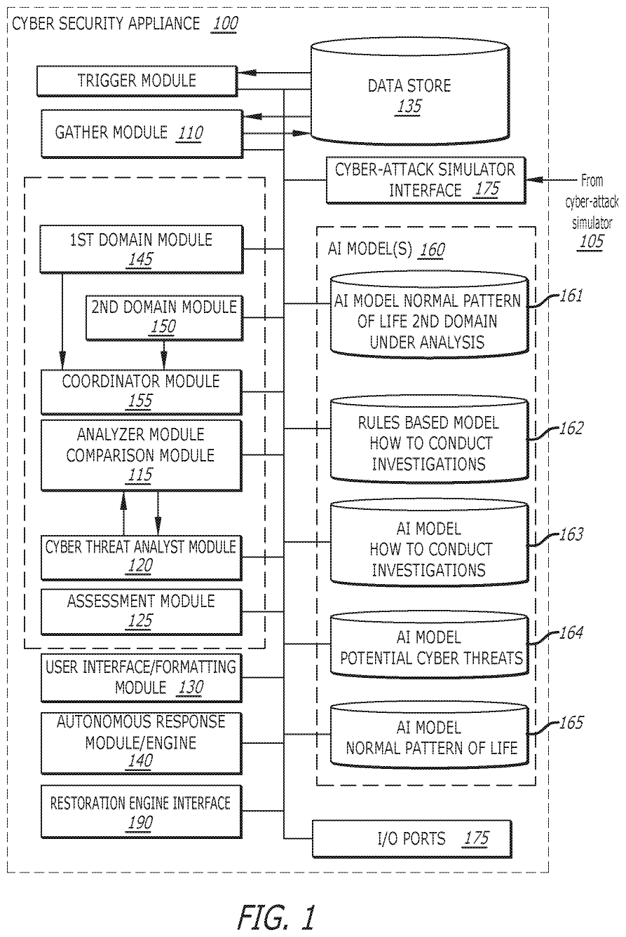

FIG. 1 illustrates a block diagram of an embodiment of an artificial intelligence (AI) based cyber security appliance with example components making up a detection engine that protects a system, including but not limited to a network or domain, from cyber threats involving generative AI interactions. Various artificial intelligence models and modules of the cyber security appliance 100 cooperate to protect a system, such as one or more networks or domains under analysis, from cyber threats like unauthorized data exfiltration via large language models (LLMs). The AI models 160 may be trained with machine learning on a normal pattern of life for entities in the networks or domains under analysis, trained with machine learning on cyber threat hypotheses to form and investigate a cyber threat, and trained on what are a possible set of cyber threats and their characteristics, symptoms, and remediations.

The cyber security appliance 100 is configured to host the cyber threat detection engine and its cooperative components. This overarching appliance acts as the central hub for processing security events and managing autonomous interventions. In some embodiments, the cyber security appliance 100 may be deployed as a physical hardware device within a local network or as a virtualized instance within a scalable cloud environment. The cyber security appliance 100 can process data streams originating from various endpoints to identify risks associated with artificial intelligence interactions. In one embodiment, the cyber security appliance 100 can host the cyber threat detection engine and other cooperative components. The detection engine uses the set of modules cooperating with the one or more artificial intelligence models in the cyber security appliance 100 to prevent a cyber threat from compromising the nodes and spreading through the nodes of the network being protected by the cyber security appliance 100.

The gather module 110 is configured to receive and aggregate incoming data from across the monitored environment. This module can pull raw network traffic, application programming interface logs, and specific generative AI prompt data for initial processing. In certain embodiments, the gather module 110 may format and normalize the disparate data streams so that they are readable by downstream analytical components. By centralizing the data ingestion process, the gather module 110 ensures that the subsequent machine learning models receive a continuous and uniformly structured supply of interaction telemetry.

The analyzer module 115, which may include a comparison module, is configured to conduct initial evaluations of the gathered data against established baselines. This component can perform rapid assessments to identify overt deviations in network traffic or generative AI usage. In various embodiments, the analyzer module 115 might compare a newly received prompt against a historical storage database using a similarity search to generate a preliminary anomaly score. The analyzer module 115 can then pass these preliminary findings to more specialized modules for deeper investigation or immediate autonomous response.

The cyber threat analyst module 120 is configured to conduct long-term, in-depth investigations of potential and emerging cyber threats. Instead of focusing solely on immediate alerts, this module can string together multiple low-level anomalies over an extended period to uncover advanced persistent threats. In some embodiments, the cyber threat analyst module 120 may formulate and test various cyber threat hypotheses regarding unusual prompt activity or subtle data exfiltration attempts. By mimicking the deductive reasoning of a human security professional, the cyber threat analyst module 120 can determine whether a complex chain of events indicates a coordinated attack.

The assessment module 125 is configured to evaluate the findings from the analytical modules to generate specific risk metrics. This component can calculate a threat level score indicating the severity of a potential cyber threat and a confidence score indicating the certainty of the detection. In certain embodiments, the assessment module 125 may weigh the sensitivity of the data involved, such as whether a prompt contains personal identifiable information, to adjust the final risk output. The scores produced by the assessment module 125 can be utilized to determine if an automated response action should be triggered or if the event requires human review.

The user interface/formatting module 130 is configured to translate complex machine learning outputs into human-readable alerts and visual dashboards. This module can generate reports detailing the steps taken during an automated investigation, including the hypotheses tested and the conclusions reached. In various embodiments, the user interface/formatting module 130 may present security administrators with a graphical representation of the detected anomalies, such as highlighting specific sensitive tokens within a blocked prompt. By providing clear and actionable insights, the user interface/formatting module 130 allows human teams to monitor the health of the system without being overwhelmed by raw data logs.

The data store 135 is configured to maintain comprehensive historical records of network activity and artificial intelligence interactions. This repository can store previous prompts, responses, vector embeddings, and network metadata for extended periods. In some embodiments, the data store 135 may provide the necessary historical context for training new autoencoder models or conducting similarity searches. The data store 135 can be continuously updated by the gather module to ensure that the system's baseline understanding of normal behavior remains accurate and up to date.

The autonomous response module/engine 140 is configured to execute mitigation actions without requiring manual human intervention. When a high-risk interaction is detected, this module can initiate targeted interventions to contain the threat and prevent data loss. In certain embodiments, the autonomous response module/engine 140 might disable a monitored connection through a reset message, alter a firewall policy, or modify a prompt by substituting sensitive information with placeholder values. By acting at machine speed, the autonomous response module/engine 140 can stop unauthorized agentic workflows or prompt injections before the payload reaches the external language model.

The first domain module 145 is configured to interact with and understand a specific segment of the monitored environment, such as an information technology endpoint network. This component can receive information from endpoint agents and parse standard network protocols traversing the local infrastructure. In various embodiments, the first domain module 145 may track device-level behaviors, such as which local applications are initiating connections to external services. The first domain module 145 ensures that the overarching security system maintains visibility into the foundational network layers supporting the user devices.

The second domain module 150 is configured to specialize in a different segment of the monitored environment, such as the generative artificial intelligence interaction domain. This module can possess specific algorithms designed to parse prompt structures, evaluate language model responses, and track application programming interface calls to external artificial intelligence services. In some embodiments, the second domain module 150 may interface with proxy servers or cloud gateways to intercept and structure the data flowing to and from the generative models. The second domain module 150 provides the dedicated context needed to analyze complex linguistic and algorithmic interactions.

The coordinator module 155 is configured to bridge the gap between the disparate domain modules. This component can tie an event occurring in the endpoint network to a corresponding event occurring in the artificial intelligence interaction space. In certain embodiments, the coordinator module 155 might link an unusual local file access detected by the first domain module to an unusual prompt submission detected by the second domain module. By correlating cross-domain activities, the coordinator module 155 helps the system build a holistic picture of a potential multi-stage cyberattack.

The AI models 160 comprise the overarching suite of mathematical algorithms and machine learning frameworks utilized by the security appliance. These models can range from unsupervised clustering algorithms to complex neural networks designed to mimic human analytical tradecraft. In various embodiments, the AI models 160 may be continuously updated and refined based on new data ingested by the system to improve their predictive accuracy. The AI models 160 provide the computational intelligence required to detect novel, previously unseen threats without relying on static signature lists.

The AI model normal pattern of life 2nd domain under analysis 161 is configured specifically to establish a baseline for the generative artificial intelligence interactions. This specialized model can track what constitutes typical prompt behavior, standard response lengths, and regular tool usage for a specific user or agent. In some embodiments, the AI model normal pattern of life 2nd domain under analysis 161 might employ an autoencoder ensemble to calculate a reconstruction loss for new interactions. The AI model normal pattern of life 2nd domain under analysis 161 can flag any linguistic or operational deviation that falls outside of the established historical norm.

The rules based model on how to conduct investigations 162 is configured to provide deterministic, logic-driven pathways for analyzing specific types of security events. This component can utilize hardcoded scripts and organizational policies to guide the cyber threat analyst module through a standardized investigative process. In certain embodiments, the rules based model on how to conduct investigations 162 might dictate the exact steps to follow when a known personal identifiable information format is detected in an outbound transmission. The rules based model on how to conduct investigations 162 ensures compliance with strict internal security guidelines while complementing the more flexible machine learning approaches.

The AI model on how to conduct investigations 163 is configured to dynamically determine the best analytical steps to take when confronted with an ambiguous threat. This model can be trained using supervised learning on the historical actions and decisions of expert human cyber security analysts. In various embodiments, the AI model on how to conduct investigations 163 may decide which additional data logs to query or which alternative hypotheses to test when the initial evidence is inconclusive. By emulating human intuition, the AI model on how to conduct investigations 163 can adapt to novel attack strategies that might bypass rigid, rule-based scripts.

The AI model potential cyber threats 164 is configured to identify the characteristics and symptoms of specific malicious activities. This model can be trained on a vast corpus of known attack vectors, including prompt injections, jailbreak attempts, and agentic data exfiltration techniques. In some embodiments, the AI model potential cyber threats 164 might act as a named entity recognition classifier to pinpoint sensitive corporate data hidden within a seemingly benign chat request. The AI model potential cyber threats 164 allows the system to quickly categorize an anomaly by matching it to the behavioral fingerprints of known threat profiles.

The AI model normal pattern of life 165 is configured to establish the baseline of typical operational behavior for the foundational network and its endpoints. This model can monitor standard metrics such as typical login times, average data transfer volumes, and regular internal routing paths. In certain embodiments, the AI model normal pattern of life 165 may identify when an endpoint device suddenly initiates connections to unusual external servers or accesses restricted internal databases. The AI model normal pattern of life 165 provides the comparative background needed to detect when an underlying machine has been compromised, even if the user's explicit prompts appear normal.

The cyber-attack simulator interface 175 is configured to provide a communicative bridge to an external or internal threat simulation engine. This interface can allow the detection modules to send current network state data to the simulator to model how an ongoing attack might escalate. In various embodiments, the cyber-attack simulator interface 175 might receive simulated attack vectors, such as a simulated lateral movement by a rogue artificial intelligence agent, to test the readiness of the autonomous response protocols. The cyber-attack simulator interface 175 helps the system proactively anticipate and prepare for sophisticated, multi-stage intrusions.

The I/O ports 175 are configured to manage the physical or logical data connections entering and exiting the appliance. These ports can handle the ingestion of mirrored network traffic, secure agent telemetry, and third-party threat intelligence feeds. In some embodiments, the I/O ports 175 may securely route the outbound autonomous response instructions to firewalls, endpoint agents, or cloud gateways. The I/O ports 175 ensure that the system maintains reliable and continuous connectivity with the broader enterprise infrastructure.

The restoration engine interface 190 is configured to connect the analytical and response modules to a system dedicated to post-incident recovery. This interface can facilitate the exchange of data needed to roll back affected systems to a known trusted state after a cyberattack is neutralized. In certain embodiments, the restoration engine interface 190 might signal the restoration engine to reverse unauthorized configuration changes made by a compromised generative artificial intelligence tool. The restoration engine interface 190 ensures a seamless transition from active threat mitigation to network healing and recovery.

The cyber security appliance 100 with the AI-based cyber security system may protect a network or domain from a cyber threat such as an insider attack leaking personal identifiable information (PII), malicious prompts, or compromised AI agents. The cyber security appliance 100 can protect all of the devices on the networks or domains being monitored. For example, an IT network domain module (e.g., the first domain module 145) may communicate with network sensors to monitor network traffic going to and from the computing devices on the network as well as receive secure communications from software agents embedded in host computing devices. Other domain modules such as the second domain module 150, which might operate as a generative AI interaction domain module, operate similarly within their specific scope to monitor API calls to external chatbots or internal LLM usage. The descriptions below will detail the activities and functions of several of the components in the cyber security appliance 100.

The gather module 110 is configured with one or more process identifier classifiers. Each process identifier classifier may be configured to identify and track one or more processes and devices in the network under analysis that are making communication connections to generative AI tools. The data store 135 cooperates with the process identifier classifier to collect and maintain historical data of processes and their connections, which is updated over time as the network is in operation. In an example, the process identifier classifier can identify each AI agent script running on a given device along with its endpoint connections, which are stored in the data store 135. In addition, a feature classifier can examine and determine features in the data being analyzed into different categories, such as classifying an interaction as a coding assistance request versus a general web search.

The analyzer module 115 can cooperate with the AI models 160 or other modules in the cyber security appliance 100 to confirm a presence of a cyber threat in a cyberattack against one or more domains in an enterprise's system. A process identifier in the analyzer module 115 can cooperate with the gather module 110 to collect any additional data and metrics to support a possible cyber threat hypothesis, such as pulling the last fifty prompts submitted by a specific user. Similarly, the cyber threat analyst module 120 can cooperate with the internal data sources as well as external data sources to collect data in its investigation. More specifically, the cyber threat analyst module 120 can cooperate with the other modules and the AI models 160 in the cyber security appliance 100 to conduct a long-term investigation and a more in-depth investigation of potential and emerging cyber threats directed to one or more domains in an enterprise's system. Herein, the cyber threat analyst module 120 and the analyzer module 115 can also monitor for other anomalies, such as model breaches, including deviations from a normal pattern of life for an entity interacting with an LLM. The analyzer module 115 and the cyber threat analyst module 120 can cooperate with the AI models 160 trained on potential cyber threats in order to assist in examining and factoring these additional data points that have occurred over a given timeframe to see if a correlation exists between a series of two or more anomalies occurring within that time frame and possible known and unknown cyber threats.

The cyber threat analyst module 120 allows two levels of investigations of a cyber threat that may suggest a potential impending cyberattack or data breach. In a first level of investigation, the analyzer module 115 and AI models 160 can rapidly detect and then the autonomous response module 140 will autonomously respond to overt and obvious cyberattacks, which are generally indicated by high scores of 80 or more on a confidence or threat scale. However, thousands to millions of low-level anomalies occur in a domain under analysis all of the time, such as users experimenting with new phrasing in their generative AI prompts. Most other systems need to set the threshold of trying to detect a cyberattack at a level higher than the low-level anomalies examined by the cyber threat analyst module 120 just to avoid having too many false positive indications of a cyberattack, as well as to not overwhelm a human cyber security analyst with notifications of low-level anomalies. However, advanced persistent threats attempt to avoid detection by making these low-level anomalies in the system over time during their cyberattack, such as an AI adversary red team slowly exfiltrating proprietary code block by block over several days, before making their ultimate mortal blow against the system being protected. The cyber threat analyst module 120 also conducts a second level of investigation over time with the assistance of the AI models 160 trained with machine learning on how to form cyber threat hypotheses and how to conduct investigations for a cyber threat hypothesis that can detect these advanced persistent cyber threats actively trying to avoid detection by looking at one or more of these low-level anomalies combined with other anomalies and factors as a part of a chain of linked information.

The artificial intelligence-based cyber security analyst tool can use the cyber threat analyst module 120 and its interaction with the other modules and AI models 160 in the cyber security appliance 100. The artificial intelligence-based cyber security analyst tool's investigations into potential cyber-attacks from potential cyber threats has the ability for customers to review the outcomes of the artificial intelligence-based cyber security analyst tool's investigations at the hypothesis-level and a human readable summary on why the system took the hypothesis steps taken and investigation steps taken and then its conclusion. For every compatible alert, such as a reconstruction loss model breach, the artificial intelligence-based cyber security analyst tool investigates a series of possible relevant hypotheses and tries to find data and activity that meets the criteria of those hypotheses. When the artificial intelligence-based cyber security analyst tool finds activity or data that meets the criteria that actually support a likelihood of a hypothesis, then those hypotheses are worth surfacing to an operator. The artificial intelligence-based cyber security analyst tool presents the most salient information to the end user.

The artificial intelligence-based cyber security analyst autonomously investigates alerts, streamlines investigations, and prioritizes incidents, thus reducing workload and alert fatigue. The artificial intelligence-based cyber security analyst uses various forms of machine learning, including unsupervised, supervised, and deep learning combined with human intuition and trade craft from hundreds of world-class human cyber analysts across thousands of customer deployments. The artificial intelligence-based cyber security analyst relieves a human cyber analyst from spending anywhere between half an hour and half a day investigating a single suspicious security incident involving prompt injections. The artificial intelligence-based cyber security analyst looks for patterns, forms hypotheses, reaches conclusions about how to mitigate the threat, and shares the findings with the rest of the business.

The artificial intelligence-based cyber security analyst continuously conducts investigations behind the scenes and operates at a speed and scale beyond human capabilities. The artificial intelligence-based cyber security analyst tool, optionally acting as a large language model itself, is built to incorporate cyber threat knowledge from external data stores, external data sources, as well as from a network's own cyber security appliance 100. The artificial intelligence-based cyber security analyst tool uses threat intelligence to understand a cyber threat adversary's tactics and motivations. An effectiveness of the artificial intelligence-based cyber security analyst tool lies in its ability to access and integrate diverse data sources. The artificial intelligence-based cyber security analyst module 120 can tap into external data stores, such as threat intelligence platforms and vulnerability databases, to enrich its understanding of the generative AI threat landscape.

The cyber threat analyst module 120 forms in conjunction with the AI models 160 trained with machine learning on how to form cyber threat hypotheses and how to conduct investigations for a cyber threat hypothesis to investigate hypotheses on what are a possible set of cyber threats. The cyber threat analyst module 120 can also cooperate with the analyzer module 115 with its one or more data analysis processes to conduct an investigation on a possible set of cyber threats hypotheses that would include an anomaly of at least one of the abnormal behavior, the suspicious activity, or any combination of both, identified through cooperation with the AI models 160 trained with machine learning on the normal pattern of life of entities in the system. For example, the cyber threat analyst module 120 may perform several additional rounds of gathering additional information, including abnormal prompt behavior, over a period of time, such as examining data over a 7-day period to determine causal links between the information. The cyber threat analyst module 120 may submit to check and recheck various combinations of potentially related information, including abnormal behavior of an AI agent under analysis, until each of the one or more hypotheses on potential cyber threats are one of refuted, supported, or included in a report that includes details of activities assessed to be relevant activities to the anomaly of interest to the user. For this embodiment, a human cyber security analyst might then be needed to further investigate the anomaly of interest included in the chain of potentially related information.

An input from the cyber threat analyst module 120 of a supported hypothesis of a potential cyber threat will trigger the analyzer module 115 and the assessment module 125 to compare, confirm, and send a signal to act upon and mitigate that cyber threat. In contrast, the cyber threat analyst module 120 investigates subtle indicators and initially seemingly isolated unusual or suspicious activity such as a local script initiating an API call to an LLM after normal working hours. Most of the investigations conducted by the cyber threat analyst module 120 cooperating with the AI models 160 trained with machine learning on how to form cyber threat hypotheses and how to conduct investigations for a cyber threat hypothesis on unusual or suspicious activities may not result in a cyber threat hypothesis that is supported, but rather most cyber threat hypotheses are refuted or simply not supported. Typically, during the investigations, several rounds of data gathering to support or refute the long list of potential cyber threat hypotheses formed by the cyber threat analyst module 120 will occur before the algorithms in the cyber threat analyst module 120 will determine whether a particular cyber threat hypothesis is supported, refuted, or needs further investigation by a human. The rounds of data gathering will build chains of linked low-level indicators of unusual activity along with potential activities that could be within a normal pattern of life for that entity to evaluate the whole chain of activities to support or refute each potential cyber threat hypothesis formed. The investigations by the cyber threat analyst module 120 can happen over a relatively long period of time and be far more in depth than the analyzer module 115, which will work with the other modules and AI models 160 to confirm that a cyber threat has in fact been detected by the presence of an anomaly with a score of 75 or more or the occurrence of a specific event deemed a serious cyber threat in itself.

The gather module 110 cooperates with the cyber threat analyst module 120 and the analyzer module 115 to collect data to support or to refute each of the one or more possible cyber threat hypotheses that could include this abnormal behavior or suspicious activity by cooperating with one or more of the cyber threat hypotheses mechanisms to form and investigate hypotheses on what are a possible set of cyber threats.

Thus, the cyber threat analyst module 120 is configured to cooperate with the AI models 160 trained with machine learning on how to form cyber threat hypotheses and how to conduct investigations for a cyber threat hypothesis to form and investigate hypotheses on what are a possible set of cyber threats and then can cooperate with the analyzer module 115 with the one or more data analysis processes to confirm the results of the investigation on the possible set of cyber threats hypotheses that would include the abnormal behavior, the suspicious activity, or any combination of both, identified through cooperation with the AI models 160 trained with machine learning on the normal pattern of life of entities in the domains under analysis.

In the first level of threat detection, the gather module 110 and the analyzer module 115 cooperate to supply any data and metrics requested by the analyzer module 115 cooperating with the AI models 160 trained on possible cyber threats to support or rebut each possible type of cyber threat. Generally, that presence of an anomaly with a high threat or anomaly score, or the occurrence of a specific event deemed a serious cyber threat in itself, will cause the analyzer module 115 to send a signal and this information to the autonomous response module 140. Again, the analyzer module 115 can cooperate with the AI models 160 and other modules to rapidly detect and then cooperate with the autonomous response module 140 to autonomously respond to overt and obvious cyberattacks.

As a starting point, the AI-based cyber security appliance 100 can use multiple modules, each capable of identifying abnormal behavior and suspicious activity against the AI models 160 trained on a normal pattern of life for the entities in the network or domain under analysis, which is supplied to the analyzer module 115 and the cyber threat analyst module 120. The analyzer module 115 and the cyber threat analyst module 120 may also receive other inputs such as AI model breaches or AI classifier breaches as a trigger to start an investigation from an external source.

Many other model breaches of the AI models 160 trained with machine learning on the normal behavior of the system can send an input into the cyber threat analyst module 120 and the trigger module to trigger an investigation to start the formation of one or more hypotheses on what are a possible set of cyber threats that could include the initially identified abnormal behavior and suspicious activity.

The cyber threat analyst module 120, which forms and investigates hypotheses on what are the possible set of cyber threats, can use hypotheses mechanisms including any of one or more of the AI models 160 trained on how human cyber security analysts form cyber threat hypotheses and how to conduct investigations for a cyber threat hypothesis that would include at least an anomaly of interest, one or more scripts outlining how to conduct an investigation on a possible set of cyber threats hypotheses that would include at least the anomaly of interest, one or more rules-based models on how to conduct an investigation on a possible set of cyber threats hypotheses and how to form a possible set of cyber threats hypotheses that would include at least the anomaly of interest, and any combination of these. Again, the AI models 160 trained on how to form cyber threat hypotheses and how to conduct investigations for a cyber threat hypothesis may use supervised machine learning on human-led cyber threat investigations and then steps, data, metrics, and metadata on how to support or to refute a plurality of the possible cyber threat hypotheses, and then the scripts and rules-based models will include the steps, data, metrics, and metadata on how to support or to refute the plurality of the possible cyber threat hypotheses. The cyber threat analyst module 120 and the analyzer module 115 can feed the cyber threat details to the assessment module 125 to generate a threat risk score that indicates a level of severity of the cyber threat.

Each artificial intelligence-based engine has an interface to communicate with another separate artificial intelligence-based engine, which is configured to understand a type of information and communication that this other separate artificial intelligence-based engine needs to make determinations on an ongoing cyberattack from that other artificial intelligence-based engine's perspective. The autonomous response module 140 works with the assessment module 125 in the detection engine when the cyber threat is detected and autonomously takes one or more actions to mitigate the cyber threat. The detection engine is configured to include interfaces to the cyber-attack simulator via the cyber-attack simulator interface 175 and the restoration engine via the restoration engine interface 190.

The cyber threat detection engine can also have an anomaly alert system in a user interface and formatting module 130 configured to report out anomalous incidents and events as well as the cyber threat detected to a display screen viewable by a human cyber-security professional. Each artificial intelligence-based engine might utilize a rapid messaging system to communicate with a human cyber-security team to keep the human cyber-security team informed on actions autonomously taken and actions needing human approval to be taken.

The assessment module 125 and the cyber threat analyst module 120 can cooperate with the AI models 160 trained on possible cyber threats to use AI algorithms to account for ambiguities by distinguishing between the subtly differing levels of evidence that characterize network data. Instead of generating simple binary outputs indicating malicious or benign, the mathematical algorithms produce outputs marked with differing degrees of potential threat. This enables users of the system to rank alerts and notifications to the enterprise security administrator in a rigorous manner and prioritize those which most urgently require action. Meanwhile, it also assists to avoid the problem of numerous false positives associated with simply a rule-based approach.

The gather module 110 cooperates with the data store 135. The data store 135 stores comprehensive logs for network traffic observed, generative AI tool access requests, prompt payloads, cloud activity, and other interaction data. These logs can be filtered with complex logical queries and each API interaction can be interrogated on a vast number of metrics in the network information stored in the data store 135. The gather module 110 pulls data relevant for each possible hypothesis from the data store 135 as well as from additional external and internal sources. In an example, the data store 135 can store the metrics and previous threat alerts associated with an endpoint agent's AI tool interactions for a period of time, which is, by default, at least 27 days. This corpus of data is fully searchable. The cyber security appliance 100 works with network probes to monitor network traffic and store and record the data and metadata associated with the network traffic in the data store 135.

The gather module 110 may have a process identifier classifier. The process identifier classifier can identify and track each process and device in the network making communication connections. The data store 135 cooperates with the process identifier classifier to collect and maintain historical data of processes and their connections, which is updated over time as the network is in operation. In an example, the process identifier classifier can identify each application running on a given device along with its endpoint connections, which are stored in the data store 135. Similarly, data from any of the domains under analysis may be collected and compared. Examples of domains under analysis being protected can include any of an Informational Technology network, an Operational Technology network, a Cloud service, a generative AI integration environment, an endpoint device, and any combinations of these.

A domain module is constructed and coded to interact with and understand a specific domain. For instance, the first domain module 145 may receive information from and send information to endpoint-based sensors. The first domain module 145 also has algorithms and components configured to understand endpoint network parameters, protocols, activity, and other characteristics of the network under analysis. The second domain module 150 is, in this example, a generative AI interactions module. The second domain module 150 can receive information from and send information to cloud-based LLM APIs or proxy servers intercepting generative AI traffic. The second domain module 150 also has algorithms and components configured to understand prompt structures, vector embeddings, clustering spaces, and other characteristics of the generative AI landscape under analysis.

The coordinator module 155 is configured to work with various machine learning algorithms and relational mechanisms to assess, annotate, and position in a vector diagram or a relational database activity occurring in the first domain compared to activity occurring in the second domain. The domain modules can cooperate to exchange and store their information with the data store 135.

As discussed, the process identifier classifier in the gather module 110 can cooperate with additional classifiers in each of the domain modules to assist in tracking individual processes and associating them with entities in a domain under analysis as well as individual processes and how they relate to each other. The process identifier classifier can cooperate with other trained AI classifiers in the modules to supply useful metadata along with helping to make logical nexuses. A feedback loop of cooperation exists between the gather module 110, the analyzer module 115, the domain specific modules, the AI models 160 trained on different aspects of this process, and the cyber threat analyst module 120 to gather information to determine whether a cyber threat is potentially attacking the networks and domains under analysis.

In the following narrative example, the analyzer module 115 and the cyber threat analyst module 120 can use multiple factors in the determination of whether an event is likely malicious. To illustrate, an endpoint device might suddenly attempt to establish a secure connection to an unapproved LLM provider. The analyzer module 115 can cooperate with one or more of the AI models 160 trained on certain cyber threats to detect whether the anomalous activity detected exhibits traits that may suggest a malicious intent, such as data exfiltration or a network policy violation. The analyzer module 115 can also cooperate with one or more of the AI models 160 trained on potential AI-based cyber threats to detect whether the anomalous activity detected may suggest a malicious intent.

In the above example, the analyzer module 115 and the cyber threat analyst module 120 can cooperate with the one or more AI models 160 trained with machine learning on the normal pattern of life 165 for entities in a domain under analysis to detect anomalous prompts which are detected as outside of the usual pattern of life for each entity of the network. Likewise, the analyzer module 115 can cooperate with the one or more AI models 160 trained with machine learning on the normal pattern of life for entities in a second domain under analysis to detect anomalous network activity by users and devices in the network, which is detected as outside of the usual pattern of life for each entity.

Thus, the analyzer module 115 and the cyber threat analyst module 120 can be configured with one or more data analysis processes to cooperate with the one or more of the AI models 160 trained with machine learning on the normal pattern of life in the system, to identify an anomaly of at least one of the abnormal behavior, the suspicious activity, or the combination of both, from one or more entities in the system. Note, other sources, such as other model breaches, can also identify at least one of the abnormal behaviors, the suspicious activity, and the combination of both, to trigger the investigation.

Accordingly, during this cyber threat determination process, the analyzer module 115 and the cyber threat analyst module 120 can also use AI classifiers that look at the features and determine a potential maliciousness based on commonality or overlap with known characteristics of malicious processes. Many factors, including anomalies that include unusual and suspicious behavior, and other indicators of processes and events, are examined by the one or more AI models 160 trained on potential cyber threats including some supporting AI classifiers looking at specific features for their malicious nature in order to make a determination of whether an individual factor or a chain of anomalies is determined to be likely malicious.

Initially, in this example of activity in an AI interaction analysis, rare token clusters or rare centroid distances for this network coming from a new or unusual prompt are factored just like suspicious network protocols are considered. These are quickly determined by referencing the one or more of the AI models 160 trained with machine learning on the pattern of life of each device and its associated processes in the system. Next, the analyzer module 115 and the cyber threat analyst module 120 can have an external input to ingest threat intelligence from other devices in the network cooperating with the cyber security appliance 100. Next, the analyzer module 115 and the cyber threat analyst module 120 can look for other anomalies, such as model breaches, while the AI models 160 trained on potential cyber threats can assist in examining and factoring other anomalies that have occurred over a given timeframe to see if a correlation exists between a series of two or more anomalies occurring within that time frame.

The analyzer module 115 and the cyber threat analyst module 120 can combine these indicators of compromise with many other weak indicators to detect the earliest signs of an emerging threat, including previously unknown threats, without using strict blacklists or hard-coded thresholds. However, the AI classifiers can also routinely look at blacklists to identify maliciousness of features looked at. A deeper analysis may assist in confirming an analysis to determine that indeed a cyber threat has been detected. The analyzer module 115 can also look at factors of how rare the endpoint connection is, how old the endpoint is, where geographically the endpoint is located, and how a security certificate associated with a communication is verified only by an endpoint device or by an external third party. The analyzer module 115 can then assign weighting given to these factors in the machine learning that can be supervised based on how strongly that characteristic has been found to match up to actual malicious cyber threats learned in the training.

In another example, an AI classifier supporting the AI models 160 is trained to find potentially malicious indicators in prompt texts. The agent analyzer data analysis process in the analyzer module 115 and the cyber threat analyst module 120 may cooperate with the process identifier classifier to identify all of the additional factors, which are referenced and compared to one or more AI models 160 trained with machine learning on the normal behavior of the pattern of life of the system.

The analyzer module 115 and the cyber threat analyst module 120 may use the agent analyzer data analysis process that detects a potentially malicious agent previously unknown to the system to start an investigation on one or more possible cyber threat hypotheses. The determination and output of this step is what are possible cyber threats that can include or be indicated by the identified abnormal behavior and identified suspicious activity identified by the agent analyzer data analysis process.

In an example, the cyber threat analyst module 120 can use the agent analyzer data analysis process and the AI models 160 trained on forming and investigating hypotheses on what are a possible set of cyber threats to use the machine learning to aid in forming one or more hypotheses to support or refute each hypothesis. The cyber threat analyst module 120 can cooperate with the AI models 160 trained on forming and investigating hypotheses to form an initial set of possible hypotheses, which needs to be intelligently filtered down. The cyber threat analyst module 120 can be configured to use the one or more supervised machine learning models trained on agnostic examples of a past history of detection of a multitude of possible types of cyber threat hypotheses previously analyzed by humans, a behavior and input of how a plurality of human cyber security analysts make a decision and analyze a risk level regarding a potential cyber threat, and steps to take to conduct an investigation starting with an anomaly via learning how expert humans tackle investigations.

The cyber threat analyst module 120 using AI models, scripts and rules based modules is configured to conduct initial investigations regarding the anomaly of interest, collect additional information to form a chain of potentially related information under analysis and then form one or more hypotheses that could have this chain of information that is potentially related under analysis and then gather additional information in order to refute or support each of the one or more hypotheses.

In an example, a behavioral pattern analysis of what are the unusual behaviors of the network, system, device, or user under analysis by the machine learning models may be as follows. The coordinator module 155 can tie the alerts, activities, and events from, in this example, the generative AI interaction domain to the alerts, activities, and events from the endpoint network domain.

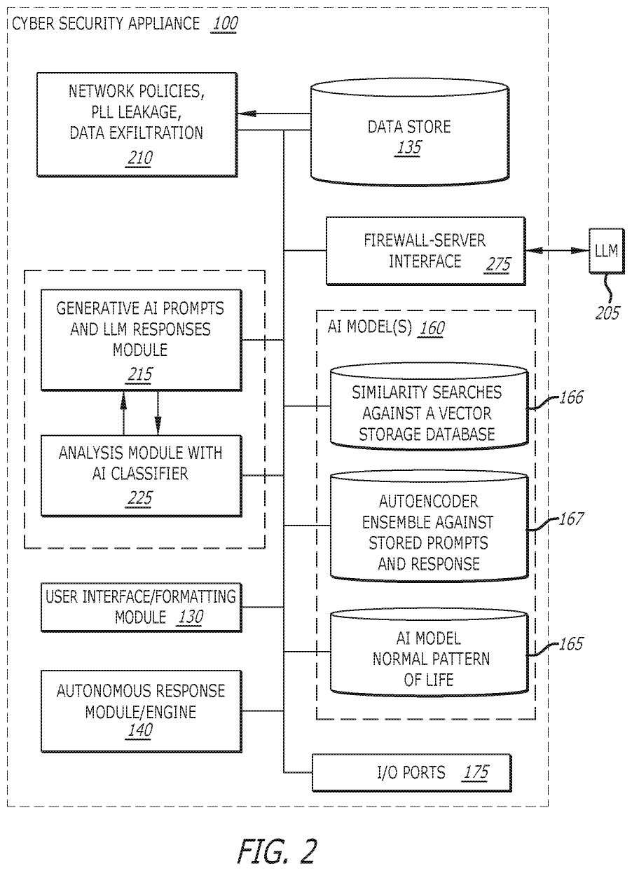

Although a specific embodiment for an artificial intelligence based cyber security appliance for carrying out the various steps, processes, methods, and operations described herein is discussed with respect to FIG. 1, any of a variety of systems and/or devices may be utilized in accordance with embodiments of the disclosure. For example, the cyber threat analyst module could be hosted entirely within a scalable cloud platform instead of on a local appliance, or the AI models could utilize supervised deep learning networks in place of or in addition to rules-based models. The elements depicted in FIG. 1 may also be interchangeable with other elements of FIGS. 2-15 as required to realize a particularly desired embodiment.

FIG. 2 illustrates a block diagram of an embodiment of the cyber security appliance 100 featuring components specifically tailored for monitoring and securing generative artificial intelligence interactions. The cyber security appliance 100 can be configured as a specialized deployment or a subset of the broader architecture previously detailed, operating within a network to protect against data exfiltration or malicious prompt engineering. While this figure highlights the components unique to the large language model focused aspects of this design, it should be understood that this embodiment is just one of many possible configurations. Accordingly, it is assumed that other components of the appliance, such as the cyber threat analyst module or the gather module shown in the embodiment depicted in FIG. 1, may be available and seamlessly utilized in this embodiment to provide a comprehensive defense strategy.

The network policies, PII leakage, and data exfiltration 210 are sensitive information covered by the targeted security rules and classification categories enforced by the system. This component can maintain the specific definitions of what constitutes restricted corporate data, personal identifiable information, or a violation of acceptable artificial intelligence usage. In various embodiments, the network policies, PII leakage, data exfiltration 210 might provide the foundational criteria against which every outgoing prompt and incoming response is measured. This enables the appliance to maintain strict compliance with regulatory frameworks by instantly recognizing when an interaction attempts to bypass established data governance boundaries.

The data store 135 is configured to securely retain the vast amounts of telemetry and textual data generated by the artificial intelligence interactions. This repository can hold historical user prompts, model responses, generated vector embeddings, and the corresponding anomaly scores for extended periods of time. In some embodiments, the data store 135 may act as the primary reference database for conducting similarity searches and training new baseline models. In this manner, the system can continuously adapt to evolving user behaviors by ensuring that the machine learning models have access to a rich, locally maintained corpus of historical interaction data.

The firewall-server interface 275 is configured to manage the network traffic flowing between the internal enterprise environment and external or internal generative models. This interface can operate as a secure checkpoint, intercepting application programming interface calls and chat sessions before they leave the protected network. In certain embodiments, the firewall-server interface 275 might integrate directly with existing network security appliances to enforce blocking or TCP reset commands issued by the autonomous response engine. Accordingly, it can be seen that this component provides the critical physical or logical choke point required to halt unauthorized data exfiltration in real time. Note, in an embodiment the Application Programming Interfaces interactions with enterprise AI services such as the APIs of the generative model can be used to manage the network traffic flowing between the internal enterprise environment and external or internal generative models as discussed herein. In an embodiment, both the firewall server interface 275 and the API interactions with enterprise AI services, can be used to manage the network traffic flowing between the internal enterprise environment and external or internal generative models can be used to manage the network traffic flowing between the internal enterprise environment and external or internal generative models as discussed herein.

The LLM 205 is configured to represent the large language model or generative artificial intelligence agent that the users or internal systems are attempting to interact with. This model can be a third-party cloud-based chatbot, an internally hosted generative tool, or an agentic script utilizing natural language processing. In various embodiments, the LLM 205 may receive complex prompts and generate detailed responses, code snippets, or data summaries that could pose a security risk if left unmonitored. By treating the LLM 205 as a distinct entity outside or inside the trust boundary, the system can meticulously scrutinize all data crossing the threshold into the model's processing environment.

The generative AI prompts and LLM responses module 215 is configured to specifically isolate and manage the bidirectional text streams characterizing an artificial intelligence session. This module can extract the exact textual payload of a user's prompt and the corresponding output generated by the model, stripping away unnecessary network headers. In some embodiments, the generative AI prompts and LLM responses module 215 might parse multi-turn chat conversations to maintain the context of a prolonged interaction. This targeted extraction enables the downstream classifiers to focus their computational resources entirely on the semantic meaning of the interaction rather than decoding raw network packets.

The analysis module with AI classifier 225 is configured to perform deep inspection and categorization of the extracted interaction text. This component can employ advanced natural language processing techniques, such as named entity recognition, to identify specific sensitive data types hidden within a conversational prompt. In certain embodiments, the analysis module with AI classifier 225 may evaluate the text to determine if a user is attempting a prompt injection attack or trying to trick the model into revealing restricted information. In this manner, the system can accurately flag interactions that technically comply with basic network protocols but still pose a severe semantic or intellectual property risk.

The user interface/formatting module 130 is configured to translate the complex determinations made by the artificial intelligence classifiers into actionable insights for human administrators. This module can generate visual dashboards that highlight specific policy violations, such as color-coding a masked social security number within a blocked prompt. In various embodiments, the user interface/formatting module 130 might compile daily reports summarizing the overall generative artificial intelligence usage across the enterprise, pinpointing the most frequently accessed models and the most common risk factors. This enables security teams to quickly understand and validate the autonomous decisions made by the appliance without needing to manually decipher raw machine learning outputs.

The autonomous response module/engine 140 is configured to execute immediate, machine-speed mitigation actions when an unauthorized interaction is confirmed. This engine can initiate a variety of interventions, ranging from outright blocking the connection to dynamically altering the payload in transit. In some embodiments, the autonomous response module/engine 140 might seamlessly replace sensitive data identified by the classifiers with generic placeholder values, allowing a sanitized version of the prompt to safely reach the language model. Accordingly, it can be seen that this module provides a critical layer of active defense, mitigating data exfiltration risks dynamically while minimizing disruptions to legitimate business workflows.

The AI models 160 comprise the specialized suite of mathematical frameworks dedicated to evaluating the safety and normalcy of the generative interactions. These models can incorporate both supervised classification techniques for known threats and unsupervised learning algorithms for detecting novel anomalies. In certain embodiments, the AI models 160 may operate in tandem, utilizing multi-layered evaluations to reduce false positives and generate a highly accurate, composite threat score. By leveraging a diverse array of machine learning approaches, this component ensures that the appliance can adapt to the rapidly evolving landscape of artificial intelligence-based cyber attacks.

The similarity searches against a vector storage database 166 is configured to evaluate the semantic intent of a new interaction by comparing it to historically observed behaviors. This model can convert the text of a prompt into a high-dimensional vector embedding and measure its mathematical distance from established cluster centroids representing normal usage. In various embodiments, the similarity searches against a vector storage database 166 might identify that a prompt asking for proprietary source code summaries is semantically far removed from a user's typical queries about marketing analytics. This enables the system to detect anomalous intent even if the user employs novel phrasing or vocabulary that has never been explicitly blacklisted.

The autoencoder ensemble against stored prompts and responses 167 is configured to provide an unsupervised, reconstruction-based method for anomaly detection. This specialized model can ingest a new interaction, attempt to compress and reconstruct it based on its training, and then calculate a reconstruction loss score indicating how unusual the data is. In some embodiments, the autoencoder ensemble against stored prompts and responses 167 may utilize a rolling window of multiple autoencoders, frequently aging off older models and training new ones to accurately reflect the shifting pattern of life of the organization. In this manner, the appliance can identify highly subtle, out-of-distribution prompts that signify a compromised account or a slow-moving insider threat.

The AI model normal pattern of life 165 is configured to maintain the foundational baseline of acceptable behavior for users and devices across the broader network. This model can track contextual metadata surrounding the artificial intelligence interaction, such as the time of day, the geolocation of the endpoint, and the typical frequency of application programming interface calls. In certain embodiments, the AI model normal pattern of life 165 might flag an interaction as highly suspicious if a user attempts to access a language model at three in the morning from an unrecognized external internet protocol address, regardless of the prompt's actual contents. This provides an essential layer of contextual security, ensuring that environmental anomalies are factored into the final risk assessment of the generative interaction.

The I/O ports 175 are configured to manage the secure transmission of data into and out of the specialized appliance. These physical or logical ports can handle the high-volume ingestion of parsed prompt data from remote endpoint agents and the secure delivery of autonomous response commands. In various embodiments, the I/O ports 175 might facilitate the connection to external threat intelligence feeds, allowing the system to update its classifiers with the latest known malicious prompt structures. Accordingly, it can be seen that this component ensures the appliance remains tightly integrated with the broader enterprise network and external security resources.

In one embodiment, an organization could deploy the cyber security appliance 100 to protect against accidental data exposure by well-meaning employees. For instance, a human resources representative might attempt to use a public LLM 205 to summarize a batch of internal employee performance reviews. As the user submits the request, the generative AI prompts and LLM responses module 215 can intercept and extract the exact text of the prompt. The analysis module with AI classifier 225 can evaluate this extracted text against the network policies, PII leakage, data exfiltration 210. Upon detecting sensitive personal identifiable information, such as employee names, home addresses, and salaries, the system can trigger an intervention. The autonomous response module/engine 140 can dynamically mask the sensitive data by substituting the identified terms with generic placeholder values before the data crosses the firewall-server interface 275. This enables the employee to still receive the desired AI-generated summary from the generative artificial intelligence tool without inadvertently compromising the organization's confidential human resources data.

In one embodiment, a software engineering enterprise could utilize the system to prevent the intentional loss or exfiltration of proprietary intellectual property. A departing or disgruntled software developer might attempt to copy large sections of proprietary backend source code and paste them into an external LLM 205 to generate unauthorized personal applications or transfer the code off-premises. Likewise, in another example, a software developer not being aware this software is actually proprietary backend source code might violate this policy. In any example, the generative AI prompts and LLM responses module 215 can capture these outgoing interactions. To evaluate the intent behind the prompt, the similarity searches against a vector storage database 166 can convert the developer's prompt into a high-dimensional vector embedding. If the mathematical distance of this vector heavily deviates from the user's established historical centroids, or if the autoencoder ensemble against stored prompts and responses 167 calculates a high reconstruction loss indicating a rare bulk code-dump event, the system can generate a critically high anomaly score. The autonomous response module/engine 140 can then instantly sever the network connection via the firewall-server interface 275. Accordingly, it can be seen that the cyber security appliance 100 can halt intellectual property theft in real time before the proprietary source code ever leaves the secure enterprise boundary.

In one embodiment, the cyber security appliance 100 could provide significant value by securing automated, agentic artificial intelligence workflows operating within a corporate network. An organization might deploy an internal AI agent configured with permissions to read daily sales databases and autonomously draft summary emails using an external LLM 205. If a malicious external actor successfully executes a prompt injection attack against this internal agent, the agent might suddenly alter its behavior, attempting to query unauthorized corporate financial databases and forward that highly restricted data within a prompt to an unapproved external server. The gather module 110 can track this unusual internal process connection and data access. The cyber threat analyst module 120 can correlate the unauthorized internal database access with the subsequent anomalous outbound prompt. The AI model normal pattern of life 165 can recognize this chain of events as highly suspicious because the agent is operating far outside its assigned operational limits. Consequently, the autonomous response module/engine 140 can autonomously revoke the specific AI agent's network access permissions and isolate the affected machine. This enables the security team to contain a compromised machine-to-machine workflow instantly, ensuring that a hijacked AI agent cannot exfiltrate data, while allowing the rest of the organization to continue utilizing their uncompromised artificial intelligence tools safely.

Although a specific embodiment for a cyber security appliance tailored for monitoring generative artificial intelligence interactions for carrying out the various steps, processes, methods, and operations described herein is discussed with respect to FIG. 2, any of a variety of systems and/or devices may be utilized in accordance with embodiments of the disclosure. For example, the autoencoder ensemble against stored prompts and responses could be implemented natively within the endpoint agent rather than centrally on the appliance, or the user interface might be delivered as a managed cloud service rather than an on-premises dashboard. The elements depicted in FIG. 2 may also be interchangeable with other elements of FIG. 1 and FIGS. 3-15 as required to realize a particularly desired embodiment.

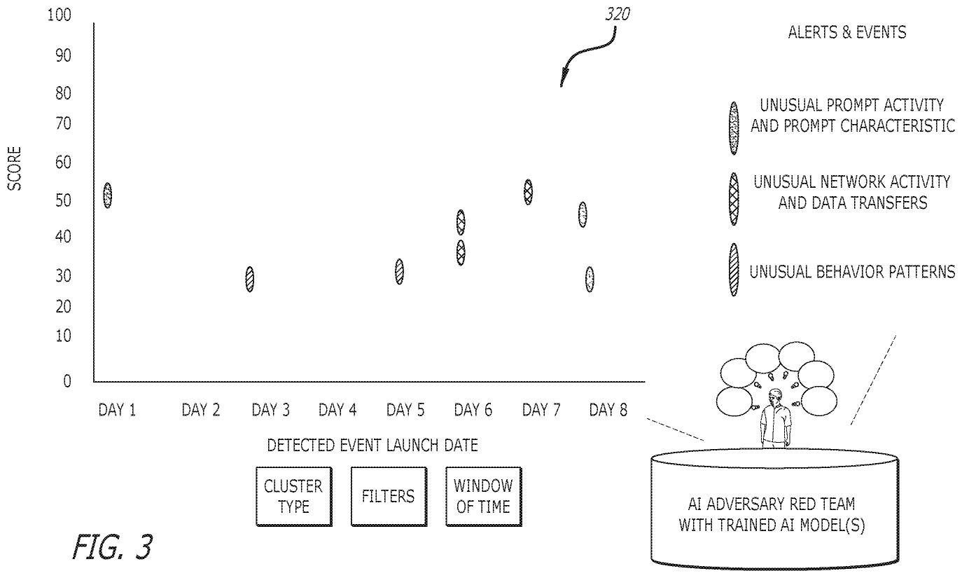

Referring to FIG. 3, the graph 320 illustrating an example chain of unusual behavior in accordance with various embodiments of the disclosure is shown. In many embodiments, the graph 320 can depict a visualization of prompt activities and network activities that deviate from a normal pattern of life in connection with the rest of the monitored system or network. The analytic logic may be configured to allow for multiple levels of investigation of a cyber threat that might suggest a potential impending cyberattack or data exfiltration event. In a first level of investigation, the analytic logic and the classifier can rapidly detect overt and obvious malicious interactions, which are generally indicated by high anomaly scores of 80 or more on a 0 to 100 score scale, and the autonomous response module is configured to autonomously respond to these immediate threats. However, the analytic logic may also be configured to conduct a second level of investigation over a window of time with the assistance of the pattern of life (POL) models.

These POL models can be trained with machine learning to assist in forming cyber threat hypotheses and conducting investigations over time. This approach can detect advanced persistent cyber threats or subtle insider threats that are actively trying to avoid detection by executing actions that generate low anomaly scores. To accomplish this, the analytic logic might look at one or more low-level anomalies and combine them with other anomalies and factors as a part of a chain of linked information. For example, as depicted in the graph 320, the analytic logic may perform several rounds of gathering additional alerts and events over a window of time, such as examining data over an eight-day period, to determine causal links between seemingly disparate pieces of information. A chain of related activities that can include both unusual activity and activity within a pattern of normal life for that entity can be formed and checked against individual cyber threat hypotheses to determine whether that overall pattern is indicative of the behavior of a malicious actor.

In a narrative example of this process, the analytic logic is configured to detect a chain of anomalous behavior comprising multiple low-level indicators, all registering under a score of 50 on the threat indicator scale. Over the course of the depicted time frame, the analytic logic might detect unusual network activity and data transfers occurring on three separate occasions. Furthermore, the system might detect unusual prompt activity and prompt characteristics originating from the same user or endpoint computing device three times within the same window of time. These unusual prompt characteristics might involve a user attempting to bypass the safety filters of a generative AI tool or subtly inputting fragmented personal identifiable information (PII) into the prompt across multiple days. The analytic logic can be configured to find a causal link between the unusual network data transfers and the unusual prompt activities.

Likewise, the system might detect unusual behavior patterns, such as an AI agent or a user attempting to gain unauthorized access to sensitive internal databases, occurring twice during this period. The analytic logic can be configured to establish a causal link between these unusual behavior patterns and at least one of the prompts containing unusual characteristics. To build this chain of evidence, the analytic logic can go back and pull in some of the entity's normal activities to help support or refute a possible hypothesis of whether the overall pattern is indicative of malicious behavior. The analytic logic might be configured to organize data and entities by a specific cluster type, a directed graph, a vector diagram, or a relational database to identify nodes that are overlapping or close in distance, suggesting a relationship based on similar times, similar entities, or similar activities. An administrator might apply various filters to the graph 320 to isolate these specific data points.

If the pattern of behaviors under analysis is believed to be indicative of a malicious actor executing a coordinated attack leading up to a detected event launch date, such as an AI adversary red team utilizing trained AI models to probe the network, a confidence score can be generated. This score indicates how confident the system is in its assessment that the unusual pattern was caused by a malicious actor. Next, an overall threat level score or probability can be assigned, indicative of the severity of the threat posed by this activity. The cyber security appliance is configurable via a user interface, enabling an administrator to define what type of automatic response actions the autonomous response module is configured to take when different types of cyber threats reach or exceed a configurable threat level. Consequently, by analyzing the chain of distinct alerts, activities, and events, the system can detect subtle, low-scoring anomalies that individually might not trigger an alarm but collectively represent a significant threat to the AI-based environment.

Although a specific embodiment for a graph illustrating an example chain of unusual behavior for carrying out the various steps, processes, methods, and operations described herein is discussed with respect to FIG. 3, any of a variety of systems and/or devices may be utilized in accordance with embodiments of the disclosure. For example, the visual representation could utilize a three-dimensional cluster map or a continuous real-time sliding window with a color-coded threat matrix rather than a two-dimensional timeline graph with a numerical score scale. The elements depicted in FIG. 3 may also be interchangeable with other elements of FIGS. 1-2 and FIGS. 4-15 as required to realize a particularly desired embodiment.

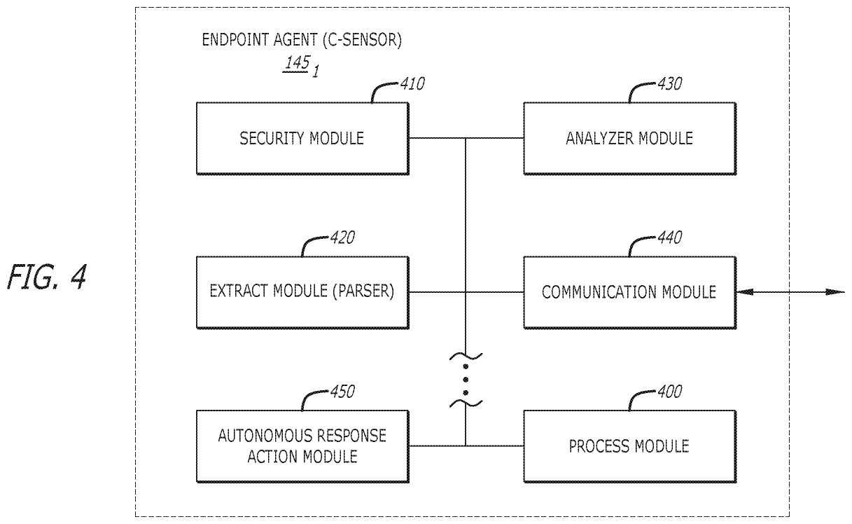

Herein, FIG. 4 depicts an exemplary c-sensor 1451 and the one or more modules utilized by the c-sensor 1451. Specifically, the embodiment depicted in FIG. 4 shows a first endpoint agent 1451 which may be referred to as a c-sensor 1451 and can be deployed on a wide range of managed endpoint computing devices. This and other related embodiments show the logical architecture of an endpoint computing device installed with an endpoint agent to monitor and collect information, and thereafter, provide the collected information to a generative artificial intelligence (AI) interaction module. In various embodiments, the other c-sensors deployed within the system can also contain similar components to those illustrated in this exemplary architecture.

According to one embodiment of the disclosure, the c-sensor 1451 may comprise a process module 400 configured to integrate into and monitor processes operating and resident on the endpoint computing device as a first set of process data, and a security module 410 having an interface to cooperate with and integrate with an operating system (OS) of the endpoint computing device. The c-sensor 1451 may also include an extract module 420 configured to detect and extract the information associated with the interactions to and from the endpoint computing device 1401. The c-sensor 1451 may optionally include an analyzer module 430 with connection analytic logic to analyze the interaction information along with a communication module 440 to send the interaction information securely to a classifier in the cyber security appliance 100 and/or to the scalable cloud platform. The c-sensor 1451 may have an autonomous response module 450 configured to perform autonomous action(s) that are correlated to initiating blocking or modifying actions on the interaction with the AI agent and/or alerts in response to the classification of the monitored interactions determined to be anomalous and/or unauthorized leaks of network policies, PII leakage, data exfiltration.

The c-sensor 1451, by extending visibility to endpoint computing devices even when they are disconnected from the network, enables the cyber threat defense system to cover branch offices and remote workers working on endpoint computing devices off the network (such as an organization's virtual private networks (VPNs). In addition, a light version of the c-sensor 1451 can be employed in an endpoint computing device such as an loT device that has less computing power than an endpoint computing device of a laptop computing device. As such, the c-sensor 1451 can be deployed on a range of managed endpoint computing devices. This, therefore, allows the systems to analyze real-time network traffic, for example, of remote workers working on an endpoint device, in the same way the cyber security appliance 100 analyzes network traffic and its metadata in its network by correlating a web of connections to develop an evolving understanding of workforce behavior. Furthermore, the c-sensors 1451-145N described herein provide much-needed visibility of suspicious connectivity to the endpoint computing devices 1401-140N.

By extending visibility to endpoint computing devices even when they are disconnected from a primary enterprise network, the first c-sensor 1451 enables the AI-based cybersecurity system to cover branch offices and remote workers operating off the network via virtual private networks. In addition, a lightweight version of the first c-sensor 1451 can be employed in an internet of things device that might possess less computing power than a standard laptop computing device. This deployment allows the system to analyze real-time network traffic and metadata to develop an evolving understanding of workforce behavior while providing critical visibility into suspicious connectivity on the endpoint computing devices.

The process module 400 is configured to integrate into and monitor processes operating and resident on the endpoint computing device. The process module 400 can gather a first set of process data to establish a baseline of normal application behavior. In various embodiments, the process module 400 may passively observe memory usage, processing cycles, and background tasks initiated by the user or an automated script. By tracking these internal device metrics, the process module 400 can identify when an application behaves erratically, which might indicate a compromised generative AI tool or a malicious agentic script running locally on the device.

The security module 410 is configured to have an interface designed to cooperate and integrate with an operating system of the endpoint computing device. The security module 410 can establish deep hooks into the operating system to ensure that all outbound and inbound network traffic is visible to the endpoint agent. In some embodiments, the security module 410 may manage local permissions and enforce security policies directly at the operating system level. This deep integration allows the security module 410 to intercept potentially dangerous application calls or unauthorized access attempts before a malicious payload can be executed.

The extract module 420, which may also operate as a parser, is configured to detect and extract interaction information (142) associated with the interactions traversing to and from the endpoint computing device (1401). The extract module 420 can dynamically parse web requests, chat logs, or application programming interface calls directed toward an AI-based agent. In many embodiments, the extract module 420 may isolate specific prompt text, uploaded documents, or received responses from the raw, unstructured network traffic. This targeted extraction ensures that only relevant generative AI interaction data is forwarded for deeper analysis, thereby preserving network bandwidth and reducing centralized processing overhead.

The analyzer module 430 is configured to utilize connection analytic logic to analyze the extracted interaction information locally on the endpoint computing device. The analyzer module 430 can perform preliminary anomaly detection or apply basic rule-based filters before any data is sent across the broader network. In certain embodiments, the analyzer module 430 may evaluate the timing, frequency, and destination of the AI interactions to quickly flag obvious policy violations. By conducting this initial triage, the analyzer module 430 can reduce latency in identifying immediate threats and lessen the analytical burden placed on the centralized cloud resources.

The communication module 440 is configured to send the interaction information securely to a classifier located in a cyber security appliance (100) and/or to a scalable cloud platform. The communication module 440 can establish encrypted tunnels or secure sockets to ensure that the sensitive prompt data remains protected against interception during transit. In various embodiments, the communication module 440 may batch the extracted data and transmit the structured information at scheduled intervals to optimize local network performance. Furthermore, the communication module 440 can receive autonomous responsive action instructions or updated AI usage policies back from the centralized cybersecurity system for local enforcement.

The autonomous response action module 450 is configured to perform autonomous actions that are correlated to initiating blocking or modifying actions on the interaction with the AI agent. The autonomous response action module 450 can execute these actions in response to a classification indicating the monitored interactions are anomalous or represent unauthorized leaks of network policies, personal identifiable information leakage, or data exfiltration. In some embodiments, the autonomous response action module 450 may kill a local rogue process, interrupt an active chat session via a browser extension, or selectively drop network packets. These targeted interventions allow the autonomous response action module 450 to mitigate data exfiltration risks dynamically without completely halting the user's legitimate workflow.

To illustrate the interactions of these components, a narrative example can be considered where an employee uses a local application to query a cloud-based large language model. The process module 400 might first detect the local application spinning up and establishing a new connection footprint on the machine. As the employee types a prompt containing sensitive patient health records, the security module 410 can observe the data crossing the operating system's internal network stack. The extract module 420 is configured to then seamlessly parse the specific text of the prompt from the raw traffic stream without disrupting the application's performance.

Following the extraction phase, the analyzer module 430 can evaluate the parsed prompt data locally. The analyzer module 430 might quickly determine that the destination internet protocol address matches a restricted third-party AI service that violates internal corporate network policies. If local processing is insufficient to fully classify the text, the communication module 440 can securely transmit this parsed text to the centralized cyber security appliance (100) for deep classification against known data exfiltration patterns. The communication module 440 can then pause the outbound transmission and await a definitive risk score and response instruction from the centralized analytics engine.

Upon receiving an alert instruction back via the communication module 440, the autonomous response action module 450 can instantly initiate mitigation procedures. The autonomous response action module 450 is configured to execute a modifying action, such as dynamically replacing the sensitive patient health records in the prompt with generic placeholders before the data leaves the device. Alternatively, if the security policy dictates strict enforcement, the autonomous response action module 450 might instantly terminate the application's connection entirely. These coordinated actions ensure the endpoint computing device remains protected against unauthorized generative AI interactions without requiring manual administrator intervention or constant network connectivity.

Although a specific embodiment for a logical architecture of an endpoint computing device for carrying out the various steps, processes, methods, and operations described herein is discussed with respect to FIG. 4, any of a variety of systems and/or devices may be utilized in accordance with embodiments of the disclosure. For example, the endpoint agent could be implemented entirely as a cloud-delivered proxy service rather than an operating system-integrated module, or the autonomous response action module could be strictly configured to generate an alert for an administrator rather than taking independent mitigative actions. The elements depicted in FIG. 4 may also be interchangeable with other elements of FIGS. 1-3 and FIGS. 5-15 as required to realize a particularly desired embodiment.

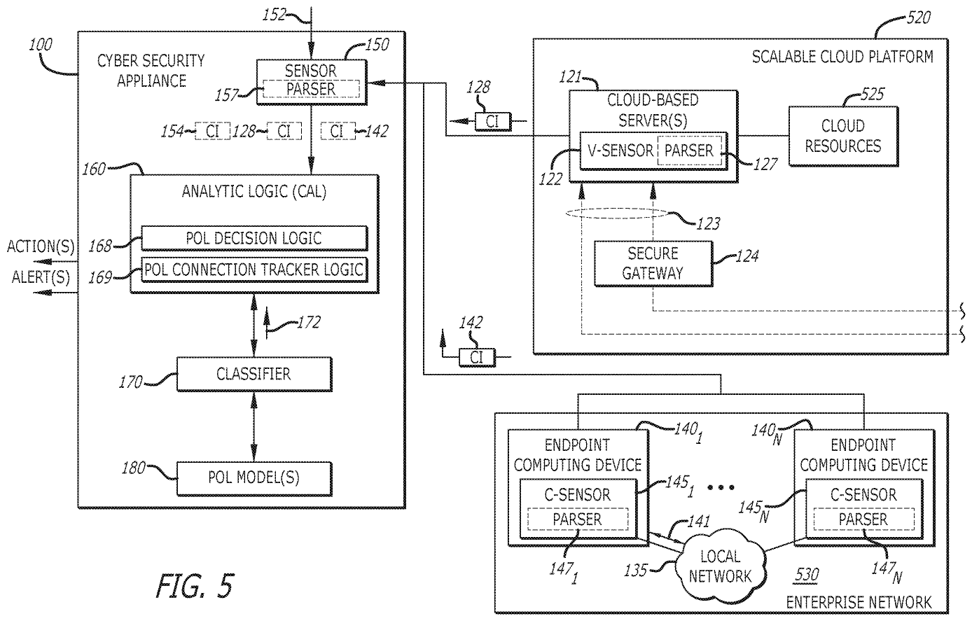

FIG. 5 illustrates a block diagram of an AI-based cybersecurity system that includes a cyber security appliance implemented with a generative AI interaction module to protect against unusual, unauthorized, and/or malicious interactions with an AI based system or AI based agent. In various embodiments, the AI-based cybersecurity system may include primary components such as i) a cyber security appliance 100, ii) a scalable cloud platform 520, and iii) an enterprise network 530. The enterprise network 530 can utilize a local network 135 to communicatively couple a first endpoint computing device 1401 and an Nth endpoint computing device 140N. The cyber security appliance 100 may be hosted within the enterprise network 530 as an on-premises deployment, or the cyber security appliance 100 might be hosted separately and remotely from the enterprise network 530.

The scalable cloud platform 520 is configured to host a portion of the logic and functionality of the AI-based cybersecurity system. The scalable cloud platform 520 may receive tracked information securely and directly from endpoint agents on thousands of endpoint computing devices to monitor interactions at a large scale. A first cloud-based server 121 is configured to operate within the scalable cloud platform 520. The first cloud-based server 121 can host virtualized components and containers, enabling the AI-based cybersecurity system to handle analytics in a decentralized manner across multiple environments.

A v-sensor 122 is configured to operate as a lightweight virtual probe designed for deployment in virtualized environments where physical probes might be impractical. The v-sensor 122 is configured to function as a traffic collection and analysis point as well as a point of egress messages from and ingress messages into the scalable cloud platform 520. A data traffic 123 may flow through the scalable cloud platform 520 during normal operations. The v-sensor 122 is adapted to monitor the data traffic 123 flowing through various cloud ingress and egress points, such as virtual private network tunnels or internal network segments.

A secure gateway 124 is configured to interface with the v-sensor 122 and the scalable cloud platform 520. The logical placement of the v-sensor 122 allows for the observation of north-south traffic passing through the secure gateway 124 to external destinations. Various cloud resources 525 may be hosted within the scalable cloud platform 520 to provide processing power or storage. The v-sensor 122 may be positioned logically between the secure gateway 124 and the cloud resources 525 to observe east-west traffic inside the scalable cloud platform 520.

A cloud parser 127 is configured to process data within the first cloud-based server 121. The cloud parser 127 can assist in formatting and organizing the raw data gathered by the virtual probes for further evaluation by the analytic logic. A first context information 128 may be transmitted from the scalable cloud platform 520 to the cyber security appliance 100. The first context information 128 can provide the cyber security appliance 100 with valuable metadata or contextual details regarding the cloud-based interactions that might aid in anomaly detection.

The enterprise network 530 is configured to represent the protected environment of an organization. The AI-based cybersecurity system may be designed to protect the operability of the enterprise network 530 from anomalous or malicious connections originating internally or externally. A local network 135 is configured to communicatively couple multiple devices within the enterprise network 530. The local network 135 can facilitate internal traffic routing and localized monitoring efforts between connected computing devices.

A first endpoint computing device 1401 and an Nth endpoint computing device 140N may be deployed within the enterprise network 530. The first endpoint computing device 1401 and the Nth endpoint computing device 140N can be utilized by a human user or an AI agent to initiate interactions with generative AI models. These interactions might involve sending prompts to an AI-based agent and receiving corresponding responses from the AI-based agent. In some embodiments, the first endpoint computing device 1401 may be a laptop computing device or an internet of things device operating within a branch office.

A local network traffic 141 may flow between the first endpoint computing device 1401 and the local network 135. The local network traffic 141 can include various prompts, responses, and application programming interface requests traversing the enterprise boundary. A first interaction information 142 is configured to represent the data extracted from interactions by the endpoint computing devices. The first interaction information 142 may be routed to analytic logic located either in the cyber security appliance 100 or the scalable cloud platform 520 for deep inspection.

A second context information 143 may be appended to or transmitted alongside the first interaction information 142. The second context information 143 can enrich the raw interaction data with specific device states or environmental details. A first c-sensor 1451 and an Nth c-sensor 145N are configured to operate as endpoint agents. The first c-sensor 1451 is configured to ingest both traffic data to and from the first endpoint computing device 1401 as well as internal data of processes running on the first endpoint computing device 1401.

A first parser 1471 and an Nth parser 147N may be installed with the endpoint agents on the respective endpoint computing devices. The first parser 1471 is configured to extract information from interactions and route the extracted information to the analytic logic. A sensor parser 150 is configured to receive the incoming data at the cyber security appliance 100. The sensor parser 150 can prepare and structure the data streams arriving from the endpoint computing devices for subsequent modeling and deep analysis.

An external data input 152 may provide additional data feeds into the cyber security appliance 100. The external data input 152 can include threat intelligence feeds, third-party audit logs, or administrative overrides. A third context information 154 may be processed internally by the cyber security appliance 100. The third context information 154 can help correlate various streams of data to build a more comprehensive view of the network activity across the enterprise network 530.

A sensor parser logic 157 may execute within the sensor parser 150 to handle specific formatting tasks. The sensor parser logic 157 can normalize data arriving from diverse sources and different operating systems to ensure compatibility. An analytic logic 160 is configured to receive the routed information and conduct decentralized analytics. The analytic logic 160 may be deployed at the cyber security appliance 100, distributed across cloud servers, or hosted on the endpoint computing devices.

A POL decision logic 168 is configured to receive, model, analyze and maintain state information and data associated with the monitored interactions. The POL decision logic 168 can notify an autonomous response module upon determining an interaction approaches or exceeds an operational limit. A POL connection tracker logic 169 is configured to assist in tracking the active states of various network sessions. The POL connection tracker logic 169 can provide historical continuity for the evaluations performed by the analytic modules.

A classifier 170 is configured to perform AI classifier analysis on multiple categories. The classifier 170 can evaluate interactions for network policy violations, personal identifiable information leakage, and unauthorized data exfiltration. A logic communication pathway 172 is configured to bidirectionally connect the analytic logic 160 to the classifier 170. The logic communication pathway 172 ensures seamless data exchange and rapid querying during the deep analysis of prompts and responses.

One or more POL models 180 are configured to maintain a baseline of normal activities within an organization. The POL models 180 can utilize unsupervised anomaly-based autoencoder ensembles to establish a pattern of life for the specific network being protected. This range of different modeling techniques may be used to identify threats and risks in the organization. By evaluating the reconstruction loss of an interaction, the POL models 180 can accurately output an anomaly score for the POL decision logic 168.

To illustrate how these components might interact in a practical scenario, consider an enterprise environment where a remote employee utilizes the first endpoint computing device 1401 to draft a sensitive financial report. The remote employee might open a chat session with an external generative AI tool hosted within the cloud resources 525 to ask for coding or document navigation assistance. The remote employee could then draft a prompt containing confidential company metrics intended for the AI tool. As the remote employee attempts to send this prompt, the first c-sensor 1451 integrates into the operating system and detects the outgoing interaction.

The first parser 1471 isolates the text of the prompt and extracts the text as the first interaction information 142. Once extracted, the first interaction information 142 is transmitted securely over the local network 135 to the cyber security appliance 100. The sensor parser 150 ingests the data, and the analytic logic 160 begins its evaluation. The analytic logic 160 passes the prompt text over the logic communication pathway 172 to the classifier 170.

The classifier 170, employing an AI classification model, analyzes the text and flags the confidential company metrics as a potential personal identifiable information leakage or unauthorized data exfiltration. Simultaneously, the analytic logic 160 may compare the interaction against the POL models 180. This comparison might discover that sharing financial data with this specific external AI tool results in a high reconstruction loss. Such a high reconstruction loss indicates an anomalous event for this specific user based on historical observations.

With the anomaly confirmed and the sensitive data flagged, the POL decision logic 168 determines that the interaction exceeds the organization's operational limits. The POL decision logic 168 then triggers an autonomous response module. Depending on the configured AI usage policies, the AI-based cybersecurity system may execute an autonomous responsive action to disable the monitored connection through a Transmission Control Protocol reset message, preventing the prompt from ever reaching the cloud resources 525. Alternatively, the autonomous responsive action might dynamically modify the interaction by masking the confidential company metrics with placeholders, allowing the sanitized prompt to proceed to the generative AI tool safely.

Although a specific embodiment for an AI-based cybersecurity system for carrying out the various steps, processes, methods, and operations described herein is discussed with respect to FIG. 5, any of a variety of systems and/or devices may be utilized in accordance with embodiments of the disclosure. For example, the entire analytic logic and pattern of life modeling could be hosted entirely within the scalable cloud platform without relying on an on-premises cyber security appliance, or the c-sensors could be deployed as lightweight browser extensions rather than full operating system integrated modules. The elements depicted in FIG. 5 may also be interchangeable with other elements of FIGS. 1-4 and FIGS. 6-15 as required to realize a particularly desired embodiment.

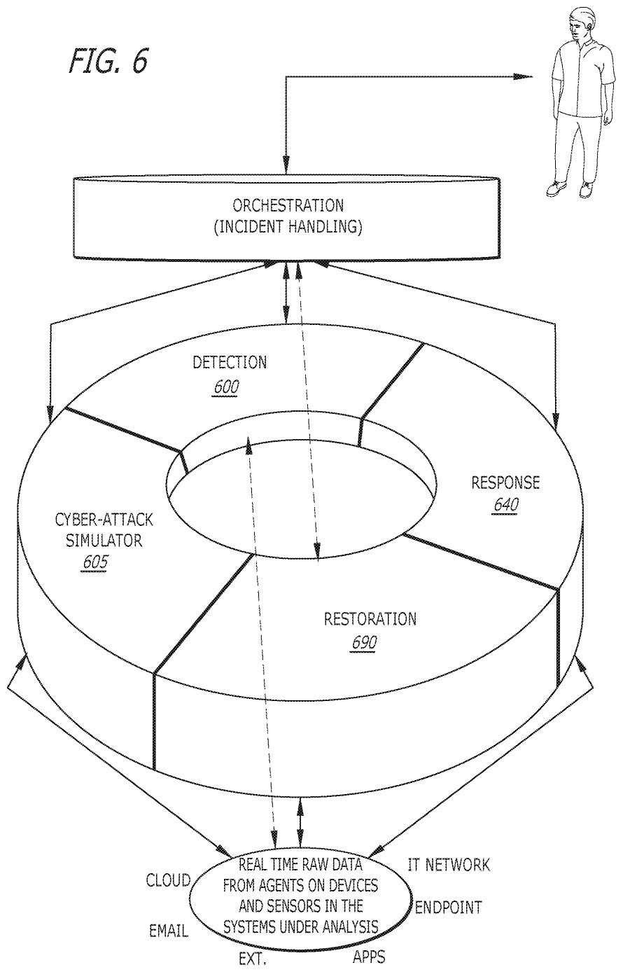

FIG. 6 illustrates a diagram of an embodiment of a cooperative cybersecurity architecture. The architecture may include primary components such as i) a detection engine 600, ii) an autonomous response engine 640, iii) a restoration engine 690, and iv) a cyber-attack simulator 605. The detection engine 600 is configured to use artificial intelligence algorithms trained to perform a first machine-learned task of detecting a cyber threat, such as an anomalous interaction with a generative AI tool. The autonomous response engine 640 is configured to use artificial intelligence algorithms trained to perform a second machine-learned task of taking one or more mitigation actions to mitigate the cyber threat, such as masking personal identifiable information in a prompt. The restoration engine 690 is configured to use artificial intelligence algorithms trained to perform a third machine-learned task of remediating the system being protected back to a trusted operational state.

The cyber-attack simulator 605 is configured to use artificial intelligence algorithms trained to perform a fourth machine-learned task of artificial intelligence-based simulations of cyberattacks to assist in determining how a simulated cyberattack might occur in the system being protected. In addition, an intelligent orchestration component can use artificial intelligence algorithms trained to perform a fifth machine-learned task of adaptive interactive response between the multiple artificial intelligence-based engines. This orchestration provides information each artificial intelligence engine needs to work cohesively to provide an overall incidence response that mitigates different types of cyber threats, such as agentic data exfiltration, while still minimizing an impact tailored to this particular system being protected. For example, when a conversation occurs between the AI-based engines such as a system that can be positively affected by both proposed mitigation actions and proposed restoration actions, any of which might be attempted but fail or only partially succeed, then the intelligent orchestration component can arbitrate and evolve the best result for this particular system being protected. The intelligent orchestration component can help anticipate the needs of and cohesive response of each artificial intelligence-based engine based on a current detected cyber threat involving large language models.

Referring to FIG. 6, the restoration engine 690 is configured to take one or more remediation actions with artificial intelligence assistance to remediate the one or more nodes in the graph of the system affected by the cyberattack back to a trusted operational state in a recovery from the cyber threat. These actions might be fully automatic or may require a specific human confirmation decision before they begin. The restoration engine 690 can cooperate with the other AI-based engines of the cyber security system, via the interfaces and/or direct integrations, to track and understand the cyber threat identified by the other components. Furthermore, the restoration engine 690 is configured to track the one or more mitigation actions taken to mitigate the cyber threat during the cyberattack by the other components in order to assist in intelligently restoring the protected system while still mitigating the cyber threat attack back to a trusted operational state. Thus, as a situation develops with an ongoing cyberattack involving malicious prompt injections, the restoration engine 690 is configured to take one or more remediation actions to remediate at least one of the nodes in the graph of the network back to a trusted operational state while the cyberattack is still ongoing.

The multiple artificial intelligence-based engines have communication hooks in between them to exchange a significant amount of behavioral metrics including data between the multiple artificial intelligence-based engines to work together to provide an overall cyber threat response. The detection engine 600 can share anomaly scores generated by an unsupervised anomaly-based autoencoder ensemble with the other engines to indicate the severity of an unusual prompt. The autonomous response engine 640 can communicate which TCP reset messages or prompt masking actions have been applied so that the other engines are aware of the current containment status. The cyber-attack simulator 605 can broadcast the results of simulated lateral movements by a compromised AI agent to prepare the rest of the system for potential escalations.

The intelligent orchestration component can be configured as a discreet intelligent orchestration component that exists on top of the multiple artificial intelligence-based engines to orchestrate the overall cyber threat response and an interaction between the multiple artificial intelligence-based engines, each configured to perform its own machine-learned task. Alternatively, the intelligent orchestration component can be configured as a distributed collaboration with a portion of the intelligent orchestration component implemented in each of the multiple artificial intelligence-based engines to orchestrate the overall cyber threat response and an interaction between the multiple artificial intelligence-based engines. In an embodiment, whether implemented as a distributed portion on each AI engine or a discrete AI engine itself, the intelligent orchestration component can use self-learning algorithms to learn how to best assist the orchestration of the interaction between itself and the other AI engines. These other AI engines might also implement self-learning algorithms themselves to perform their individual machine-learned tasks better, such as refining the named entity recognition model used to detect sensitive data within generative AI interactions.

The multiple artificial intelligence-based engines can be configured to cooperate to combine an understanding of normal operations of the nodes, an understanding of emerging cyber threats, an ability to contain those emerging cyber threats, and a restoration of the nodes of the system to heal the system. This cooperation might utilize an adaptive feedback between the multiple artificial intelligence-based engines in light of simulations of the cyberattack. Such simulations might be utilized to predict what might occur in the nodes in the system based on the progression of the attack so far, such as predicting which internal databases a compromised AI agent might target next. The system can then analyze the mitigation actions taken to contain those emerging cyber threats and remediation actions taken to heal the nodes using the simulated cyberattack information.

The multiple artificial intelligence-based engines each have an interface to communicate with the other separate artificial intelligence-based engines configured to understand a type of information and communication that the other separate artificial intelligence-based engine needs to make determinations on an ongoing cyberattack from that other artificial intelligence-based engine's perspective. Each artificial intelligence-based engine might have an instant messaging system to communicate with a human cyber-security team to keep the human cyber-security team informed on actions autonomously taken. This messaging system could also be utilized to present actions needing human approval as well as generate reports for the human cyber-security team regarding unusual generative AI tool usage. This ensures that the human administrators maintain ultimate visibility and control over how the network handles sophisticated AI-based threats.

Each of these artificial intelligence-based engines has bi-directional communications, including the exchange of raw data, with each other as well as with software agents resident in physical and/or virtual devices making up the system being protected. This includes bi-directional communications with c-sensors within the endpoint computing devices being protected. The system under protection can be, for example, an IT network, an OT network, a scalable cloud platform, an email network, a source code database, an endpoint device, or a generative AI interaction module. Real-time raw data from agents on devices and sensors in the systems under analysis can be continuously ingested to feed the analytic logic and classifier modules.

In a narrative example of this system operating, the autonomous response engine 640 uses its intelligence to cooperate with the cyber-attack simulator 605 and its artificial intelligence-based simulations to choose and initiate an initial set of one or more mitigation actions. These actions might be indicated as a preferred targeted initial response to a detected cyber threat involving an unauthorized data exfiltration attempt via an LLM. The autonomous response engine 640, rather than the human taking the action, is configured to autonomously cause the one or more mitigation actions to be taken to contain the cyber threat when a threat risk parameter from an assessment module in the detection engine 600 is equal to or above an actionable threshold. Example mitigation actions can include the autonomous response engine 640 monitoring and sending signals to a potentially compromised node to restrict communications of the potentially compromised node to merely normal recipients and types of communications according to the artificial intelligence model trained to model the normal pattern of life for each node in the protected system. Another example mitigation action might involve the autonomous response engine 640 being trained on how to isolate a compromised node as well as to take mitigation acts with other nodes that have a direct nexus to the compromised node, such as blocking the node from accessing the company's enterprise chatbot.

In another narrative example of the system operating during a complex event, the cyber-attack simulator 605 and its artificial intelligence-based simulations use intelligence to cooperate with the restoration engine 690 to assist in choosing one or more remediation actions to perform on nodes affected by the cyberattack. The goal may be to bring the nodes back to a trusted operational state while still mitigating the cyber threat during an ongoing cyberattack involving an agentic AI script that has gone rogue. This cooperation might be based on effects determined through the simulation of possible remediation actions to perform and their effects on the nodes making up the system being protected. This allows the system to preempt possible escalations of the cyberattack while restoring one or more nodes back to a trusted operational state without accidentally crashing the entire network segment.

In yet another narrative example, the restoration engine 690 restores the one or more nodes in the protected system by cooperating with at least two or more other intelligent components. First, the restoration engine 690 might cooperate with an artificial intelligence model trained to model a normal pattern of life for each node in the protected system, using an autoencoder ensemble to understand baseline prompt behaviors. Second, the restoration engine 690 might cooperate with an artificial intelligence model trained on what are a possible set of cyber threats and their characteristics and symptoms to identify the cyber threat that is causing a particular node to behave abnormally and fall outside of that node's normal pattern of life. Third, the restoration engine 690 might cooperate with the autonomous response engine 640 to ensure that the restoration process does not conflict with active network blocks or PII masking rules currently being enforced against the generative AI tool interactions.

Although a specific embodiment for a cooperative cybersecurity architecture for carrying out the various steps, processes, methods, and operations described herein is discussed with respect to FIG. 6, any of a variety of systems and/or devices may be utilized in accordance with embodiments of the disclosure. For example, the intelligent orchestration component could be implemented as a distributed set of edge-computing nodes across the enterprise network rather than a discrete central engine, or the detection engine could rely on supervised machine learning models in addition to the unsupervised anomaly-based autoencoder ensembles. The elements depicted in FIG. 6 may also be interchangeable with other elements of FIGS. 1-5 and FIGS. 7-15 as required to realize a particularly desired embodiment.

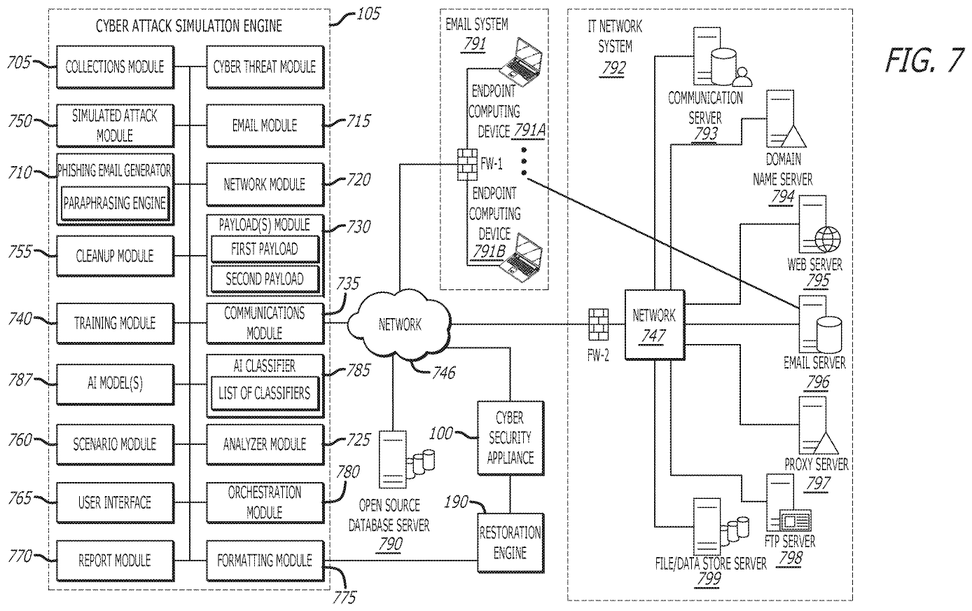

Referring to FIG. 7, the cyber attack simulation engine 105 using artificial intelligence-based simulations is communicatively coupled to a cyber security appliance 100, an open source database server 790, an email system 791, one or more endpoint computing devices 791A-791B, and an IT network system 792 with one or more entities, over one or more networks 746/747 in the system being protected.

The collections module 705 is configured to gather intelligence, target data, and environmental variables prior to launching a simulated attack. The collections module 705 can scrape public internet repositories or query internal directories to build realistic profiles of the simulated victims. In certain embodiments, the collections module 705 might ingest previous legitimate prompts submitted by users to map out the typical linguistic style of the organization. This collected intelligence allows the simulation engine to craft highly targeted and convincing simulated attacks that blend seamlessly into the organization's normal pattern of life.

The cyber threat module is configured to manage the specific attack vectors and threat profiles utilized during a simulation. This module can store a repository of known tactics, techniques, and procedures associated with prominent cybercriminal groups or rogue artificial intelligence agents. In various embodiments, the cyber threat module may dictate whether a particular simulation should mimic a noisy brute-force network intrusion or a stealthy, multi-day prompt manipulation campaign. By managing these diverse profiles, the cyber threat module ensures that the testing environment accurately reflects the real-world risks threatening the enterprise.

The simulated attack module 750 is configured to execute the active phases of the testing scenario. The simulated attack module 750 can deploy the crafted payloads, initiate the unauthorized network connections, and trigger the anomalous large language model application programming interface calls. In some embodiments, the simulated attack module 750 might coordinate a distributed attack across multiple simulated endpoints to test the correlation capabilities of the cyber security appliance 100. The simulated attack module 750 carefully paces the intrusion to measure how quickly the defensive systems detect the initial indicators of compromise.

The phishing email generator 710 is configured to dynamically create deceptive email communications designed to trick human users or automated email processing agents. The phishing email generator 710 can utilize an integrated paraphrasing engine to subtly alter the wording, tone, and structure of the email across thousands of iterations to bypass static email filters. In certain embodiments, the phishing email generator 710 might craft messages that contain hidden prompt injection payloads intended to compromise an internal artificial intelligence assistant that automatically reads and summarizes employee emails. This enables the simulation engine to test the vulnerability of the organization's automated artificial intelligence workflows to maliciously crafted incoming data.

The email module 715 is configured to interface specifically with the targeted email infrastructure during a simulation. The email module 715 can manage the transmission protocols, sender spoofing techniques, and delivery timing of the simulated phishing campaigns. In various embodiments, the email module 715 may monitor delivery receipts and track whether a simulated victim opened an attachment or clicked a malicious link. The email module 715 ensures that the delivery mechanisms of the simulated attacks accurately mirror the complex routing behaviors of modern malicious email servers.

The network module 720 is configured to handle the direct network-level interactions and traffic generation for the simulated attacks. The network module 720 can establish covert command and control channels, simulate unauthorized data transfers, and generate anomalous transmission control protocol streams. In some embodiments, the network module 720 might simulate an internal artificial intelligence agent attempting to establish an unauthorized external connection to an unapproved cloud resource. The network module 720 provides the foundational network traffic required to test the deep packet inspection capabilities of the defensive sensors.

The payload(s) module 730 is configured to store, manage, and select the specific simulated malicious packages delivered during the attack. The payload(s) module 730 can maintain a diverse library of benign but trackable files, scripts, and text strings designed to trigger security alerts without causing actual harm to the host systems. In certain embodiments, the payload(s) module 730 might utilize a first payload to probe the system's initial defenses and a second payload to simulate a deeper, secondary exfiltration attempt. This staging capability allows the simulation engine to test the defensive architecture's ability to track a multi-staged cyberattack across different kill chain phases.

The cleanup module 755 is configured to automatically remove the simulated artifacts and revert any harmless configuration changes made during the testing process. The cleanup module 755 can delete simulated malicious files, close established testing ports, and clear temporary registry keys generated by the simulated attack module. In various embodiments, the cleanup module 755 might send a secure signal to the cyber security appliance 100 to disregard the simulated alerts from its long-term pattern of life machine learning training data. The cleanup module 755 ensures that the enterprise network is returned to its pristine state following a simulation, preventing testing artifacts from polluting actual security analytics.

The communications module 735 is configured to manage the internal data routing and signaling between the various sub-components of the cyber attack simulation engine 105. The communications module 735 can ensure that the payload module, the network module, and the reporting modules remain perfectly synchronized during a complex, multi-stage attack simulation. In some embodiments, the communications module 735 might securely encrypt the control signals passing between the simulation engine and its deployed testing agents to prevent the defensive network from easily identifying the simulation traffic. The communications module 735 acts as the nervous system of the simulation platform, maintaining the operational integrity of the testing environment.

The training module 740 is configured to update and refine the artificial intelligence algorithms utilized by the simulation engine itself. The training module 740 can ingest the results of previous simulations, analyzing which attack vectors successfully bypassed the cyber security appliance 100 and which were caught immediately. In certain embodiments, the training module 740 might utilize reinforcement learning to teach the simulated attack module how to dynamically adjust its prompt injection phrasing to lower the reconstruction loss score generated by the defensive autoencoders. The training module 740 ensures that the simulated adversary continuously evolves, forcing the defensive systems to adapt and improve.

The AI classifier 785 is configured to analyze the target environment and dynamically categorize the simulated vulnerabilities. The AI classifier 785 can maintain a list of classifiers to determine the best possible attack route based on the specific operating systems and artificial intelligence tools deployed by the target. In various embodiments, the AI classifier 785 might evaluate an intercepted response from an enterprise large language model and classify the model's safety filter stringency before launching a secondary payload. The AI classifier 785 provides the simulation engine with the cognitive capability to understand its target and pivot its strategy mid-attack.

The AI model(s) 787 are configured to provide the core mathematical and predictive capabilities for the cyber attack simulation engine 105. The AI model(s) 787 can generate novel, synthetically derived prompt injection phrases that have never been seen in the wild, ensuring the defensive systems are tested against zero-day threats. In some embodiments, the AI model(s) 787 might utilize large language models to rapidly draft highly convincing, contextually accurate spear-phishing emails tailored to specific corporate executives. The AI model(s) 787 empower the simulation engine to transcend simple script-based testing and execute highly intelligent, adaptive adversary emulations.

The analyzer module 725 is configured to evaluate the success or failure of the deployed simulation tactics in real-time. The analyzer module 725 can track whether a simulated payload successfully navigated past the network firewalls and reached the targeted endpoint computing device. In certain embodiments, the analyzer module 725 might monitor the responses from the defensive autonomous response module to determine exactly which specific network action triggered the block. The analyzer module 725 provides the immediate feedback loop required for the simulation engine to understand the defensive posture of the enterprise network.

The scenario module 760 is configured to design and orchestrate the overarching narrative and rules of engagement for a specific testing exercise. The scenario module 760 can define the scope of the attack, such as restricting the simulated actions to only target a specific branch office's generative artificial intelligence tool. In various embodiments, the scenario module 760 might load a pre-configured tabletop exercise simulating an insider threat attempting to leak proprietary source code via an external chatbot. The scenario module 760 allows human administrators to tightly control the parameters of the test to ensure it meets specific regulatory or compliance validation requirements.

The orchestration module 780 is configured to sequence the various actions of the simulation across the different domains and modules. The orchestration module 780 can ensure that a simulated phishing email is delivered exactly five minutes before a simulated anomalous large language model interaction occurs, creating a realistic chain of events. In some embodiments, the orchestration module 780 might pause a simulation if it detects that the enterprise network is experiencing genuine, unrelated operational distress to prevent compounding the issue. The orchestration module 780 acts as the ultimate director of the simulated attack, maintaining the timeline and execution flow of the exercise.

The user interface 765 is configured to provide a graphical control panel for human red team operators and security administrators. The user interface 765 can display the real-time progress of a simulated attack, showing a visual map of the compromised nodes and the active data exfiltration channels. In certain embodiments, the user interface 765 might allow an operator to manually override an autonomous simulation, steering a simulated prompt injection attack toward a newly discovered internal database. The user interface 765 bridges the gap between the complex artificial intelligence simulation algorithms and the human operators guiding the security assessment.

The formatting module 775 is configured to structure the outputs, logs, and telemetry generated by the simulation engine into standardized data formats. The formatting module 775 can translate proprietary simulation metrics into common security logging formats that can be easily ingested by external auditing tools. In various embodiments, the formatting module 775 might package a simulated malicious payload so that it perfectly mimics the file structure and header formatting of a known threat actor's malware. The formatting module 775 ensures that the data generated by the engine is highly realistic and universally readable.

The report module 770 is configured to aggregate the results of the completed simulations into comprehensive, human-readable documents. The report module 770 can detail the exact timeline of the attack, which defensive systems successfully detected the anomalies, and where the security gaps remain. In some embodiments, the report module 770 might generate an executive summary highlighting the vulnerability of the organization's generative artificial intelligence integrations to data exfiltration. The report module 770 provides the critical post-action intelligence required for the enterprise to adjust its security policies and patch its defensive systems.

The email system 791 is configured to represent the internal communication infrastructure targeted by the simulated attacks. The email system 791 can encompass the internal servers, routing rules, and filtering appliances that process messages for the organization's employees. In certain embodiments, the email system 791 might be integrated with an automated artificial intelligence assistant designed to read and sort incoming messages. The email system 791 serves as the primary battleground for testing the organization's resilience against socially engineered phishing and payload delivery campaigns.

The endpoint computing device 791A is configured to act as a primary simulated victim or target within the email system. The endpoint computing device 791A can represent an employee's laptop or workstation receiving a simulated malicious email. In various embodiments, the endpoint computing device 791A might be monitored by an internal c-sensor that tracks the user's interaction with the simulated phishing link or prompt injection payload. The endpoint computing device 791A provides the necessary internal footing for the simulation engine to test the lateral movement and local execution defenses of the organization.

The first firewall FW-1 is configured to protect the boundary of the internal email system and its associated endpoints. The first firewall FW-1 can enforce access control lists and basic packet filtering rules against incoming traffic. In some embodiments, the first firewall FW-1 might be integrated with the cyber security appliance 100 to receive dynamic block instructions when an anomalous connection is detected. The first firewall FW-1 acts as the first line of defense that the cyber attack simulation engine 105 must attempt to bypass or evade.

The endpoint computing device 791B is configured to represent a secondary target or a laterally compromised machine within the environment. The endpoint computing device 791B can be utilized to test how a simulated threat spreads from an initially compromised host to other vulnerable systems. In certain embodiments, the simulation engine might cause the first endpoint computing device 791A to attempt to remotely execute an unauthorized artificial intelligence script on the endpoint computing device 791B. The endpoint computing device 791B helps validate the internal network segmentation and east-west traffic monitoring capabilities of the defensive architecture.

The IT network system 792 is configured to represent the broader, general-purpose corporate network infrastructure of the enterprise. The IT network system 792 can house the critical databases, web servers, and domain controllers required to run the business operations. In various embodiments, the IT network system 792 might contain internal, proprietary large language models hosted locally for secure employee usage. The IT network system 792 is the ultimate target environment where the cyber attack simulation engine 105 attempts to exfiltrate sensitive data or compromise core operational functions.

The communication server 793 is configured to manage the real-time messaging, voice, or video traffic within the IT network system. The communication server 793 can route internal chat logs and collaborative workspace data. In some embodiments, the communication server 793 might host a corporate chatbot powered by generative artificial intelligence. The communication server 793 can be targeted by the simulation engine to test whether an attacker can inject malicious prompts directly into the company's internal messaging infrastructure.

The domain name server 794 is configured to resolve human-readable web addresses into machine-routable internet protocol addresses. The domain name server 794 can handle all internal and external directory routing for the enterprise. In certain embodiments, the cyber attack simulation engine 105 might test the domain name server 794 by attempting to utilize DNS tunneling to slowly exfiltrate artificial intelligence training data out of the network. The domain name server 794 provides a critical infrastructure vector for testing covert communication channels and anomalous routing behaviors.

The web server 795 is configured to host internal intranet portals or public-facing enterprise applications. The web server 795 can provide the user interfaces for employees to access internal databases or cloud services. In various embodiments, the web server 795 might host a web-based portal where employees submit prompts to an enterprise-licensed large language model. The web server 795 can be targeted by the simulation engine to test for vulnerabilities such as cross-site scripting or unauthenticated application programming interface access to the generative artificial intelligence tools.

The email server 796 is configured to handle the core storage, routing, and processing of messages for the IT network system. The email server 796 can synchronize with the broader email system 791 to deliver internal and external communications. In some embodiments, the email server 796 might be targeted by the cyber attack simulation engine 105 to simulate a mass data exfiltration event involving years of archived corporate communications. The email server 796 represents a highly valuable data repository that the defensive systems must closely monitor for unusual access patterns.

The network 747 is configured to serve as the internal routing backbone connecting the various servers within the IT network system. The network 747 can comprise the physical switches, routers, and internal cabling facilitating the east-west data flow. In certain embodiments, the network 747 might be monitored by internal network taps feeding raw packet data to the cyber security appliance 100 for continuous anomaly detection. The network 747 provides the transmission medium that the simulated threats must traverse to access the critical server infrastructure.

The proxy server 797 is configured to act as an intermediary for requests from clients seeking resources from other servers, often external to the network. The proxy server 797 can provide caching, anonymity, or content filtering for outgoing web traffic. In various embodiments, the proxy server 797 might intercept all outgoing interactions directed to external generative artificial intelligence tools to ensure they pass through the local security scanners first. The proxy server 797 can be targeted during a simulation to test whether an attacker can bypass the proxy to establish a direct, unmonitored connection to a malicious command and control server.

The FTP server 798 is configured to facilitate the bulk transfer of files across the network using the file transfer protocol. The FTP server 798 can hold large datasets, software patches, or backup images. In some embodiments, the FTP server 798 might store the vast corpora of raw text data utilized to fine-tune the organization's internal artificial intelligence models. The FTP server 798 can be targeted by the cyber attack simulation engine 105 to simulate a high-volume data theft event, triggering the anomaly detection models based on the unusual data transfer size.

The file/data store server 799 is configured to house the highly sensitive, structured or unstructured proprietary data of the organization. The file/data store server 799 can contain financial records, intellectual property, or personal identifiable information of customers. In certain embodiments, the file/data store server 799 might be queried by an internal artificial intelligence agent attempting to compile a summary report. The file/data store server 799 is the ultimate prize for a simulated attacker, testing whether the cyber security appliance 100 can distinguish between a legitimate AI-driven data query and a malicious exfiltration attempt.

The second firewall FW-2 is configured to protect the boundary of the IT network system 792 and its internal servers. The second firewall FW-2 can segment the highly sensitive server farm from the general user endpoint network. In various embodiments, the second firewall FW-2 might be dynamically updated by the autonomous response engine to drop traffic from a simulated compromised node attempting to move laterally into the IT network system 792. The second firewall FW-2 provides a critical internal choke point for testing the automated containment capabilities of the security architecture.

The external network 746 is configured to represent the public internet or external cloud infrastructure connecting the various remote components. The external network 746 can route traffic between the enterprise environment, the external cyber attack simulation engine 105, and third-party services. In some embodiments, the external network 746 might carry the encrypted prompt data traveling to an external large language model. The external network 746 provides the realistic external transport layer necessary for simulating attacks that originate from outside the protected enterprise boundary.

In one embodiment, the cyber security appliance 100 is configured to serve as the primary defensive brain of the operation, monitoring the simulated attacks and taking autonomous actions. The cyber security appliance 100 can process the telemetry from the various network domains, calculating reconstruction loss scores and flagging anomalous interactions. In certain embodiments, the cyber security appliance 100 might receive a signal from the simulation engine to run in a “shadow mode,” logging its intended autonomous responses to the simulated attack without actually disrupting the ongoing exercise. The cyber security appliance 100 is the core system being tested, validating its ability to protect the generative artificial intelligence workflows against sophisticated threats.

The open source database server 790 is configured to host public or shared threat intelligence and vulnerability data. The open source database server 790 can provide the cyber attack simulation engine 105 with up-to-date information on the latest zero-day exploits or known prompt injection vulnerabilities. In various embodiments, the open source database server 790 might be queried by the defensive cyber security appliance 100 to enrich its own classification models with the latest threat signatures. The open source database server 790 ensures that both the simulated attacker and the defensive systems have access to the current global threat landscape.

The restoration engine 190 is configured to coordinate the post-incident recovery efforts after the simulated or actual attack is contained. The restoration engine 190 can roll back unauthorized configuration changes, restore deleted files from backups, and force a credential reset for compromised users. In some embodiments, the restoration engine 190 might automatically revert a compromised internal artificial intelligence model to a previously known safe checkpoint before it was subjected to data poisoning during the simulation. The restoration engine 190 closes the incident response loop, testing the organization's ability to seamlessly recover operations after a generative artificial intelligence security breach.

To illustrate how these components might interact in a practical scenario, consider a narrative example where the cyber attack simulation engine 105 is tasked with testing the enterprise's resilience against an AI-generated spear-phishing campaign combined with a prompt injection payload. The collections module 705 might first scrape public data to profile a target on the endpoint computing device 791A. The phishing email generator 710 can then utilize the AI model(s) 787 to draft a highly personalized email containing a hidden malicious payload designed to interact with the user's local artificial intelligence assistant. The simulated attack module 750 dispatches the email via the network 746, attempting to bypass the first firewall FW-1. If the user on the endpoint computing device 791A engages with the email, the hidden prompt injection payload attempts to force the local AI assistant to query the highly secure file/data store server 799 and exfiltrate the results. The cyber security appliance 100 must detect this anomalous data retrieval behavior, utilizing its autoencoder ensembles to flag the action as out-of-distribution, and instantly trigger a block at the second firewall FW-2 before the sensitive data leaves the internal network.

In one embodiment, the cyber attack simulation engine 105 with artificial intelligence-based can conduct simulations in the cyber attack simulation engine 105 by constructing a graph of nodes of the system being protected. This graph of nodes can include the physical devices connecting to the network, any virtualized instances of the network, user accounts in the network, and generative artificial intelligence tools integrated into the network, as well as connections and pathways through the network to create a virtualized instance of the network to be tested.

The cyber attack simulation engine 105 with artificial intelligence-based simulations is configured to integrate with the cyber security appliance 100 and cooperate with components within the cyber security appliance 100 protecting the network from cyber threats. This cooperation involves making use of outputs, data collected, and functionality from two or more of a data store, other modules, and one or more AI models already existing in the cyber security appliance 100.

The cyber attack simulation engine 105 may include a cyber threat module to generate many different types of cyber threats with past historical attack patterns to attack the simulated system. These simulated attacks can be generated by the simulated attack module 750 that will digitally and virtually replicate the system being protected, such as a phishing email generator 710 configured to generate one or more automated phishing emails containing prompt injection payloads to pentest the generative AI defenses and the network defenses provided by the cyber security appliance 100. For example, the system being protected can be an email system integrated with an automated AI assistant, and then the phishing email generator 710 may be configured to cooperate with trained AI models to customize the automated phishing emails based on identified data points of the organization and its entities to trick the assistant into exfiltrating data.

The email module 715 and network module 720 may use a vulnerability tracking module to track and profile, for example, versions of software, the configuration of internal LLMs, and a state of patches and updates compared to a latest patch and update of the software resident on devices in the system. The vulnerability tracking module can supply results of the comparison of the version of software as an actual detected vulnerability for each particular node in the system being protected, which is utilized by a node exposure score generator and the cyber attack simulation engine 105 in calculating the spread of a cyber threat and a prioritization of remediation actions on a particular node compared to the other network nodes with actual detected vulnerabilities. The node exposure score generator is configured to also factor in whether the particular node is exposed to direct contact by an entity generating the cyber threat, such as a public-facing corporate chatbot, or the particular node is downstream of a node exposed to direct contact by the entity generating the cyber threat external to the network.

The node exposure score generator and the simulated attack module 750 in the cyber attack simulation engine 105 cooperate to run the one or more hypothetical simulations of an actual detected cyber threat incident and a hypothetical cyberattack incident to calculate the node paths of least resistance in the virtualized instance of the system being protected. The progress through the node paths of least resistance through the system being protected are plotted through the various simulated instances of components of the graph of the system being protected until reaching a suspected end goal of the cyber-attack scenario, all based on historic knowledge of connectivity and behavior patterns of users and generative AI agents within the system under analysis. The simulated attack module 750, via a simulator and a virtual network clone creator, can be programmed to model and work out the key paths and devices in the system via initially mapping out the system being protected and querying the cyber security appliance 100 on specifics known about the system being protected. The simulated attack module 750 is configured to search and query two or more of a data store, modules in the detection engine, and the one or more artificial intelligence models making up the cyber security appliance 100 protecting the actual network under analysis from cyber threats, on what the cyber security appliance 100 already knows about the nodes of the system to create the graph of nodes.

Thus, the cyber attack simulation engine 105 is configured to construct the graph of the virtualized version of the system from knowledge known and stored by modules, a data store, and one or more AI models of a cyber security appliance 100 protecting an actual network under analysis. The knowledge known and stored is obtained at least from ingested traffic from the actual system under analysis. Thus, the virtualized system and its node components connecting to the network being tested during the simulation are up to date and accurate because the cyber attack simulation engine 105 is configured to obtain actual network data collected by two or more of modules, a data store, and one or more AI models of a cyber security appliance 100 protecting the actual network. The simulated attack module 750 will make a model incorporating the actual data of the system through the simulated versions of the nodes making up that system for running simulations on the simulator. Again, a similar approach is taken when the simulated attack module 750 uses a clone creator to spin up and create a virtual clone of the system being protected with virtual machines in the cloud.

The cyber attack simulation engine 105 with artificial intelligence-based simulations is configured to simulate the compromise of a spread of the cyber threat being simulated in the simulated cyber-attack scenario, based on historical and similar cyber threat attack patterns. This simulation maps the spread between the devices connected to the virtualized network, via a calculation on an ease of transmission of the cyber threat algorithm, from an originally compromised node by the cyber threat, through to other virtualized instances of components of the virtualized network, until reaching a suspected end goal of the cyber-attack scenario, including key network databases like the file/data store server 799. The cyber attack simulation engine 105 also calculates how likely it would be for the cyber-attack to spread to achieve either a programmable end goal of that cyber-attack scenario set by a user, or set by default an end goal scripted into the selected cyber-attack scenario, such as successfully exfiltrating training data via an AI agent.

The email module 715 and the network module 720 can include a profile manager module. The profile manager module is configured to maintain a profile tag on all of the devices connecting to the actual system under analysis based on their behavior and security characteristics and then supply the profile tag for the devices connecting to the virtualized instance of the system when the construction of the graph occurs. The profile manager module is configured to maintain a profile tag for each device before the simulation is carried out; and thus, eliminates a need to search and query for known data about each device being simulated during the simulation. This also assists in running multiple simulations of the cyberattack involving multiple generative AI interactions in parallel.

The cyber attack simulation engine 105 is configured to construct the graph of the virtualized system where two or more of the devices connecting to the virtualized network are assigned with different weighting resistances to malicious compromise from the cyber-attack being simulated based on the actual cyber-attack on the virtualized instance of the network and their node vulnerability score. In addition to a weighting resistance to the cyberattack, the calculations in the model for the simulated attack module 750 factor in the knowledge of a layout and connection pattern of each particular network device in a network, an amount of connections to other network devices in the network, how important a particular device is determined by the function of that network device, the users or AI agents associated with that network device, and the location of the device within the network. Note, multiple simulations can be conducted in parallel by the orchestration module 780. The simulations can occur on a periodic regular basis to pentest the cyber security of the system against prompt injections and in response to a detected ongoing cyberattack in order to get ahead of the ongoing cyberattack and predict its likely future moves. Again, the graph of the virtualize instance of the system is created with two or more of known characteristics of the network itself, pathway connections between devices on that network, security features and credentials of devices and their associated users or internal LLMs, and behavioral characteristics of the devices and their associated users connecting to that network, which all of this information is obtained from what was already know about the network from the cyber security appliance 100.

During an ongoing cyberattack, the simulated attack module 750 is configured to run the one or more hypothetical simulations of the detected cyber threat incident and feed details of a detected incident by a cyber threat module in the detection engine into the collections module 705 of the cyber attack simulation engine 105. The simulated attack module 750 is configured to run one or more hypothetical simulations of that detected incident in order to predict and assist in the triggering an autonomous response by the autonomous response engine and then restoration by the restoration engine 190 to the detected incident.

The simulated attack module 750 ingests the information for the purposes of modeling and simulating potential cyberattacks against the network and routes that an attacker would take through the network. The simulated attack module 750 can construct the graph of nodes with information to understand an importance of network nodes in the network compared to other network nodes in the network, and to determine key pathways within the network and vulnerable network nodes in the network that a cyber-attack would use during the cyber-attack, via modeling the cyber-attack on at least one of a simulated device version and a virtual device version of the system being protected under analysis. Correspondingly, the calculated likelihood of the compromise and timeframes for the spread of the cyberattack via a compromised internal LLM is tailored and accurate to each actual device being simulated in the system because the cyber-attack scenario is based upon security credentials and behavior characteristics from actual traffic data fed to the modules, data store, and AI models of the cyber security appliance 100.

The cyber attack simulation engine 105 with its artificial intelligence trained on how to conduct and perform cyberattacks in a simulation in either a simulator or in a clone creator spinning up virtual instances on virtual machines will take a sequence of actions and then evaluate the actual impact after each action in the sequence, in order to yield a best possible result to contain the detected threat while minimizing the impact on other network devices and users that are currently active and not in breach, from different possible actions to take. Again, multiple simulations can be run in parallel so that the different sequences of mitigation actions and restoration actions can be evaluated essentially simultaneously. The cyber attack simulation engine 105 is configured to use one or more mathematical functions to generate a score and likelihood for each of the possible actions and sequence of multiple possible actions that can be taken in order to determine which set of actions to choose among many possible actions to initiate. The one or more possible actions to take and their calculated scores can be stacked against each other to factor a likelihood of containing the detected threat acting abnormal with each possible set of actions, a severity level of the detected threat to the network, and the impact of taking each possible set of actions on users and on devices currently active in the network not acting abnormal to the normal behavior of the network, and then communicate with the cyber threat detection engine, the autonomous response engine, and the restoration engine 190, respectively, to initiate the chosen set of actions to cause a best targeted change of the behavior of the detected threat acting abnormal to the normal pattern of life on the network while minimizing the impact on other network devices and users that are currently active and not in breach of being outside the normal behavior benchmark. The cyber attack simulation engine 105 cooperates with the AI models modelling a normal pattern of life for nodes in the system being protected.

The simulated attack module 750 is programmed itself and can cooperate with the artificial intelligence in the restoration engine 190 to factor an intelligent prioritization of remediation actions and which nodes in the simulated instance of the system being protected should have a priority compared to other nodes. This can also be reported out via the report module 770 to assist in allocating human security team personnel resources that need human or human approval to restore the nodes based on results of the one or more hypothetical simulations of the detected incident.

Note, as those skilled in the art will recognize, the cyber attack simulation engine 105, when doing attack path modelling, does not need to calculate every theoretically possible path from the virtualized instance of the source device to the end goal of the cyber-attack scenario but rather a set of the most likely paths, each time a hop is made from one node in the virtualized network to another device in the virtualized network, in order to reduce an amount of computing cycles needed by the one or more processing units as well as an amount of memory storage needed in the one or more non-transitory storage mediums.

In one embodiment, the cyber attack simulation engine 105 may be implemented via a simulator to model the system being protected and a clone creator to spin up a virtual network and create a virtual clone of the system being protected configured to pentest one or more defenses provided by scores based on both the level of confidence that the cyber threat is a viable threat and the severity of the cyber threat. The threat risk scores be used to rank alerts that may be directed to enterprise or computing device administrators. This risk assessment and ranking is conducted to avoid frequent false positive alerts that diminish the degree of reliance on the cyber security appliance 100. The cyber attack simulation engine 105 may include and cooperate with one or more AI model(s) 787 trained with machine learning on the contextual knowledge of the organization. These trained AI models may be configured to identify data points from the contextual knowledge of the organization and its entities, which may include language-based data, generative AI prompt activity, email and network connectivity, and historic knowledgebase data. The cyber attack simulation engine 105 may use the trained AI models to cooperate with one or more AI classifier(s) by producing a list of specific organization-based classifiers for the AI classifier 785. The cyber attack simulation engine 105 is further configured to calculate, based at least in part on the results of the one or more hypothetical simulations of a possible cyberattack path and of an actual ongoing cyberattack paths from a cyber threat determine a risk score for each node, the threat risk score being indicative of a possible severity of the compromise prior to an autonomous response action is taken in response to the actual cyberattack of the cyber incident.

Although a specific embodiment for a cyber attack simulation engine for carrying out the various steps, processes, methods, and operations described herein is discussed with respect to FIG. 7, any of a variety of systems and/or devices may be utilized in accordance with embodiments of the disclosure. For example, the cyber attack simulation engine 105 could be hosted entirely within the IT network system 792 rather than connected externally via the network 746, or the payload(s) module 730 could exclusively utilize cloud-based large language models to dynamically generate the simulated attacks in real-time. The elements depicted in FIG. 7 may also be interchangeable with other elements of FIGS. 1-6 and FIGS. 8-15 as required to realize a particularly desired embodiment.

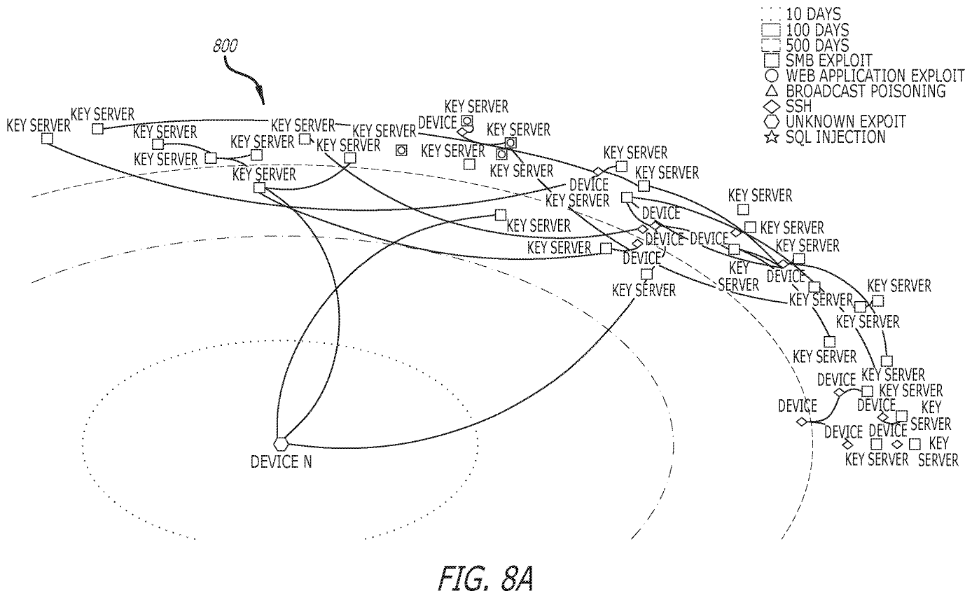

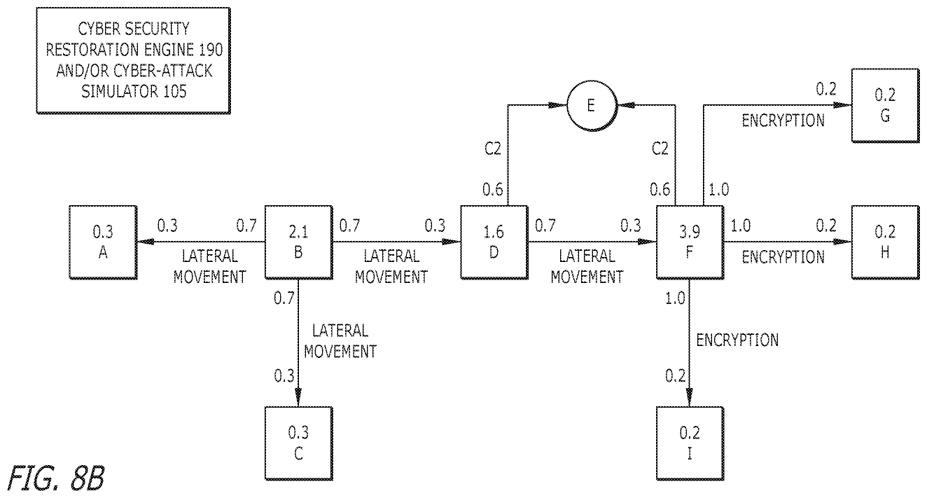

FIG. 8A illustrates a diagram of an embodiment of the cyber attack simulation engine and its artificial intelligence-based simulations constructing an example graph of nodes in an example network and simulating how the cyberattack path might likely progress in the future. This modeling is tailored with an innate understanding of a normal behavior of the nodes in the system being protected and a current operational state of each node in the graph of the protected system during simulations of cyberattacks. The cyber attack simulation engine 105 plots the attack path through the nodes and estimated times, such as 10 days, 100 days, or 500 days, to reach critical nodes in the network. The cyberattack simulation modeling is run to identify the routes, difficulty, and time periods from certain entry nodes to certain key servers, mapping out exploits ranging from web application vulnerabilities to unknown prompt injection exploits.

Again, similarly named components in each artificial intelligence-based engine can perform similar functions or have a communication link from that component located in one of the artificial intelligence-based engines where information needed from that component is communicated to another artificial intelligence-based engine through the interface to that artificial intelligence-based engine.

FIG. 8B illustrates a diagram of an embodiment of the cyber attack simulation engine 105 and the restoration engine 190 assigning scores for a portion of the graph of nodes of the system being protected. This includes the physical devices, automated agent accounts, and generative artificial intelligence interfaces in the system, as well as connections, lateral movements, and attack pathways through the network, assigning probabilistic scores such as 0.2, 0.3, 0.6, 0.7, and 1.0 to various nodes (A through I) representing the likelihood or severity of a compromise or encryption event.

### Training of AI Pre-Deployment and Then During Deployment

In step 1, an initial training of the artificial intelligence models trained on cyber threats can occur using unsupervised learning and supervised learning on characteristics and attributes of known potential cyber threats including prompt injections, malicious agentic data exfiltration, insider threats, and other kinds of cyber threats that can occur within the generative artificial intelligence domain. Each artificial intelligence model, such as a neural network or decision tree, can be programmed and configured with the background information to understand and handle particulars, including different types of prompt data, application programming interface protocols used, types of endpoint devices, and user accounts of the system being protected. The artificial intelligence pre-deployment can all be trained on the specific machine learning task that they will perform when put into deployment.

For example, the AI models 160 trained on identifying a specific cyber threat learns at least both in the pre-deployment training the characteristics and attributes of known potential cyber threats as well as a set of characteristics and attributes of each category of potential cyber threats and their weights assigned on how indicative certain characteristics and attributes correlate to potential cyber threats of that category of threats. In this example, one of the AI models 160 trained on identifying a specific cyber threat can be trained with machine learning such as Linear Regression, Regression Trees, Non-Linear Regression, Bayesian Linear Regression, or Deep learning to learn and understand the characteristics and attributes in that category of cyber threats. Later, when in deployment in a domain or network being protected by the cyber security appliance 100, the AI model trained on cyber threats can determine whether a potentially unknown threat has been detected via a number of techniques including an overlap of some of the same characteristics and attributes in that category of cyber threats. The AI model may use unsupervised learning when deployed to better learn newer and updated characteristics of sophisticated artificial intelligence-driven cyberattacks.

In an embodiment, one or more of the AI models 160 may be trained on a normal pattern of life of entities in the system as self-learning AI models using unsupervised machine learning and machine learning algorithms to analyze patterns and learn what is the normal behavior of the network. This involves analyzing data on the activity on, for example, the network level, at the device level, at the employee level, and at the generative artificial intelligence prompt level. The self-learning AI model using unsupervised machine learning understands the system under analysis' normal patterns of life in, for example, a week of being deployed on that system, and grows more bespoke with every passing minute. The AI unsupervised learning model learns patterns from the features in the day-to-day dataset and detects abnormal data, such as highly unusual text embeddings or API call frequencies, which would not have fallen into the category and cluster of normal behavior. The self-learning AI model using unsupervised machine learning can simply be placed into an observation mode for an initial week or two when first deployed on a network or domain in order to establish an initial normal behavior for entities in the network or domain under analysis.

Thus, a deployed artificial intelligence model 160 trained on a normal behavior of entities in the system can be configured to observe the nodes in the system being protected. Training on a normal behavior of entities in the system can occur while monitoring for the first week or two until enough data has been observed to establish a statistically reliable set of normal operations for each node, including user accounts, devices, and integrated language models. Initial training of one or more artificial intelligence models 160 trained with machine learning on a normal behavior of the pattern of life of the entities in the network or domain can occur where each type of network and domain will generally have some common typical behavior with each model trained specifically to understand components, protocols, activity levels, and prompt structures specific to that type of system. Alternatively, pre-deployment machine learning training of one or more artificial intelligence models trained on a normal pattern of life of entities in the system can occur. Initial training of one or more artificial intelligence models trained with machine learning on a normal behavior of the pattern of life of the entities in the network or domain can occur where each type of network and domain will generally have some common typical behavior with each model trained specifically to understand components, protocols, and activity levels to that type of network or domain. What is the normal behavior of each entity within that system can be established either prior to the deployment and then adjusted during deployment, or alternatively the model can simply be placed into an observation mode for an initial week or two when first deployed on a network or domain in order to establish an initial normal behavior for entities in the network or domain under analysis. During the deployment of the model, what is considered normal behavior will change as each different entity's behavior changes and will be reflected through the use of unsupervised learning in the model such as various Bayesian techniques and vector clustering. Again, the AI models 160 can be implemented with various mechanisms, such neural networks, decision trees, autoencoder ensembles, and combinations of these. Likewise, one or more supervised machine learning AI models 160 may be trained to create possible hypotheses and perform cyber threat investigations on agnostic examples of past historical incidents of detecting a multitude of possible types of cyber threat hypotheses previously analyzed by a human cyber security analyst.

At its core, the self-learning AI models 160 that model the normal behavior, such as a normal pattern of life, of entities in the network mathematically characterizes what constitutes normal behavior, based on the analysis of a large number of different measures of a device's network behavior and artificial intelligence interaction. This includes API traffic and network activity processes including LLM access, data volumes, token counts, timings of events, credential use, connection type, volume, and directionality of uploads and downloads into the network, prompt text structures, packet intention, administrative activity, resource and information requests, and generated outputs.

### Clustering Methods

In order to model what should be considered as normal for a device, an AI agent, or a cloud container, its behavior can be analyzed in the context of other similar entities on the network. The AI models 160 can use unsupervised machine learning to algorithmically identify significant groupings, a task which is virtually impossible to do manually when dealing with high-dimensional vector embeddings of text. To create a holistic image of the relationships within the network, the AI models and AI classifiers employ a number of different clustering methods, including matrix-based clustering, density-based clustering, and hierarchical clustering techniques. The resulting clusters, such as stored centroids in a vector space representing normal prompts, can then be used to inform the modeling of the normative behaviors and similar groupings.

The AI models and AI classifiers can employ a large-scale computational approach to understand sparse structure in models of network connectivity based on applying L1-regularization techniques, such as the lasso method. This allows the artificial intelligence to discover true associations between different elements of a network which can be cast as efficiently solvable convex optimization problems and yield parsimonious models. Various mathematical approaches assist.

Next, one or more supervised machine learning AI models are trained to create possible hypotheses and how to perform cyber threat investigations on agnostic examples of past historical incidents of detecting a multitude of possible types of cyber threat hypotheses previously analyzed by human cyber threat analysts. AI models 160 trained on forming and investigating hypotheses on what are a possible set of cyber threats can be trained initially with supervised learning. Thus, these AI models 160 can be trained on how to form and investigate hypotheses on what are a possible set of cyber threats and steps to take in supporting or refuting hypotheses. The AI models trained on forming and investigating hypotheses are updated with unsupervised machine learning algorithms when correctly supporting or refuting the hypotheses including what additional collected data, such as specific anomalous prompt strings, proved to be the most useful.

Next, the various artificial intelligence models and AI classifiers combine the use of unsupervised and supervised machine learning to learn on the job as it does not depend solely upon knowledge of previous cyber threat attacks. The artificial intelligence models and classifiers combine the use of unsupervised and supervised machine learning to constantly revise assumptions about behavior, using probabilistic mathematics, that is always up to date on what a current normal behavior is, and not solely reliant on human input. The artificial intelligence models and classifiers combine the use of unsupervised and supervised machine learning on cyber security and are capable of seeing hitherto undiscovered cyber events, from a variety of threat sources, which would otherwise have gone unnoticed. Next, these cyber threats can include, for example: malicious or accidental insider threats leaking PII to an LLM, zero-day attacks utilizing previously unseen prompt structures, latent vulnerabilities, machine-speed attacks such as rogue AI agents exfiltrating data that propagate very quickly, Cloud and SaaS-based API attacks, other silent and stealthy advanced persistent threats, and advanced spear-phishing generated by artificial intelligence.

### Ranking the Cyber Threat

The assessment module 125 and the cyber threat analyst module 120 can cooperate with the AI models 160 trained on possible cyber threats to use AI algorithms to account for ambiguities by distinguishing between the subtly differing levels of evidence that characterize network and prompt data. Instead of generating the simple binary outputs malicious or benign, the AI's mathematical algorithms produce outputs marked with differing degrees of potential threat. This enables users of the system to rank alerts and notifications to the enterprise security administrator in a rigorous manner and prioritize those which most urgently require action. Meanwhile, it also assists to avoid the problem of numerous false positives associated with simply a rule-based approach.

### More on the Operation of the Cyber Security Appliance

As discussed in more detail below, the analyzer module 115 and the cyber threat analyst module 120 can cooperate with the one or more unsupervised machine learning AI models 160 trained on the normal pattern of life and normal behavior in order to perform anomaly detection against the actual normal pattern of life for that system to determine whether an anomaly, such as the identified abnormal generative AI behavior and suspicious activity, is malicious or benign. In the operation of the cyber security appliance 100, the emerging cyber threat can be previously unknown, but the emerging threat landscape data representative of the emerging cyber threat shares enough, or does not share enough, in common with the traits from the AI models 160 trained on cyber threats to now be identified as malicious or benign. Note, if later confirmed as malicious, then the AI models 160 trained with machine learning on possible cyber threats can update their training. Likewise, as the cyber security appliance 100 continues to operate, then the one or more AI models trained on a normal pattern of life for each of the entities in the system can be updated and trained with unsupervised machine learning algorithms. The analyzer module 115 can use any number of data analysis processes to help obtain system data points so that this data can be fed and compared to the one or more AI models trained on a normal pattern of life, as well as the one or more machine learning models trained on potential cyber threats, as well as create and store data points with the connection fingerprints and prompt embeddings.

All of the above AI models 160 can continually learn and train with unsupervised machine learning algorithms on an ongoing basis when deployed in their system that the cyber security appliance 100 is protecting. Thus, learning and training on what is normal behavior for each user, each device, and the system overall and lowering a threshold of what is an anomaly.

### Anomaly Detection/Deviations

Anomaly detection can discover unusual data points in your dataset. Anomaly can be a synonym for the word outlier. Anomaly detection or outlier detection is the identification of rare items, events, or observations which raise suspicions by differing significantly from the majority of the data. Anomalous activities can be linked to some kind of problems or rare events. Since there are tons of ways to induce a particular cyber-attack, it is very difficult to have information about all these attacks beforehand in a dataset. But, since the majority of the user activity, device activity, and prompt requests in the system under analysis is normal, the system overtime captures almost all of the ways which indicate normal behavior. And from the inclusion-exclusion principle, if an activity under scrutiny does not give indications of normal activity, the self-learning AI model using unsupervised machine learning can predict with high confidence that the given activity is anomalous or unusual. The AI unsupervised learning model learns patterns from the features in the day to day dataset and detects abnormal data which would not have fallen into the category or cluster of normal behavior. The goal of the anomaly detection algorithm through the data fed to it is to learn the patterns of a normal activity so that when an anomalous activity occurs, the modules can flag the anomalies through the inclusion-exclusion principle. The cyber threat module can perform its two-level analysis on anomalous behavior and determine correlations.

In an example, 95% of data in a normal distribution lies within two standard-deviations from the mean. Since the likelihood of anomalies in general is very low, the modules cooperating with the AI model of normal behavior can say with high confidence that data points spread near the mean value are non-anomalous. And since the probability distribution values between mean and two standard-deviations are large enough, the modules cooperating with the AI model of normal behavior can set a value in this example range as a threshold, where a parameter can be tuned over time through the self-learning. Here, feature values with probability larger than this threshold indicate that the given feature's values are non-anomalous, otherwise it is anomalous. Note, this anomaly detection can determine that a data point is anomalous or non-anomalous on the basis of a particular feature, such as calculating a reconstruction loss score indicating how unusual the data is. In reality, the cyber security appliance 100 should not flag a data point as an anomaly based on a single feature. Merely, when a combination of all the probability values for all features for a given data point is calculated can the modules cooperating with the AI model of normal behavior say with high confidence whether a data point is an anomaly or not. Anomaly detection can discover unusual data points in your dataset.

Again, the AI models trained on a normal pattern of life of entities in a network or domain under analysis may perform the cyber threat detection through a probabilistic change in a normal behavior through the application of, for example, an unsupervised Bayesian mathematical model to detect the behavioral change in computers, generative AI prompts, and computer networks. The Bayesian probabilistic approach can determine periodicity in multiple time series data and identify changes across single and multiple time series data for the purpose of anomalous behavior detection. Additional anomalous behavior detectors can use rolling ensembles of autoencoder models, a recurrent neural network, and a bidirectional long short-term memory (LSTM) to calculate out-of-distribution anomaly scores.

Next, as discussed further below, during pre-deployment the cyber threat analyst module 120 and the analyzer module 115 can use data analysis processes and cooperate with AI models 160 trained on forming and investigating hypotheses on what are a possible set of cyber threats. In addition, another set of AI models can be trained on how to form and investigate hypotheses on steps to take in supporting or refuting hypotheses. The AI models trained on forming and investigating hypotheses are updated with unsupervised machine learning algorithms when correctly supporting or refuting the hypotheses including what additional collected data proved to be the most useful.

Although a specific embodiment for a cyber attack simulation engine constructing node graphs and assigning probabilistic scores for carrying out the various steps, processes, methods, and operations described herein is discussed with respect to FIGS. 8A and 8B, any of a variety of systems and/or devices may be utilized in accordance with embodiments of the disclosure. For example, the simulation engine could utilize three-dimensional cluster maps to visualize the cyberattack paths rather than two-dimensional node graphs, or the scoring matrices could rely on discrete logical thresholds in addition to continuous probabilistic calculations. The elements depicted in FIGS. 8A and 8B may also be interchangeable with other elements of FIGS. 1-7 and FIGS. 9-15 as required to realize a particularly desired embodiment.

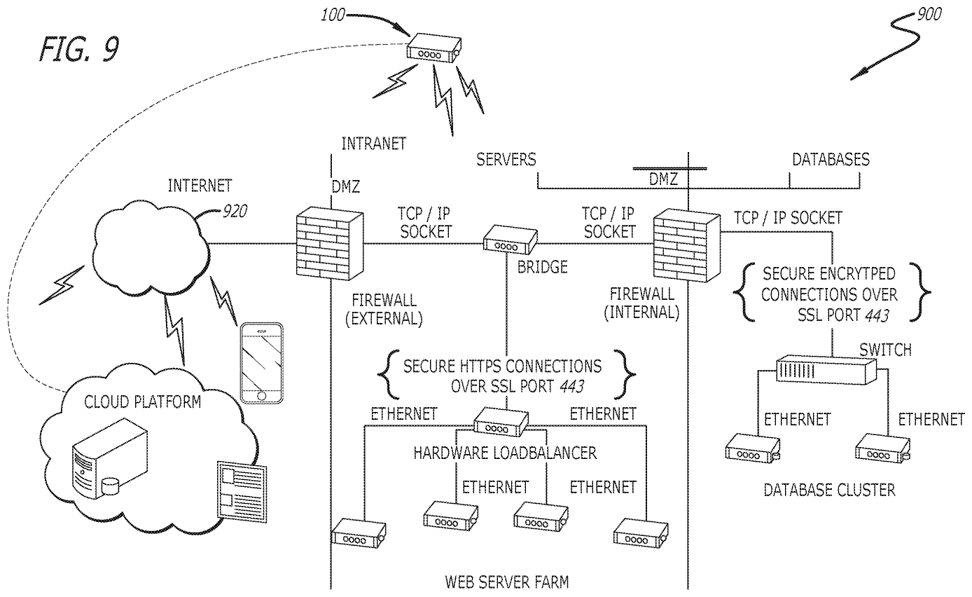

FIG. 9 illustrates a block diagram of an embodiment of a cyber threat defense system 900 featuring the artificial intelligence-based cyber security appliance 100 and other artificial intelligence-based engines plugging in as an appliance platform to protect a system against anomalous generative artificial intelligence interactions. The probes and detectors monitor, in this example, external large language model application programming interface activity and internal IT network activity to feed this data to determine what is occurring in each domain individually to their respective modules configured and trained to understand that domain's information, such as prompt structures and vector embeddings, as well as correlate causal links between these activities in these domains to supply this input into the modules of the cyber security appliance 100. The network can include various computing devices such as desktop units, laptop units, smart phones, firewalls, network switches, routers, servers, databases, Internet gateways, etc.

The cyber threat defense system 900 is configured to represent the comprehensive enterprise network architecture and its connections to external environments. This overarching system encompasses the internal private networks, the demilitarized zones, and the external cloud platforms where modern business operations occur. In various embodiments, the cyber threat defense system 900 provides the structural context within which the analytical models evaluate a pattern of life, tracking how data flows from endpoint user devices through internal switches and firewalls out to third-party artificial intelligence services. By monitoring this complete topology, the defensive mechanisms can accurately pinpoint exactly where an unauthorized data exfiltration attempt or prompt injection attack is originating and where it is destined.

The cyber security appliance 100 is configured to deploy within this architecture to passively or actively monitor the data traversing the internal and external boundaries. This appliance can ingest mirrored traffic from core switches or receive telemetry directly from the secure gateways routing traffic to the internet. In some embodiments, the cyber security appliance 100 might sit at a strategic choke point to intercept and parse the secure communications flowing to generative artificial intelligence tools, calculating anomaly scores and executing autonomous responses before the traffic leaves the enterprise. The cyber security appliance 100 serves as the analytical brain of the network, orchestrating the detection and mitigation of complex artificial intelligence-driven threats across the entire infrastructure.

The internet 920 is configured to represent the public, untrusted external network connecting the enterprise to third-party services. This expansive network routes the application programming interface calls and chat sessions from internal users to the externally hosted large language models. In certain embodiments, the internet 920 might be the vector through which external attackers attempt to send maliciously crafted prompt injection payloads into public-facing corporate chatbots. The internet 920 acts as the primary transmission medium for both legitimate cloud-based artificial intelligence utilization and external cyber threats targeting the organization.

The cloud platform is configured to host external resources, which frequently include the massive computational clusters required to run commercial generative artificial intelligence models. This platform can receive the prompts submitted by the enterprise's employees and return the generated text, code, or images. In various embodiments, the cloud platform might also host the decentralized analytic logic and virtual sensors utilized by the cyber security appliance itself to process telemetry at scale. The cloud platform represents the highly scalable, external destination where much of the modern generative artificial intelligence processing actually occurs.

The external and internal firewalls are configured to enforce the perimeter and internal segmentation security policies of the enterprise. These devices can maintain the access control lists that permit or deny traffic flowing between the intranet, the demilitarized zone, and the internet. In some embodiments, the firewalls might integrate with the autonomous response engine of the cyber security appliance to dynamically block specific Transmission Control Protocol sockets if an unauthorized artificial intelligence interaction is detected. The firewalls provide the necessary physical or logical barriers required to contain compromised nodes and halt active data exfiltration events.

The secure HTTPS connections over SSL port 443 are configured to encrypt the data payloads traveling between the user endpoints, the web servers, and the external cloud platforms. This encryption ensures that sensitive prompts and proprietary data remain confidential while in transit across untrusted networks. In certain embodiments, the cyber security system must utilize endpoint parsers or authorized proxy decryption to inspect these secure encrypted connections, allowing the natural language processing classifiers to evaluate the raw text of the generative artificial intelligence interactions. These secure connections highlight the necessity for advanced interception and parsing capabilities to effectively monitor modern, encrypted artificial intelligence traffic.

The demilitarized zone, bridge, hardware load balancer, and web server farm are configured to securely host and route traffic for the organization's internally hosted, public-facing applications. These components can manage the incoming connections from external users accessing the company's website or customer support portals. In various embodiments, the web server farm might host an internal, enterprise-licensed large language model interface that must be protected against external prompt injection attempts designed to trick the system into revealing backend server configurations. This infrastructure tier requires specialized monitoring to ensure that generative artificial intelligence features embedded in public applications do not become a vector for lateral network compromise.

The internal servers and database cluster are configured to store the highly sensitive, proprietary information of the enterprise, such as human resources records, financial data, and core intellectual property. These databases operate deep within the trusted intranet, far behind the external firewalls. In some embodiments, the database cluster might be targeted by a rogue internal artificial intelligence agent that has been compromised by an attacker, attempting to query the sensitive records and bundle them into an outgoing prompt for exfiltration. The servers and database cluster represent the ultimate prize for cybercriminals, making their protection the primary objective of the entire cyber threat defense architecture.

Although a specific embodiment for a cyber threat defense system utilizing a cyber security appliance for carrying out the various steps, processes, methods, and operations described herein is discussed with respect to FIG. 9, any of a variety of systems and/or devices may be utilized in accordance with embodiments of the disclosure. For example, the hardware load balancer could be replaced with a software-defined networking controller, or the database cluster could be hosted entirely within a virtual private cloud rather than on-premises hardware. The elements depicted in FIG. 9 may also be interchangeable with other elements of FIGS. 1-8B and FIGS. 10-15 as required to realize a particularly desired embodiment.

### Computing Devices

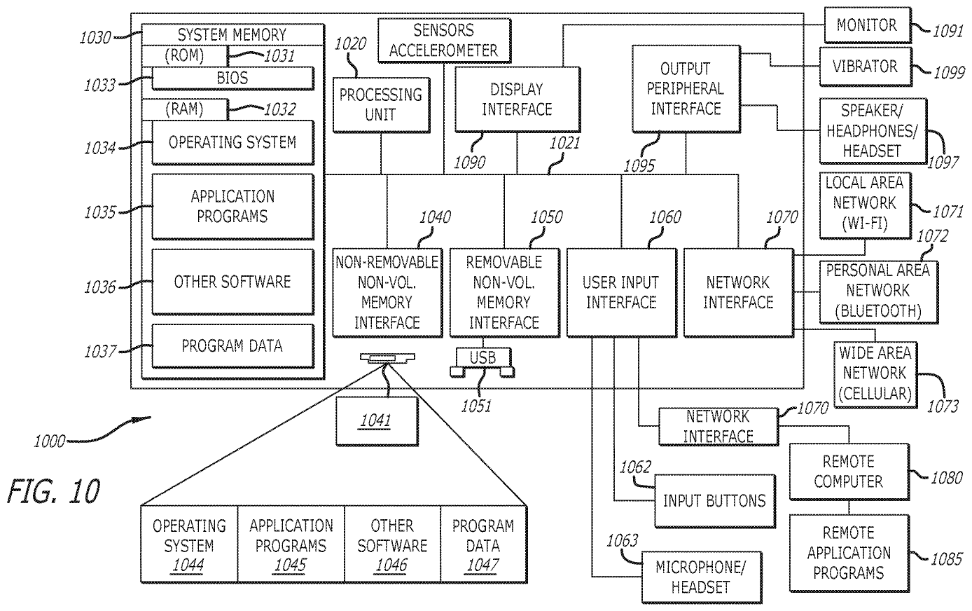

FIG. 10 illustrates a block diagram of an embodiment of one or more computing devices 1000 that can be a part of the artificial intelligence-based cyber security system, including the multiple artificial intelligence-based engines, the cyber security appliance, the scalable cloud platform, the endpoint c-sensors, and the generative artificial intelligence interaction modules discussed herein.

The computing device 1000 may include one or more processors or processing units 1020 to execute instructions, one or more memories to store information, one or more data input components to receive data input from a user of the computing device 1000, and a network interface 1070 to establish a communication link to communicate with other computing devices external to the computing device 1000. The computing device 1000 may also include one or more sensors, such as an accelerometer, where an output from the sensors is used for sensing a specific triggering condition and then correspondingly generating one or more preprogrammed actions. A display screen or monitor 1091 is utilized to display at least some of the information stored in the memories and other components. Note, portions of this design implemented in software are stored in the one or more memories, such as the system memory (ROM) 1030 and the system memory (RAM) 1033, and are executed by the one or more processing units 1020. The processing unit 1020 may have one or more processing cores, which couples to a system bus 1021 that couples various system components including the system memory. The system bus 1021 may be any of several types of bus structures selected from a memory bus, an interconnect fabric, a peripheral bus, and a local bus using any of a variety of bus architectures.

Computing device 1000 typically includes a variety of computing machine-readable media. Machine-readable media can be any available media that can be accessed by computing device 1000 and includes both volatile and nonvolatile media, and removable and non-removable media. By way of example, and not limitation, computing machine-readable media use includes storage of information, such as computer-readable instructions, data structures, other executable software, or other data utilized to monitor and evaluate generative artificial intelligence interactions. Computer-storage media includes, but is not limited to, RAM 1033, ROM 1030, BIOS 1031, EEPROM, flash memory or other memory technology, CD-ROM, digital versatile disks (DVD) or other optical disk storage, magnetic cassettes, magnetic tape, magnetic disk storage or other magnetic storage devices, or any other tangible medium which can be used to store the desired information, and which can be accessed by the computing device 1000. Transitory media such as wireless channels are not included in the machine-readable media. Machine-readable media typically embody computer readable instructions, data structures, and other executable software. In an example, volatile and non-volatile memory drives are illustrated for storing portions of the operating system 1034, application programs 1035, other software 1036, and program data 1037. A non-removable non-volatile memory interface 1040 can communicatively couple to a local hard drive 1041 to store large datasets, such as the operating system 1044, application programs 1045, other software 1046, and program data 1047, which may include the vector storage databases and autoencoder ensembles used for prompt analysis. A removable non-volatile memory interface 1050 can couple to portable storage devices, such as a USB 1051 drive.

A user may enter commands and information into the computing device 1000 through input devices such as a keyboard, touchscreen, or software or hardware input buttons 1062, a microphone/headset 1063, a pointing device and scrolling input component, such as a mouse, trackball, or touch pad. The microphone/headset 1063 can cooperate with speech recognition software to capture voice-to-text prompts directed at large language models. These and other input devices are often connected to the processing unit 1020 through a user input interface 1060 that is coupled to the system bus 1021, but can be connected by other interface and bus structures, such as a lightning port, game port, or a universal serial bus. A display monitor 1091 or other type of display screen device is also connected to the system bus 1021 via an interface, such as a display interface 1090. In addition to the monitor 1091, computing devices may also include other peripheral output devices such as a speaker/headphones/headset 1097, a vibrator 1099, and other output devices, which may be connected through an output peripheral interface 1095.

The computing device 1000 can operate in a networked environment using logical connections to one or more remote computers or client devices, such as a remote computer 1080. The remote computer 1080 can be a personal computer, a mobile computing device, a server hosting a generative artificial intelligence model, a router, a network PC, a peer device, or other common network node, and typically includes many or all of the elements described above relative to the computing device 1000. The logical connections can include a personal area network (PAN) 1072, a local area network (LAN) 1071, and a wide area network (WAN) 1073. Such networking environments are commonplace in offices, enterprise-wide computer networks, intranets, and the Internet. A browser application and one or more local apps may be resident on the computing device 1000 and stored in the memory to facilitate the submission of prompts to external chatbots or internal agents.

When used in a LAN networking environment, the computing device 1000 is connected to the LAN 1071 through a network interface 1070, which can be, for example, a Bluetooth or Wi-Fi adapter. When used in a WAN networking environment, the computing device 1000 typically includes some means for establishing communications over the WAN 1073. With respect to mobile telecommunication technologies, for example, a radio interface, which can be internal or external, can be connected to the system bus 1021 via the network interface 1070, or other appropriate mechanism. In a networked environment, other software depicted relative to the computing device 1000, or portions thereof, may be stored in the remote memory storage device. By way of example, and not limitation, remote application programs 1085 can reside on the remote computer 1080. It will be appreciated that the network connections shown are examples and other means of establishing a communications link between the computing devices that may be used. It should be noted that the present design can be carried out on a single computing device or on a distributed system in which different portions of the present design are carried out on different parts of the distributed computing system, such as decentralizing the analytic logic across multiple edge computing devices.

The computing device 1000 is configured to comprise at least a hardware architecture that can be utilized to implement any of the various components of the artificial intelligence-based cyber security system. This device can serve as the underlying physical hardware for the cyber security appliance, the endpoint c-sensors deployed on user machines, or the servers operating within the scalable cloud platform. In various embodiments, the computing device 1000 provides the computational resources, memory storage, and network connectivity required to ingest generative artificial intelligence interactions, calculate reconstruction loss scores, and execute autonomous response actions in real time.

The processing unit 1020 is configured to execute the complex instructions and machine learning algorithms that drive the cyber security system. This unit can comprise one or more multi-core processors, graphical processing units, or specialized tensor processing units designed to handle the heavy computational loads of natural language processing. In some embodiments, the processing unit 1020 may process the extracted prompt data through the autoencoder ensembles or the named entity recognition classifiers to instantly determine if a user's interaction with a large language model contains unauthorized personal identifiable information.

The system bus 1021 is configured to act as the primary internal communication backbone of the computing device. This bus communicatively couples the various internal components, such as linking the processing unit to the system memory and the peripheral interfaces. In certain embodiments, the system bus 1021 must support extremely high-bandwidth data transfers, ensuring that the large, high-dimensional vector embeddings generated during the analysis of a generative artificial intelligence prompt can move swiftly between the memory and the processor without creating a computational bottleneck.

The system memory (ROM) 1030 is configured to provide non-volatile storage for the essential firmware of the computing device. This memory retains its data even when the device is powered down, ensuring that critical startup instructions are never lost. In various embodiments, the system memory (ROM) 1030 provides the foundational, unalterable code base required to initialize the hardware components securely before the advanced cyber security analytic modules and endpoint agents can be loaded into active memory.

The BIOS 1031 is configured to operate as the basic input/output system stored within the read-only memory. This firmware initializes and tests the hardware components during the boot process and loads the operating system. In some embodiments, the BIOS 1031 may include secure boot protocols designed to ensure that the underlying hardware has not been compromised by a rootkit or advanced persistent threat before the cyber security appliance's anomaly detection algorithms even begin running.

The system memory (RAM) 1032 is configured to act as the primary volatile workspace for the computing device. This memory holds the active data and executable code that the processing unit is currently utilizing. In certain embodiments, the system memory (RAM) 1032 might temporarily store the intercepted text of an outgoing generative artificial intelligence prompt, holding the payload in active memory just long enough for the AI classifiers to generate a threat risk score before the data is either flushed or forwarded to the external network.

The RAM indicator 1033 is configured to specifically point to the memory block representing the volatile random-access memory allocations. This active memory space is highly dynamic, constantly shifting as new applications and analytical models are loaded and unloaded. In various embodiments, the RAM indicator 1033 represents the space where the real-time, rolling ensemble of autoencoder models is held active to ensure zero-latency inference when a new prompt interaction is detected on the endpoint.

The operating system 1034 is configured to manage the local hardware resources and provide common services for the active computer programs. This software layer resides in the active RAM while the device is running, orchestrating the file system, memory allocation, and process scheduling. In some embodiments, the operating system 1034 provides the environment into which the endpoint c-sensor integrates, allowing the security agent to hook into deep system processes and monitor the network traffic generated by local applications attempting to access external large language models.

The application programs 1035 are configured to represent the active, user-facing software currently executing in the volatile memory. These programs can include web browsers, native chat clients, or specialized enterprise software. In certain embodiments, the application programs 1035 are the origin point for the generative artificial intelligence interactions, serving as the interface where a human employee types a prompt or where a local AI agent drafts an automated query that the cyber security appliance must subsequently intercept and evaluate.

The other software 1036 is configured to represent additional active background processes, services, and daemons running in the volatile memory. This software can include necessary system utilities or third-party integrations. In various embodiments, the other software 1036 might comprise the active threat intelligence parsers or the local analytic logic of the cybersecurity system, working silently alongside the application programs to continuously track the pattern of life of the device and calculate out-of-distribution anomaly scores.

The program data 1037 is configured to represent the active, temporary datasets being utilized by the running software and applications in the RAM. This data can include temporary cache files, active user session tokens, and immediate interaction telemetry. In some embodiments, the program data 1037 might hold the dynamically generated placeholder values that the autonomous response engine is currently utilizing to mask sensitive personal identifiable information within a prompt before the altered prompt is transmitted out of the network interface.

The non-removable non-vol. memory interface 1040 is configured to serve as the internal controller connecting the system bus to the primary, permanent local storage drives. This interface handles the high-speed read and write commands directed to the local disks. In certain embodiments, the non-removable non-vol. memory interface 1040 manages the continuous stream of historical interaction logs being written to the data store, ensuring that the heavy logging requirements of the cyber security appliance do not degrade the overall performance of the computing device.

The hard drive 1041 is configured to represent the physical, non-volatile storage medium, such as a solid-state drive or magnetic disk, permanently installed in the computing device. This drive securely stores the massive volumes of data required for long-term operations. In various embodiments, the hard drive 1041 may serve as the primary local data store, archiving weeks or months of generative artificial intelligence prompts, responses, and anomaly scores to serve as the historical baseline for training new pattern of life machine learning models.

The operating system 1044 is configured to represent the permanent installation files and core directories of the device's operating system stored on the hard drive. These files are loaded into RAM during the boot sequence. In some embodiments, the operating system 1044 directories must be strictly protected by the cyber security system, as advanced prompt injection attacks or rogue AI agents may attempt to execute unauthorized scripts designed to alter these foundational files and establish persistence on the endpoint.

The application programs 1045 are configured to represent the permanent installation files for the user and system applications residing on the hard drive. These files remain dormant until launched by the user or the operating system. In certain embodiments, the application programs 1045 might include the locally installed, proprietary enterprise chatbots or development tools that the cyber security system must continually monitor to ensure they are not exploited to exfiltrate proprietary source code.

The other software 1046 is configured to represent the stored binaries and executables for the background services and security tools. This can include the dormant endpoint agent installer files or configuration scripts. In various embodiments, the other software 1046 might encompass the locally stored rules-based models and hardcoded containment scripts that the autonomous response engine calls upon when a severe artificial intelligence interaction anomaly is detected and immediate network isolation is required.

The program data 1047 is configured to represent the persistent datasets, databases, and logs saved to the hard drive for long-term retention. This data survives power cycles and provides the historical context for the device. In some embodiments, the program data 1047 includes the stored vector space centroids and the clustered embeddings of previous prompts, enabling the analyzer module to quickly load historical references and calculate similarity scores without needing to query a remote cloud server.

The removable non-vol. memory interface 1050 is configured to manage connections to portable, external storage devices. This interface allows the computing device to read and write data to media that can be physically disconnected and moved. In certain embodiments, the removable non-vol. memory interface 1050 might be strictly monitored or disabled by the cyber security appliance's autonomous response engine to prevent an insider threat from utilizing an automated AI script to scrape internal databases and dump the confidential results onto a portable drive.

The USB 1051 is configured to represent a physical Universal Serial Bus drive or similar portable storage medium connected to the device. This media provides a highly portable means of transferring data. In various embodiments, the USB 1051 could be utilized by a security administrator to manually load highly sensitive, air-gapped threat intelligence updates or newly trained artificial intelligence classifier models directly onto an isolated on-premises cyber security appliance without connecting it to the external internet.

The user input interface 1060 is configured to manage the signals originating from physical human-interface devices. This interface translates physical keystrokes and mouse movements into digital commands that the operating system can process. In some embodiments, the user input interface 1060 handles the direct typing of prompts into a chat interface, representing the exact point of origin for a generative artificial intelligence interaction before the text is parsed, encrypted, and sent to the network layer.

The input buttons 1062 are configured to represent physical keys, such as a keyboard, mouse clicks, or hardware switches on a mobile device. These buttons provide the tactile control mechanisms for the human user. In certain embodiments, the input buttons 1062 are the primary means by which an employee constructs the complex, multi-turn prompts directed at an enterprise large language model, generating the behavioral telemetry that the c-sensor must evaluate against the user's normal pattern of life.

The microphone/headset 1063 is configured to capture audio input from the user and deliver audio output. This peripheral allows for voice commands and auditory feedback. In various embodiments, the microphone/headset 1063 might be utilized by a user to dictate voice-to-text prompts directed at a generative artificial intelligence assistant, requiring the local endpoint agent to intercept and analyze the transcribed text for sensitive information leakage before the query is processed by the cloud model.

The network interface 1070 is configured to manage the primary communication hardware connecting the device to external networks. This interface translates internal data packets into the specific protocols required for network transmission. In some embodiments, the network interface 1070 is the critical junction where the autonomous response engine can intervene, allowing the cyber security appliance to instantly drop a Transmission Control Protocol connection or issue a reset packet if a malicious prompt injection is detected traversing the interface.

The local area network (Wi-Fi) 1071 is configured to represent a wireless, localized network connection utilized by the device. This network typically connects the endpoint to the broader enterprise intranet via wireless access points. In certain embodiments, the local area network (Wi-Fi) 1071 carries the internal east-west traffic, such as an endpoint querying a locally hosted, private large language model, which the cyber security appliance must monitor just as strictly as external web traffic to prevent lateral movement by a compromised agent.

The personal area network (Bluetooth) 1072 is configured to represent a short-range wireless communication protocol connecting the device to nearby peripherals. This network manages connections to items like wireless headsets, smartwatches, or mobile phones. In various embodiments, the personal area network (Bluetooth) 1072 might be monitored by the cyber security system to ensure that a compromised local AI agent does not attempt to utilize an unmonitored Bluetooth tether to a mobile device to exfiltrate data, bypassing the primary enterprise firewalls.

The wide area network (Cellular) 1073 is configured to represent a long-range wireless connection to the broader internet or telecommunications network. This connection allows the device to operate independently of the local enterprise Wi-Fi. In some embodiments, the wide area network (Cellular) 1073 might be utilized by a remote endpoint computing device to connect directly to third-party cloud-based generative AI tools, necessitating the presence of the local c-sensor to perform the data extraction and anomaly detection directly on the device rather than relying on a centralized appliance.

The remote computer 1080 is configured to represent an external server, peer device, or cloud infrastructure physically separated from the local computing device. This remote entity can provide vast computational resources or host centralized databases. In certain embodiments, the remote computer 1080 represents the massive cloud server clusters hosting the commercial large language models that the enterprise's employees are interacting with, sitting outside the protective boundary of the organization's internal network.

The remote application programs 1085 are configured to represent the software and services actively running on the remote computer. These programs provide the application programming interfaces and web portals accessed by the local device. In various embodiments, the remote application programs 1085 comprise the actual generative artificial intelligence neural networks, chatbots, and image generation algorithms that receive the user prompts, process the requests, and return the generated content back through the network interface to the local endpoint.

The display interface 1090 is configured to manage the graphical processing and video output signals of the computing device. This interface translates the digital data into the pixel configurations required by the monitor. In some embodiments, the display interface 1090 is responsible for rendering the complex, human-readable dashboards generated by the user interface/formatting module, allowing security administrators to visually track the active cyber threats, reconstruction loss graphs, and blocked prompt payloads.

The monitor 1091 is configured to serve as the primary visual output device for the system. This screen displays the operating system interface, active applications, and system alerts. In certain embodiments, the monitor 1091 provides the critical visual feedback to a user when the autonomous response engine intervenes, perhaps displaying a localized pop-up warning that their generative artificial intelligence prompt was dynamically modified to mask personal identifiable information before transmission.

The output peripheral interface 1095 is configured to manage the signals directed to non-visual feedback devices. This interface routes the specific digital commands to audio drivers and haptic motors. In various embodiments, the output peripheral interface 1095 might coordinate with the operating system to trigger specific alerts when the local c-sensor detects an anomaly, ensuring that the user or administrator is immediately notified of a security event even if they are not actively looking at the visual dashboard.

The speaker/headphones/headset 1097 is configured to deliver auditory output from the computing device. This component converts digital audio signals into sound waves. In some embodiments, the speaker/headphones/headset 1097 might be utilized to output the synthesized voice responses generated by a conversational artificial intelligence model, or to sound an audible alarm triggered by the orchestration module when a critical data exfiltration event is actively occurring on the network.

The vibrator 1099 is configured to provide haptic, physical feedback to the user. This component utilizes a small motor to generate vibrations, commonly found in mobile or wearable endpoint devices. In certain embodiments, the vibrator 1099 might be triggered by the cyber security system's anomaly alert module to provide a subtle, physical notification to a user's mobile device that a scheduled, automated AI workflow they initiated was paused by the autonomous response engine due to a detected network policy violation.

Although a specific embodiment for a computing device for carrying out the various steps, processes, methods, and operations described herein is discussed with respect to FIG. 10, any of a variety of systems and/or devices may be utilized in accordance with embodiments of the disclosure. For example, the computing device could be implemented as a headless server blade within a data center lacking a dedicated display interface, or the storage media could rely entirely on cloud-based remote storage rather than local hard drives. The elements depicted in FIG. 10 may also be interchangeable with other elements of FIGS. 1-9 and FIGS. 11-15 as required to realize a particularly desired embodiment.

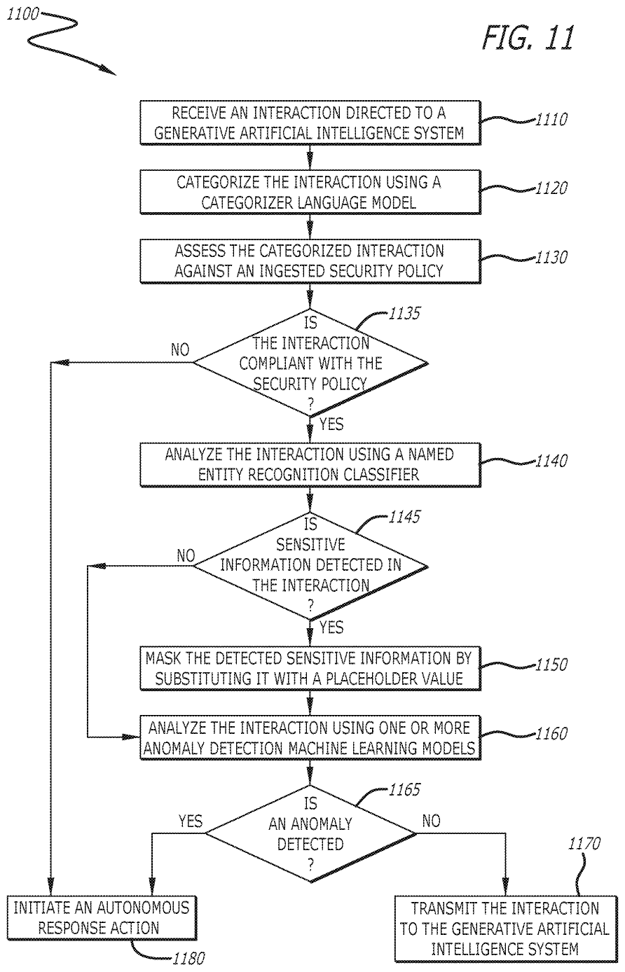

FIG. 11 illustrates a flow diagram of an embodiment of a process 1100 for securing generative artificial intelligence interactions. The process 1100 can be executed by the cyber security appliance, the endpoint agents, the scalable cloud platform, or a distributed combination of these analytical components to evaluate prompts and payloads in real time. The process 1100 can receive an interaction directed to a generative artificial intelligence system (Block 1110). The cyber security appliance or a local c-sensor can intercept the outgoing application programming interface call or chat submission before it leaves the protected enterprise boundary. This interaction typically consists of a natural language prompt, a code snippet, or a file upload generated by a human employee or an automated internal artificial intelligence agent seeking to utilize an external or internal large language model.

The process 1100 can categorize the interaction using a categorizer language model (Block 1120). The system can process the intercepted text through a specialized, lightweight machine learning classifier to determine the semantic intent and operational category of the prompt. For example, the categorizer language model might classify the interaction as a request for creative writing, a source code debugging query, a financial data summarization task, or casual conversation. By accurately categorizing the interaction early in the pipeline, the system can dynamically select the most appropriate set of security rules and anomaly thresholds for the subsequent evaluations.

The process 1100 can assess the categorized interaction against an ingested security policy (Block 1130). The analytic logic can retrieve the organization's specific data governance rules, acceptable use policies, and access control lists from the data store. The system then evaluates the categorized interaction to see if it violates any of these predefined parameters. For instance, the ingested security policy might strictly prohibit any interaction categorized as “source code debugging” from being sent to an untrusted, public-facing chatbot, or it might restrict a specific automated marketing agent from querying financial databases.

The process 1100 can determine whether the interaction is compliant with the security policy (Block 1135). If the interaction violates the established rules, the process 1100 can proceed to initiate an autonomous response action (Block 1180) to immediately halt the unauthorized activity. If the interaction complies with the basic security policies, the process 1100 can proceed to analyze the interaction using a named entity recognition classifier (Block 1140).

The process 1100 can analyze the interaction using a named entity recognition classifier (Block 1140). Even if the prompt's general category is permitted, the specific textual payload must be deeply inspected for hidden risks. The named entity recognition classifier scans the text to identify and classify specific sequences of words or numbers that match the characteristics of restricted data. This includes identifying social security numbers, credit card strings, proprietary project code names, or the names of confidential clients embedded deep within the natural language paragraphs of the prompt.

The process 1100 can determine whether sensitive information is detected in the interaction (Block 1145). If no restricted data types or sensitive entities are found within the payload, the process 1100 can proceed directly to analyze the interaction using one or more anomaly detection machine learning models (Block 1160). If sensitive information is identified, the process 1100 can proceed to mask the detected sensitive information by substituting it with a placeholder value (Block 1150).

The process 1100 can mask the detected sensitive information by substituting it with a placeholder value (Block 1150). The autonomous response module can dynamically modify the payload in transit to sanitize the prompt without completely breaking the user's workflow. For example, if the named entity recognition classifier detects a client's actual name, the system can remove that specific text string and replace it with a generic tag such as “[CLIENT_NAME_1]”. This allows the user to still submit the sanitized prompt to the generative artificial intelligence tool and receive a structurally useful response without actually exposing the underlying confidential data to the external model provider.

The process 1100 can analyze the interaction using one or more anomaly detection machine learning models (Block 1160). The cyber security appliance passes the prompt, whether in its original or masked state, through the suite of unsupervised pattern of life models. This step might involve generating a vector embedding of the text to calculate its mathematical distance from historical cluster centroids or processing the interaction through a rolling ensemble of autoencoders to calculate a reconstruction loss score. This step ensures that the system catches novel, previously unseen zero-day threats, complex prompt injection attacks, or highly unusual behaviors that successfully bypassed the static policies and the named entity recognition filters.

The process 1100 can determine whether an anomaly is detected (Block 1165). The assessment module compares the calculated out-of-distribution anomaly score or the semantic similarity score against an actionable threshold. If a severe anomaly is detected, indicating a high likelihood of a cyberattack, a compromised account, or an insider threat, the process 1100 can proceed to initiate an autonomous response action (Block 1180). If the interaction is determined to be a normal, benign activity within the established pattern of life, the process 1100 can proceed to transmit the interaction to the generative artificial intelligence system (Block 1170).

The process 1100 can transmit the interaction to the generative artificial intelligence system (Block 1170). The firewall or secure proxy allows the Transmission Control Protocol connection to proceed, routing the safe or sanitized prompt out to the external cloud platform or the internal server hosting the large language model. The system continues to monitor the session, remaining prepared to evaluate the response generated by the artificial intelligence tool when it is routed back to the requesting endpoint.

The process 1100 can initiate an autonomous response action (Block 1180). If triggered by a policy violation or a critical anomaly, the autonomous response engine executes immediate mitigation steps at machine speed. These actions can range from issuing a Transmission Control Protocol reset to instantly sever the connection, to actively locking the compromised user account out of the enterprise network entirely. This active defense mechanism ensures that the cyber threat is neutralized before any data exfiltration or unauthorized generative artificial intelligence interaction can be completed.

Although a specific embodiment for a process for securing generative artificial intelligence interactions for carrying out the various steps, processes, methods, and operations described herein is discussed with respect to FIG. 11, any of a variety of systems and/or devices may be utilized in accordance with embodiments of the disclosure. For example, the categorizer language model could be hosted natively on the endpoint agent to reduce network latency, or the autonomous response action could involve routing the flagged prompt to a human administrator for manual review rather than dropping the connection. The elements depicted in FIG. 11 may also be interchangeable with other elements of FIGS. 1-10 and FIGS. 12-15 as required to realize a particularly desired embodiment.

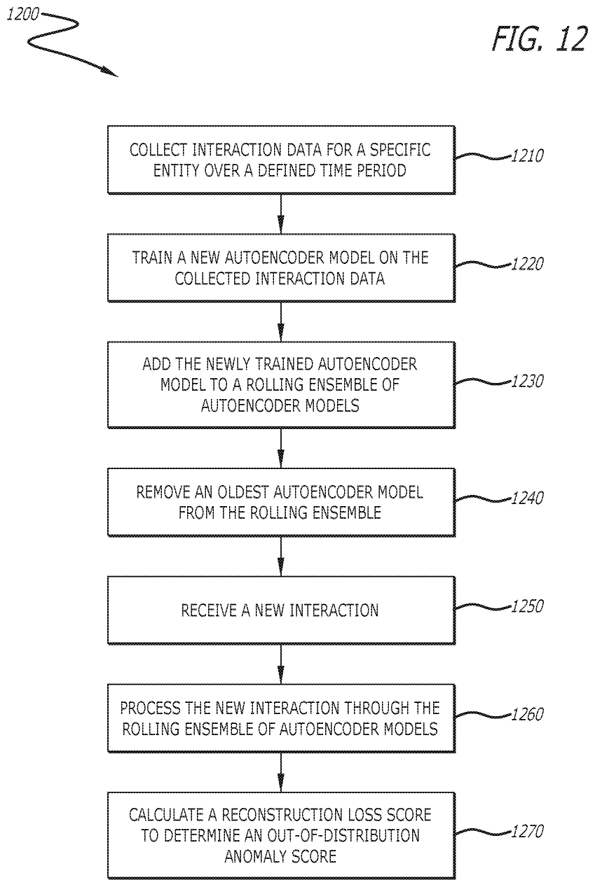

FIG. 12 illustrates a flow diagram of an embodiment of a process 1200 for utilizing unsupervised machine learning to detect anomalous generative artificial intelligence interactions. The process 1200 can be executed by the analytic logic within the cyber security appliance, a distributed cloud platform, or local endpoint c-sensors to continuously adapt to the shifting patterns of life of an organization's users and devices. The process 1200 can collect interaction data for a specific entity over a defined time period (Block 1210). The gather module and data store within the cyber security appliance aggregate the historical prompts, application programming interface calls, and language model responses generated by a particular user, endpoint device, or internal artificial intelligence agent. This defined time period might encompass a rolling window of the past seven or thirty days, capturing a statistically significant volume of routine interactions to accurately map the entity's normal operational baseline.

The process 1200 can train a new autoencoder model on the collected interaction data (Block 1220). Using unsupervised learning techniques, the analytic logic processes the aggregated historical prompts to teach the new autoencoder how to compress and reconstruct this specific user's typical generative artificial intelligence interactions. By focusing solely on the data from the defined time period, the new model learns the most current contextual nuances, vocabulary preferences, and typical usage frequencies specific to that entity.

The process 1200 can add the newly trained autoencoder model to a rolling ensemble of autoencoder models (Block 1230). Instead of relying on a single, static machine learning model that might suffer from concept drift over time, the cyber security appliance maintains a dynamic group of models. The freshly trained autoencoder is introduced into this ensemble, providing the most up-to-date representation of the entity's normal pattern of life to ensure the security system's baseline remains accurate as the user's role or projects evolve.

The process 1200 can remove an oldest autoencoder model from the rolling ensemble (Block 1240). To maintain computational efficiency and ensure the ensemble does not become overly influenced by outdated behaviors, the system routinely ages off the most historically distant model. This continuous cycling out of the oldest autoencoder ensures that the pattern of life baseline strictly reflects recent, relevant behaviors, preventing stale data from causing false positive anomaly alerts when an employee legitimately changes their typical workflow over time.

The process 1200 can receive a new interaction (Block 1250). A user or an automated agent on an endpoint computing device submits a new prompt or initiates a fresh chat session with an external large language model. The endpoint c-sensor or network parser intercepts this live data stream, extracting the textual payload and network telemetry, and forwards this current interaction to the analytic logic for real-time evaluation against the established baseline.

The process 1200 can process the new interaction through the rolling ensemble of autoencoder models (Block 1260). The intercepted prompt is fed simultaneously or sequentially into the active autoencoders currently comprising the ensemble. Each individual model within the ensemble attempts to compress the new interaction into a lower-dimensional representation and then reconstruct it back to its original form, utilizing the specific mathematical weights it learned during its respective training period.

The process 1200 can calculate a reconstruction loss score to determine an out-of-distribution anomaly score (Block 1270). The system measures the mathematical difference between the original input prompt and the reconstructed outputs generated by the ensemble. If the new interaction is similar to the user's historical baseline, the autoencoders will reconstruct it with minimal error; however, if the prompt contains novel prompt injection syntax, highly unusual data exfiltration payloads, or semantic structures radically different from the user's norm, the ensemble will struggle to reconstruct it, resulting in a high reconstruction loss. This high loss directly translates to a high out-of-distribution anomaly score, signaling the decision logic to trigger an autonomous response action to mitigate the detected threat.

Although a specific embodiment for a process for detecting anomalies using a rolling ensemble of autoencoder models for carrying out the various steps, processes, methods, and operations described herein is discussed with respect to FIG. 12, any of a variety of systems and/or devices may be utilized in accordance with embodiments of the disclosure. For example, the interaction data could be clustered into vector embeddings prior to training the autoencoder, or the ensemble could consist of recurrent neural networks rather than standard autoencoders. The elements depicted in FIG. 12 may also be interchangeable with other elements of FIGS. 1-11 and FIGS. 13-15 as required to realize a particularly desired embodiment.

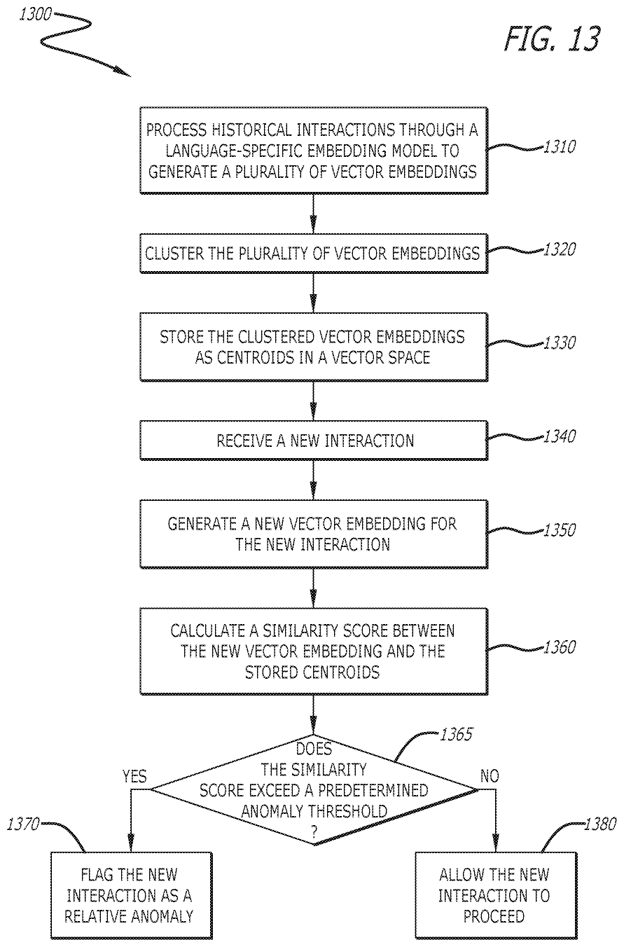

FIG. 13 illustrates a flow diagram of an embodiment of a process 1300 for evaluating the semantic intent of generative artificial intelligence interactions using vector embeddings and clustering. The process 1300 can be executed by the cyber security appliance's analytic logic or a distributed cloud platform to continuously map and monitor the contextual landscape of a user's typical prompts and queries. The process 1300 can process historical interactions through a language-specific embedding model to generate a plurality of vector embeddings (Block 1310). The system retrieves vast logs of previous textual prompts, application programming interface calls, and large language model responses associated with a specific user or endpoint device from the data store. This textual data is passed through a neural network designed to convert human-readable language into high-dimensional numerical vectors. These vector embeddings capture the deep semantic meaning and contextual relationships of the words utilized in the historical interactions, translating behavioral intent into a mathematical format that the machine learning models can efficiently process.

The process 1300 can cluster the plurality of vector embeddings (Block 1320). Once the historical text has been converted into numerical vectors, the analytic logic utilizes unsupervised machine learning algorithms, such as density-based spatial clustering or K-means clustering, to group similar vectors together. For example, all of a software developer's historical prompts asking an artificial intelligence tool to debug Python code will mathematically group together into one distinct cluster, while their occasional queries asking for help writing emails will form a separate, distinct cluster. This clustering effectively maps out the different typical operational domains of the user's normal pattern of life.

The process 1300 can store the clustered vector embeddings as centroids in a vector space (Block 1330). To optimize computational efficiency during real-time evaluations, the system calculates the geometric center, or centroid, of each identified cluster. These centroids act as the mathematical representation of the user's normal conversational topics and typical prompt structures. The system saves these centroids in a specialized vector storage database, creating a lightweight, highly searchable baseline of the entity's acceptable generative artificial intelligence usage.

The process 1300 can receive a new interaction (Block 1340). An endpoint c-sensor or a network firewall intercepts a live data stream as a user, or an automated agent attempts to submit a fresh prompt to an external chatbot or internal large language model. The exact text payload of this outgoing request is parsed and forwarded to the analytic logic for immediate evaluation before the connection is fully established with the destination server.

The process 1300 can generate a new vector embedding for the new interaction (Block 1350). The cyber security appliance passes the intercepted text of the new prompt through the identical language-specific embedding model utilized during the historical training phase. This instantly translates the live query into a new high-dimensional numerical vector, preparing it for a mathematical comparison against the established baseline.

The process 1300 can calculate a similarity score between the new vector embedding and the stored centroids (Block 1360). The analytic logic measures the mathematical distance, such as utilizing cosine similarity or Euclidean distance calculations, between the newly generated vector and the nearest historically established centroid retrieved from the vector storage database. A short distance indicates that the new prompt is semantically very similar to tasks the user has routinely performed in the past, while a large distance indicates a stark departure from the user's normal operational behavior.

The process 1300 can determine whether the similarity score exceeds a predetermined anomaly threshold (Block 1365). The system evaluates the calculated mathematical distance against a specific risk threshold. This threshold might be dynamically tuned based on the overall threat posture of the network or hardcoded by security administrators. If the new vector is located too far away from any known historical centroid in the vector space, it indicates that the interaction is semantically alien to the user's typical duties, answering the decision logic in the affirmative.

The process 1300 can flag the new interaction as a relative anomaly (Block 1370). If the similarity score exceeds the predetermined anomaly threshold (YES), the system formally categorizes the prompt as an out-of-distribution event. This flag can immediately trigger the autonomous response engine to drop the network connection, quarantine the endpoint, or route the highly unusual prompt to a human security analyst for deep inspection. This ensures that novel zero-day exploits or sudden insider threats attempting to misuse the artificial intelligence tool are halted in real time.

The process 1300 can allow the new interaction to proceed (Block 1380). If the similarity score does not exceed the predetermined anomaly threshold (NO), the system determines that the prompt aligns securely with the user's normal pattern of life. The cyber security appliance permits the Transmission Control Protocol connection to continue, routing the benign prompt out to the external cloud platform or internal generative artificial intelligence model without disrupting the employee's legitimate workflow.

Although a specific embodiment for a process for processing historical interactions and generating vector embeddings for carrying out the various steps, processes, methods, and operations described herein is discussed with respect to FIG. 13, any of a variety of systems and/or devices may be utilized in accordance with embodiments of the disclosure. For example, the vector space clustering could be performed continuously on a sliding temporal window rather than in discrete batch updates, or the similarity scoring could incorporate secondary metadata factors such as time-of-day access patterns. The elements depicted in FIG. 13 may also be interchangeable with other elements of FIGS. 1-12 and FIGS. 14-15 as required to realize a particularly desired embodiment.

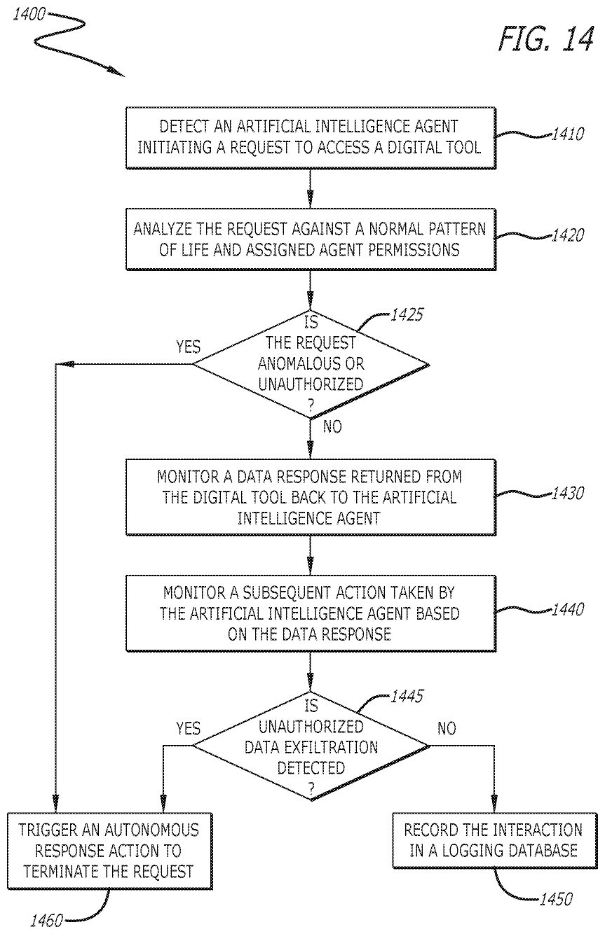

FIG. 14 illustrates a flow diagram of an embodiment of a process 1400 for monitoring and securing agentic artificial intelligence workflows. The process 1400 can be executed by the cyber security appliance, endpoint c-sensors, or a distributed cloud platform to ensure that internal or external AI agents do not abuse their access to digital tools to exfiltrate sensitive data. The process 1400 can detect an artificial intelligence agent initiating a request to access a digital tool (Block 1410). The system continuously monitors the application programming interfaces and network traffic for automated scripts, local large language models, or cloud-based AI assistants attempting to query internal databases, read files, or utilize external software services. This detection ensures that machine-to-machine interactions are scrutinized just as heavily as human-generated prompts within the protected enterprise network.

The process 1400 can analyze the request against a normal pattern of life and assigned agent permissions (Block 1420). The analytic logic compares the agent's current request against its historical behavior utilizing the unsupervised autoencoder ensembles or vector clustering models. Simultaneously, the system checks the strict role-based access control lists to verify if the artificial intelligence agent is officially authorized to interact with the specific digital tool it is targeting.

The process 1400 can determine whether the request is anomalous or unauthorized (Block 1425). The decision logic evaluates the anomaly score generated from the pattern of life analysis and the boolean result of the permissions check. If the agent is attempting to access a highly sensitive financial database it has never queried before, or if it lacks the explicit programmatic permissions to do so (YES), the system will flag the request as unauthorized and route the process to execute an immediate mitigation. If the request is typical for the agent and explicitly permitted by the security policies (NO), the process moves forward to monitor the ongoing interaction.

The process 1400 can trigger an autonomous response action to terminate the request (Block 1460). If the initial request was flagged as anomalous or unauthorized, the autonomous response engine immediately blocks the application programming interface call or drops the network connection. This preemptive intervention prevents the rogue or compromised artificial intelligence agent from accessing the targeted digital tool, halting the potential cyberattack before any data is retrieved.

The process 1400 can monitor a data response returned from the digital tool back to the artificial intelligence agent (Block 1430). Once the permitted request is processed by the target system, the cyber security appliance inspects the payload being sent back to the agent. This returned data might include a large dataset, a generated document, or a list of secure credentials that the agent requested for its legitimate automated workflow.

The process 1400 can monitor a subsequent action taken by the artificial intelligence agent based on the data response (Block 1440). The system closely tracks what the agent does next with the newly acquired information. For example, the system observes whether the agent attempts to write the data to a local file, insert it into an email, or bundle it into an outbound prompt directed at an external third-party large language model. This step is critical for detecting complex prompt injection attacks where an agent was maliciously instructed to fetch internal data and send it to an external server.

The process 1400 can determine whether unauthorized data exfiltration is being detected (Block 1445). The analytic logic evaluates the agent's subsequent action to see if it violates data governance policies, such as attempting to send personal identifiable information retrieved from the digital tool out to an unapproved internet destination. If the system detects a data exfiltration attempt (YES), the process routes to intervene immediately. If the subsequent action is benign, expected, and secure (NO), the process routes to conclude the monitoring cycle.

The process 1400 can trigger an autonomous response action to terminate the request (Block 1460). In this secondary scenario, the autonomous response engine intervenes to block the agent's subsequent outbound connection, preventing the exfiltration of the data it legitimately gathered in the previous step. The system may also quarantine the agent or revoke its access tokens to prevent further malicious actions from the compromised script.

The process 1400 can record the interaction in a logging database (Block 1450). If the entire workflow, from the initial request to the subsequent action, is deemed secure and authorized, the system logs the full context of the machine-to-machine interaction in the data store. This ensures a comprehensive audit trail is maintained for compliance purposes and provides fresh, normalized data to continuously train the pattern of life machine learning models.

Although a specific embodiment for a process for monitoring and securing agentic artificial intelligence workflows for carrying out the various steps, processes, methods, and operations described herein is discussed with respect to FIG. 14, any of a variety of systems and/or devices may be utilized in accordance with embodiments of the disclosure. For example, the agent permissions check could be outsourced to a third-party identity and access management cloud provider, or the autonomous response action could involve dynamically modifying the agent's code rather than terminating the connection. The elements depicted in FIG. 14 may also be interchangeable with other elements of FIGS. 1-13 and FIG. 15 as required to realize a particularly desired embodiment.

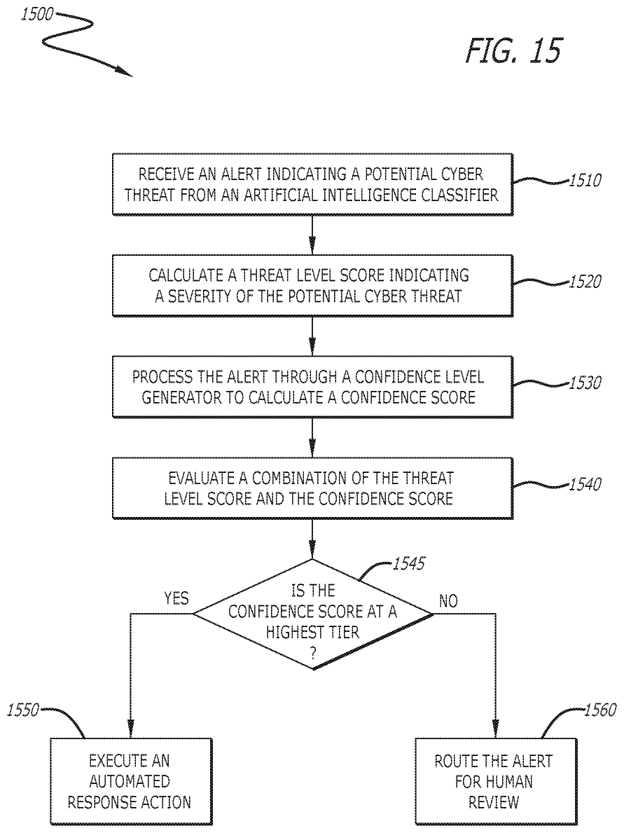

FIG. 15 illustrates a flow diagram of an embodiment of a process 1500 for evaluating and responding to a potential cyber threat based on threat level and confidence scores. The process 1500 can be executed by the assessment module and the orchestration module within the cyber security appliance to prioritize incidents and determine the appropriate level of autonomous intervention. The process 1500 can receive an alert indicating a potential cyber threat from an artificial intelligence classifier (Block 1510). The cyber security appliance or the analytic logic detects an anomaly or a policy violation, such as an unauthorized prompt injection or data exfiltration attempt, and generates an initial alert. This alert serves as the primary trigger for the subsequent assessment and response evaluation phases.

The process 1500 can calculate a threat level score indicating a severity of the potential cyber threat (Block 1520). The assessment module evaluates the context of the interaction to determine the potential impact on the organization. For example, a threat level score might be elevated if the flagged interaction contains highly sensitive personal identifiable information or targets a critical internal database, compared to a low-severity alert involving a minor policy infraction.

The process 1500 can process the alert through a confidence level generator to calculate a confidence score (Block 1530). The system analyzes the mathematical certainty of the artificial intelligence models that generated the alert. This calculation factors in whether multiple independent classifiers, such as both the named entity recognition model and the autoencoder ensemble, simultaneously flagged the same interaction, thereby increasing the overall confidence that the alert is a true positive rather than a benign anomaly.

The process 1500 can evaluate a combination of the threat level score and the confidence score (Block 1540). The orchestration module cross-references the severity of the threat with the certainty of the detection. This combined evaluation creates a rigorous, multi-dimensional risk matrix that allows the system to prioritize alerts accurately, ensuring that critical, high-confidence threats are addressed immediately while ambiguous anomalies are handled with more nuance.

The process 1500 can determine whether the confidence score is at a highest tier (Block 1545). The decision logic checks the calculated confidence score against predefined autonomous action thresholds. If the artificial intelligence is highly certain of the malicious nature of the threat (YES), the system trusts the automated containment protocols. If the confidence score falls below this highest tier (NO), indicating ambiguity or a potential false positive, the system defers to a more cautious approach.

The process 1500 can execute an automated response action (Block 1550). When the threat is verified with maximum confidence, the autonomous response engine intervenes at machine speed without waiting for manual approval. This can involve blocking the network connection, masking the sensitive prompt payload, or isolating the compromised endpoint to instantly neutralize the cyberattack.

The process 1500 can route the alert for human review (Block 1560). When the confidence score is not at the highest tier, the system forwards the alert, along with the calculated threat level score and the relevant interaction context, to the user interface for a security administrator to investigate. This ensures that complex or ambiguous interactions are scrutinized by human intuition, maintaining ultimate operational control while avoiding disruptive false-positive automated blocks.

Although a specific embodiment for a process for evaluating and responding to a potential cyber threat for carrying out the various steps, processes, methods, and operations described herein is discussed with respect to FIG. 15, any of a variety of systems and/or devices may be utilized in accordance with embodiments of the disclosure. For example, the confidence level generator could rely on external threat intelligence feeds to adjust the score, or the automated response action could be staged to require multiple human approvals for specific high-value endpoints. The elements depicted in FIG. 15 may also be interchangeable with other elements of FIGS. 1-14 as required to realize a particularly desired embodiment.

Note, an application described herein includes but is not limited to software applications, mobile applications, and programs routines, objects, widgets, plug-ins that are part of an operating system application. Some portions of this description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms can be written in a number of different software programming languages such as Python, C, C++, Java, HTTP, or other similar languages. Also, an algorithm can be implemented with lines of code in software, configured logic gates in hardware, or a combination of both. In an embodiment, the logic consists of electronic circuits that follow the rules of Boolean Logic, software that contain patterns of instructions, or any combination of both. A module may be implemented in hardware electronic components, software components, and a combination of both. A model, such as a machine learning model composed of neural networks, is a core component of a complex system consisting of hardware storing information and executing instructions and software that is capable of performing its function as discussed herein.

Unless specifically stated otherwise as apparent from the above discussions, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers, or other such information storage, transmission or display devices.

While the foregoing design and embodiments thereof have been provided in considerable detail, it is not the intention of the applicant(s) for the design and embodiments provided herein to be limiting. Additional adaptations and/or modifications are possible, and, in broader aspects, these adaptations and/or modifications are also encompassed. Accordingly, departures may be made from the foregoing design and embodiments without departing from the scope afforded by the following claims, which scope is only limited by the claims when appropriately construed.

What is claimed is:

1. A cyber security appliance, comprising:
a generative AI interaction module configured to receive extracted information from interactions between a user and an artificial intelligence (AI) based agent;
an analytic logic module comprising one or more AI classifiers and machine-learning models configured to:
perform a similarity search against a historical storage database;
determine an anomaly score; and
identify, via the one or more AI classifiers, sensitive information;
a Pattern of Life (POL) decision logic module configured to maintain state information associated with monitored interactions and determine when an interaction exceeds an operational limit based on the anomaly score;
an autonomous response module configured to execute an autonomous responsive action in response to a notification from the POL decision logic module, and
where the generative AI interaction module, the analytic logic module, the POL decision logic module, and the autonomous response module are implemented with i) electronic circuits, ii) as software stored in one or more non-transitory computer storage mediums and executed by one or more processors, and iii) any combination of i) or ii).

2. The cyber security appliance of claim 1, wherein the sensitive information is indicative of at least one of a network policy violation, a personal identifiable information (PII) leakage, or an unauthorized data exfiltration.

3. The cyber security appliance of claim 1, wherein the extracted information is received from an endpoint agent on an endpoint computing device.

4. The cyber security appliance of claim 1, wherein the similarity search is performed using a vector based machine learning embedding.

5. The cyber security appliance of claim 1, wherein the anomaly score is determined using an unsupervised anomaly-based autoencoder ensemble.

6. The cyber security appliance of claim 5, wherein the unsupervised anomaly-based autoencoder ensemble determines the anomaly score by calculating a reconstruction loss for the interaction, and wherein the autonomous responsive action is to disable or modify the interaction.

7. The cyber security appliance of claim 1, wherein an autoencoder ensemble against stored prompts and responses is configured to provide an unsupervised, reconstruction-based method for anomaly detection, where the autoencoder ensemble against stored prompts and responses is configured to utilize a rolling window of multiple autoencoders, frequently aging off older models and training new ones to accurately reflect a shifting pattern of life of an organization.

8. The cyber security appliance of claim 6, wherein the modification of the interaction comprises masking the identified sensitive information with at least one placeholder prior to the interaction reaching the artificial intelligence (AI) based agent.

9. The cyber security appliance of claim 6, wherein disabling the interaction comprises at least one of: disabling a monitored connection through a Transmission Control Protocol (TCP) reset message, altering a firewall policy to block the monitored connection, or removing permissions of the user.

10. The cyber security appliance of claim 1, wherein the one or more AI classifiers comprises a Named Entity Recognition (NER) model trained to identify the sensitive information within the interactions.

11. A method of securing artificial intelligence interactions, comprising:
receiving, by a cybersecurity appliance, data representing an interaction comprising a prompt or a response associated with a generative artificial intelligence (AI) tool;
processing, by the cybersecurity appliance, the interaction using an autoencoder ensemble trained on a normal pattern of life comprising historical prompts and responses;
determining, by the cybersecurity appliance, a reconstruction loss for the interaction based on the processing by the autoencoder ensemble;
identifying, by the cybersecurity appliance, the interaction as anomalous based on the reconstruction loss indicating an unusualness of the interaction for a specific user; and
executing, by the cybersecurity appliance, an autonomous responsive action to secure the generative AI tool in response to identifying the interaction as anomalous.

12. The method of claim 11, wherein the autoencoder ensemble comprises a plurality of autoencoders, and wherein each autoencoder of the plurality of autoencoders represents a distinct time period of training data.

13. The method of claim 12, further comprising aging off an oldest autoencoder of the plurality of autoencoders after a predetermined period and training a new autoencoder to maintain a rolling window of the plurality of autoencoders used to evaluate the interaction.

14. The method of claim 11, wherein identifying the interaction as anomalous is evaluated for a specific object, and wherein the specific object comprises at least one of an entire business, a specific user, or a specific user group.

15. The method of claim 11, wherein determining the reconstruction loss comprises calculating a mean squared error loss representing an amount of alteration between an original representation of the interaction and a reconstructed representation of the interaction.

16. The method of claim 11, wherein the data representing the interaction comprises an agentic interaction between the generative AI tool and a second AI-based system rather than a human user.

17. The method of claim 11, wherein the generative AI tool comprises a chatbot configured to offer at least one service comprising question and answering, coding assistance, or document navigation.

18. A non-transitory computer readable medium including software modules to be executed by a processor, the software modules comprising:
a generative AI interaction module configured to receive extracted information from interactions between a user and an artificial intelligence (AI) based agent;
an analytic logic module comprising one or more AI classifiers and machine-learning models configured to: perform a similarity search against a historical storage database; determine an anomaly score; and identify, via the one or more AI classifiers, sensitive information;
a Pattern of Life (POL) decision logic module configured to maintain state information associated with the monitored interactions and determine when an interaction exceeds an operational limit based on the anomaly score; and
an autonomous response module configured to execute an autonomous responsive action in response to a notification from the POL decision logic module.

19. The non-transitory computer readable medium of claim 18, wherein the analytic logic module is configured to perform the similarity search by comparing a vector embedding of the interaction against a centroid stored in the historical storage database to save memory space.

20. The non-transitory computer readable medium of claim 18, wherein the extracted information further comprises data representing an access request by the AI based agent to a tool, and wherein the tool comprises at least one of a web search, a file lookup, or an application programming interface (API) interaction.
